(19) United States
(12) Patent Application Publication
(10) Pub. No.: US 2026/0133986 A1
(43) Pub. Date: May 14, 2026

(54) Database System Including Method and Apparatus for Representing Data Type Transformations Regarding a Query Statement

(71) Applicant: Ocient Holdings LLC, Chicago, IL (US)

(72) Inventors: Steffen R. Knoll, Stuttgart (DE); Helen L. Hu, Darien, IL (US); George Kondiles, Highland Park, IL (US); Austin Chang, San Jose, CA (US); Evan Jiang, Brooklyn, NY (US); Jonathan C. Kelley, Lake Bluff, IL (US); Pavel Yusim, Chicago, IL (US); Owen Pang, Austin, TX (US); Knut Stolze, Jena (DE); Brendan J. Batliner, Chicago, IL (US); Stefan Renner, Munich (DE)

(73) Assignee: Ocient Holdings LLC, Chicago, IL (US)

(21) Appl. No.: 19/440,947

(22) Filed: Jan. 6, 2026

Related U.S. Application Data
(63) Continuation-in-part of application No. 18/642,043, filed on Apr. 22, 2024, now Pat. No. 12,547,605.
(63) Continuation-in-part of application No. 18/790,308, filed on Jul. 31, 2024, now Pat. No. 12,541,532.

(51) Int. Cl. G06F 16/25; G06F 16/2453

(52) U.S. Cl. CPC G06F 16/258; G06F 16/24534

(57) ABSTRACT

A set of processing core resources of a database system is operable to obtain the query statement regarding a set of data values of a dataset. The set is further operable to obtain source data type information regarding source data type of the set of data values and target data type information regarding target data type regarding resulting data of the query statement. When the source data type does not match the target data type, the set is operable to access a data type conversion path list to identify a set of entries. The set is operable to determine, for the set of entries, whether an entry of the set of entries includes a source data type that corresponds to the source data type information. When the entry includes the source data type, the set is operable to output a representation of data conversion path information of the entry.

### CROSS-REFERENCE TO RELATED APPLICATIONS

The present U.S. Utility patent application claims priority pursuant to pursuant to 35 U.S.C. § 120 as a continuation-in-part of U.S. Utility application Ser. No. 18/642,043, entitled, “Performing Load Error Tracking During Loading Of Data For Storage Via A Database System”, filed on Apr. 22, 2024, which is hereby incorporated herein by reference in its entirety and made part of the present U.S. Utility patent application for all purposes.

The present U.S. Utility patent application also claims priority pursuant to pursuant to 35 U.S.C. § 120 as a continuation-in-part of U.S. Utility application Ser. No. 18/790,308, entitled, “External Control for Structured Query Language (SQL) Statement Execution”, filed on Jul. 31, 2024, which is hereby incorporated herein by reference in its entirety and made part of the present U.S. Utility patent application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to computer networking and more particularly to database system and operation.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function.

Of the many applications a computer can perform, a database system is one of the largest and most complex applications. In general, a database system stores a large amount of data in a particular way for subsequent processing. In some situations, the hardware of the computer is a limiting factor regarding the speed at which a database system can process a particular function. In some other instances, the way in which the data is stored is a limiting factor regarding the speed of execution. In yet some other instances, restricted co-process options are a limiting factor regarding the speed of execution.

### BRIEF DESCRIPTION OF THE SEVERAL VIEWS OF THE DRAWING(S)

FIG. 1 is a schematic block diagram of an embodiment of a large scale data processing network that includes a database system in accordance with various embodiments;

FIG. 1A is a schematic block diagram of an embodiment of a database system in accordance with various embodiments;

FIG. 2 is a schematic block diagram of an embodiment of an administrative sub-system in accordance with various embodiments;

FIG. 3 is a schematic block diagram of an embodiment of a configuration sub-system in accordance with various embodiments;

FIG. 4 is a schematic block diagram of an embodiment of a parallelized data input sub-system in accordance with various embodiments;

FIG. 5 is a schematic block diagram of an embodiment of a parallelized query and response (Q&R) sub-system in accordance with various embodiments;

FIG. 6 is a schematic block diagram of an embodiment of a parallelized data store, retrieve, and/or process (IO& P) sub-system in accordance with various embodiments;

FIG. 7 is a schematic block diagram of an embodiment of a computing device in accordance with various embodiments;

FIG. 8 is a schematic block diagram of another embodiment of a computing device in accordance with various embodiments;

FIG. 9 is a schematic block diagram of another embodiment of a computing device in accordance with various embodiments;

FIG. 10 is a schematic block diagram of an embodiment of a node of a computing device in accordance with various embodiments;

FIG. 11 is a schematic block diagram of an embodiment of a node of a computing device in accordance with various embodiments;

FIG. 12 is a schematic block diagram of an embodiment of a node of a computing device in accordance with various embodiments;

FIG. 13 is a schematic block diagram of an embodiment of a node of a computing device in accordance with various embodiments;

FIG. 14 is a schematic block diagram of an embodiment of operating systems of a computing device in accordance with various embodiments;

FIGS. 15-23 are schematic block diagrams of an example of processing a table or data set for storage in the database system in accordance with various embodiments;

FIG. 24A is a schematic block diagram of a query execution plan implemented via a plurality of nodes in accordance with various embodiments;

FIG. 24B illustrates an example embodiment of a plurality of database tables stored in database storage in accordance with various embodiments;

FIG. 24C is a schematic block diagram of a database system that implements a segment generator that generates segments from a plurality of records in accordance with various embodiments;

FIG. 24D is a schematic block diagram of a query processing system that generates and executes a plurality of IO pipelines to generate filtered records sets from a plurality of segments in conjunction with executing a query in accordance with various embodiments;

FIG. 24E is a schematic block diagram of a query processing system that generates an IO pipeline for accessing a corresponding segment based on predicates of a query in accordance with various embodiments;

FIG. 24F is a schematic block diagram of a database system that implements a compressed column filter conversion module based on accessing a dictionary structure in accordance with various embodiments;

FIG. 24G is a schematic block diagram of a query execution module that implements a Global Dictionary Compression join via access to a dictionary structure in accordance with various embodiments;

FIGS. 25A-25B are schematic block diagrams of embodiments of a database system that includes a record processing and storage system in accordance with various embodiments;

FIG. 25C is a is a schematic block diagram of an embodiment of a page generator in accordance with various embodiments;

FIG. 25D is a schematic block diagram of an embodiment of a page storage system of a record processing and storage system in accordance with various embodiments;

FIG. 25E is a schematic block diagram of a node that implements a query processing module that reads records from segment storage and page storage in accordance with various embodiments;

FIG. 26A is a schematic block diagram of a record processing and storage system that performs a loading process based on implementing a record source and target identification module and a table populator module that implements a record transformation module in accordance with various embodiments;

FIG. 26B illustrates an example logical flow implemented in performing a loading process in accordance with various embodiments;

FIG. 27A is a schematic block diagram of a record transformation module that generates target data from source data via applying transformation graph data that includes a plurality of transformation operations in at least one graphical path in accordance with various embodiments;

FIG. 27B is a schematic block diagram of a transformation graph data generator module that generates transformation graph data based on source data type information and target data type information in accordance with various embodiments;

FIG. 27C illustrates example transformation graph data that includes a plurality of graphical paths from source input to target output in accordance with various embodiments;

FIG. 27D illustrates example initial transformation graph data that includes an initial graphical path having a plurality of operations of unknown operation type in accordance with various embodiments;

FIG. 27E is a schematic block diagram of a transformation graph data generator module that generates transformation graph data based on an example type-casting operation list and an example full operation list in accordance with various embodiments;

FIG. 27F illustrates an example logical flow of a graphical path generation algorithm implemented by transformation graph data generator module in accordance with various embodiments;

FIG. 27G illustrates an example logical flow of a missing type-cast handling algorithm implemented by transformation graph data generator module in accordance with various embodiments;

FIG. 28A is a schematic block diagram of a record processing and storage system that performs a loading process based on implementing an incoming file processing module and an error handling module in accordance with various embodiments;

FIG. 28B is a schematic block diagram illustrating communication of source datasets, error handling configuration data, and load error tracking data between record processing and storage system and at least one user entity;

FIG. 29A is a schematic block diagram of a record processing and storage system that performs a loading process based on implementing a work unit generator module, a next loading batch set initiation module, and a plurality of loading modules in accordance with various embodiments;

FIG. 30A is a schematic block diagram of a record processing and storage system that performs a loading process based on implementing a distributed tasks coordinator that generates a plurality of subtasks each for execution via a corresponding node of a plurality of nodes in accordance with various embodiments;

FIG. 30B illustrates an example logical flow of distributed loading processing coordination performed in conjunction with performing a loading process in accordance with various embodiments;

FIG. 31A is a chart illustrating a missing record in test data in accordance with various embodiments;

FIG. 31B is a schematic block diagram of a database system enforcing a density constraint on time series data in accordance with various embodiments;

FIG. 31C is a schematic block diagram of a data ingress module for enforcing a density constraint on time series data in accordance with various embodiments;

FIG. 31D is a schematic block diagram of a data ingress module for enforcing a density constraint on time series data in accordance with various embodiments; and

FIG. 32A is a schematic block diagram of a database system utilizing external control for SQL statement execution in accordance with various embodiments.

### DETAILED DESCRIPTION OF THE INVENTION

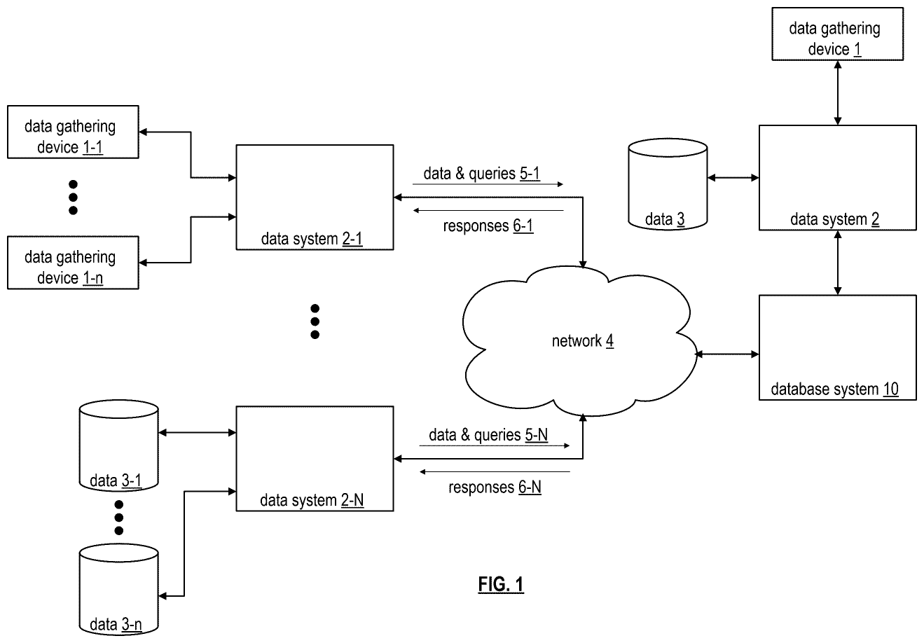

FIG. 1 is a schematic block diagram of an embodiment of a large-scale data processing network that includes data gathering devices (1, 1-1 through 1-n), data systems (2, 2-1 through 2-N), data storage systems (3, 3-1 through 3-n), a network 4, and a database system 10. The data gathering devices are computing devices that collect a wide variety of data and may further include sensors, monitors, measuring instruments, and/or other instrument for collecting data. The data gathering devices collect data in real-time (i.e., as it is happening) and provides it to data system 2-1 for storage and real-time processing of queries 5-1 to produce responses 6-1. As an example, the data gathering devices are computing in a factory collecting data regarding manufacturing of one or more products and the data system is evaluating queries to determine manufacturing efficiency, quality control, and/or product development status.

The data storage systems 3 store existing data. The existing data may originate from the data gathering devices or other sources, but the data is not real time data. For example, the data storage system stores financial data of a bank, a credit card company, or like financial institution. The data system 2-N processes queries 5-N regarding the data stored in the data storage systems to produce responses 6-N.

Data system 2 processes queries regarding real time data from data gathering devices and/or queries regarding non-real time data stored in the data storage system 3. The data system 2 produces responses in regard to the queries. Storage of real time and non-real time data, the processing of queries, and the generating of responses will be discussed with reference to one or more of the subsequent figures.

FIG. 1A is a schematic block diagram of an embodiment of a database system 10 that includes a parallelized data input sub-system 11, a parallelized data store, retrieve, and/or process sub-system 12, a parallelized query and response sub-system 13, system communication resources 14, an administrative sub-system 15, and a configuration sub-system 16. The system communication resources 14 include one or more of: wide area network (WAN) connections, local area network (LAN) connections, wireless connections, wireline connections, etc. to couple the sub-systems 11, 12, 13, 15, and 16 together.

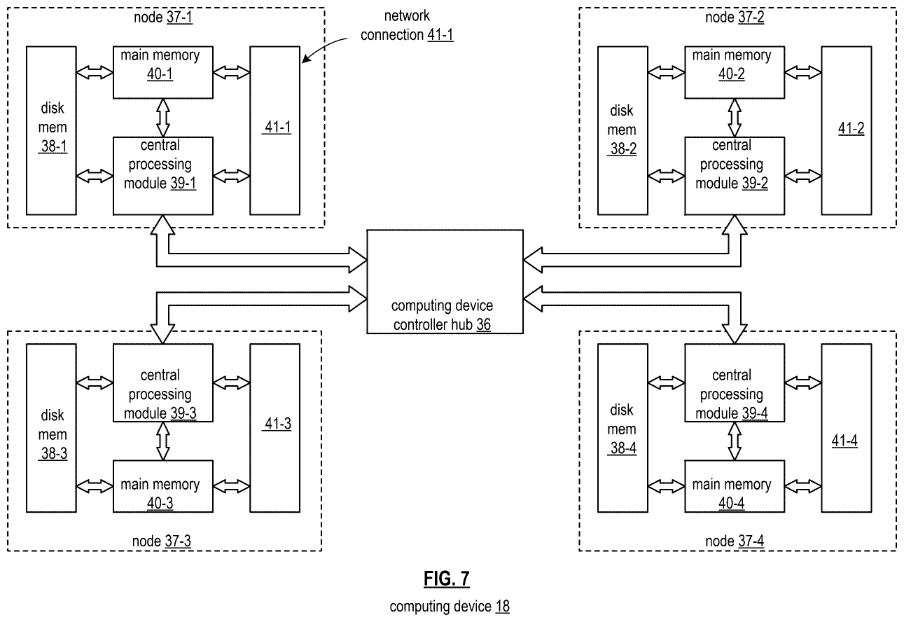

Each of the sub-systems 11, 12, 13, 15, and 16 include a plurality of computing devices; an example of which is discussed with reference to one or more of FIGS. 7-9. Hereafter, the parallelized data input sub-system 11 may also be referred to as a data input sub-system, the parallelized data store, retrieve, and/or process sub-system may also be referred to as a data storage and processing sub-system, and the parallelized query and response sub-system 13 may also be referred to as a query and results sub-system.

In an example of operation, the parallelized data input sub-system 11 receives a data set (e.g., a table) that includes a plurality of records. A record includes a plurality of data fields. As a specific example, the data set includes tables of data from a data source. For example, a data source includes one or more computers. As another example, the data source is a plurality of machines. As yet another example, the data source is a plurality of data mining algorithms operating on one or more computers.

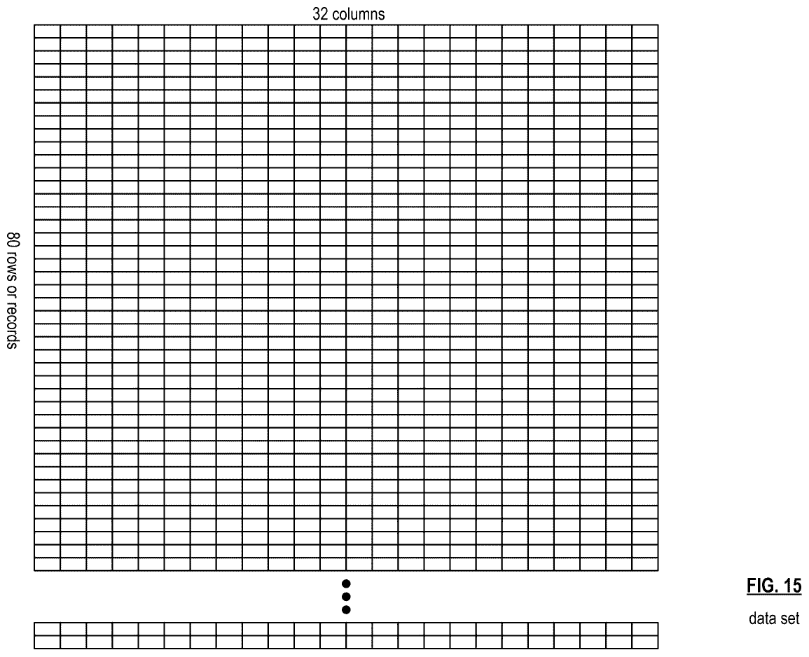

As is further discussed with reference to FIG. 15, the data source organizes its records of the data set into a table that includes rows and columns. The columns represent data fields of data for the rows. Each row corresponds to a record of data. For example, a table includes payroll information for a company's employees. Each row is an employee's payroll record. The columns include data fields for employee name, address, department, annual salary, tax deduction information, direct deposit information, etc.

The parallelized data input sub-system 11 processes a table to determine how to store it. For example, the parallelized data input sub-system 11 divides the data set into a plurality of data partitions. For each partition, the parallelized data input sub-system 11 divides it into a plurality of data segments based on a segmenting factor. The segmenting factor includes a variety of approaches of dividing a partition into segments. For example, the segment factor indicates a number of records to include in a segment. As another example, the segmenting factor indicates a number of segments to include in a segment group. As another example, the segmenting factor identifies how to segment a data partition based on storage capabilities of the data store and processing sub-system. As a further example, the segmenting factor indicates how many segments for a data partition based on a redundancy storage encoding scheme.

As an example of dividing a data partition into segments based on a redundancy storage encoding scheme, assume that it includes a 4 of 5 encoding scheme (meaning any 4 of 5 encoded data elements can be used to recover the data). Based on these parameters, the parallelized data input sub-system 11 divides a data partition into 5 segments: one corresponding to each of the data elements).

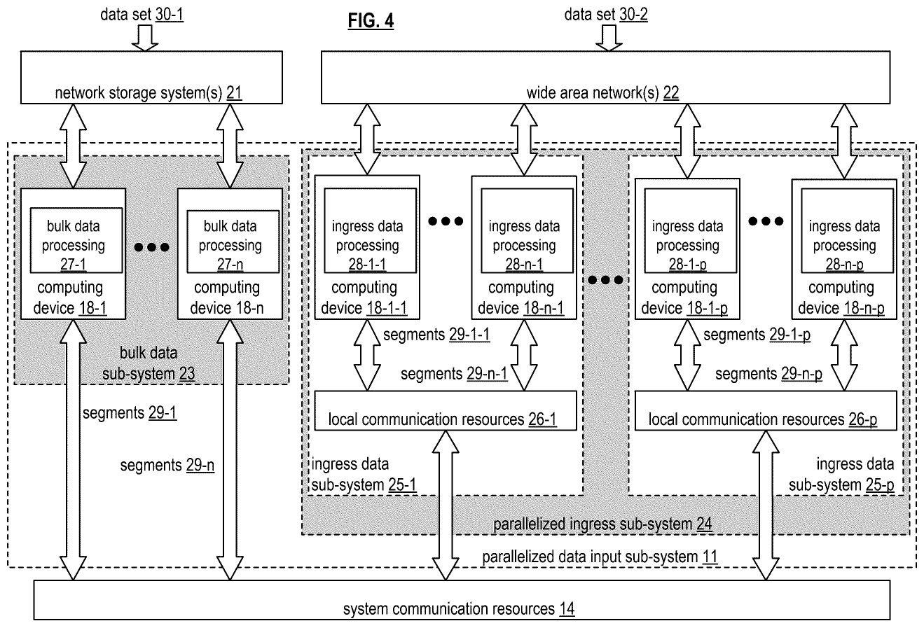

The parallelized data input sub-system 11 restructures the plurality of data segments to produce restructured data segments. For example, the parallelized data input sub-system 11 restructures records of a first data segment of the plurality of data segments based on a key field of the plurality of data fields to produce a first restructured data segment. The key field is common to the plurality of records. As a specific example, the parallelized data input sub-system 11 restructures a first data segment by dividing the first data segment into a plurality of data slabs (e.g., columns of a segment of a partition of a table). Using one or more of the columns as a key, or keys, the parallelized data input sub-system 11 sorts the data slabs. The restructuring to produce the data slabs is discussed in greater detail with reference to FIG. 4 and FIGS. 16-18.

The parallelized data input sub-system 11 also generates storage instructions regarding how sub-system 12 is to store the restructured data segments for efficient processing of subsequently received queries regarding the stored data. For example, the storage instructions include one or more of: a naming scheme, a request to store, a memory resource requirement, a processing resource requirement, an expected access frequency level, an expected storage duration, a required maximum access latency time, and other requirements associated with storage, processing, and retrieval of data.

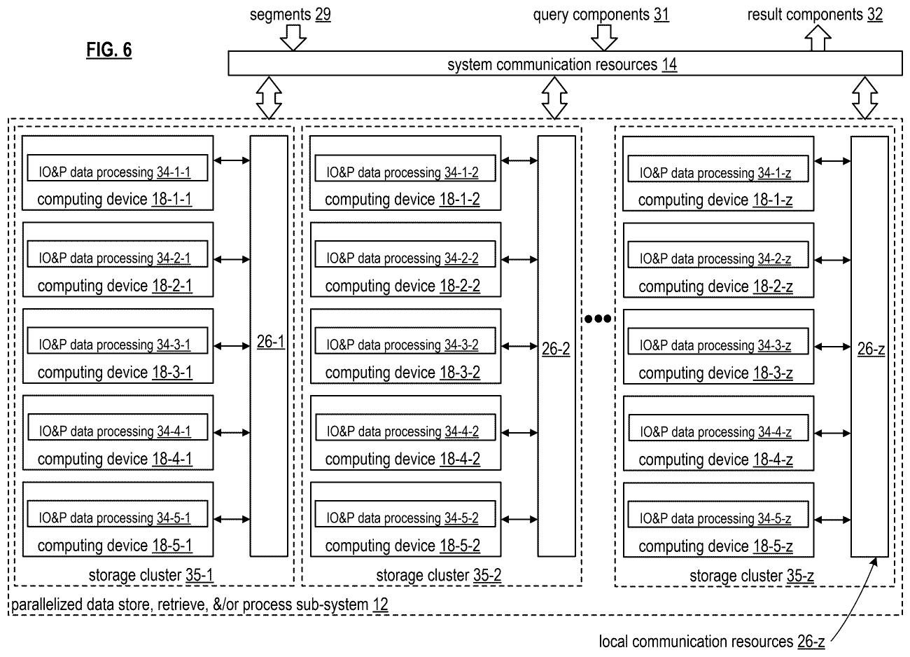

A designated computing device of the parallelized data store, retrieve, and/or process sub-system 12 receives the restructured data segments and the storage instructions. The designated computing device (which is randomly selected, selected in a round robin manner, or by default) interprets the storage instructions to identify resources (e.g., itself, its components, other computing devices, and/or components thereof) within the computing device's storage cluster. The designated computing device then divides the restructured data segments of a segment group of a partition of a table into segment divisions based on the identified resources and/or the storage instructions. The designated computing device then sends the segment divisions to the identified resources for storage and subsequent processing in accordance with a query. The operation of the parallelized data store, retrieve, and/or process sub-system 12 is discussed in greater detail with reference to FIG. 6.

The parallelized query and response sub-system 13 receives queries regarding tables (e.g., data sets) and processes the queries prior to sending them to the parallelized data store, retrieve, and/or process sub-system 12 for execution. For example, the parallelized query and response sub-system 13 generates an initial query plan based on a data processing request (e.g., a query) regarding a data set (e.g., the tables). Sub-system 13 optimizes the initial query plan based on one or more of the storage instructions, the engaged resources, and optimization functions to produce an optimized query plan.

For example, the parallelized query and response sub-system 13 receives a specific query no. 1 regarding the data set no. 1 (e.g., a specific table). The query is in a standard query format such as Open Database Connectivity (ODBC), Java Database Connectivity (JDBC), and/or SPARK. The query is assigned to a node within the parallelized query and response sub-system 13 for processing. The assigned node identifies the relevant table, determines where and how it is stored, and determines available nodes within the parallelized data store, retrieve, and/or process sub-system 12 for processing the query.

In addition, the assigned node parses the query to create an abstract syntax tree. As a specific example, the assigned node converts an SQL (Structured Query Language) statement into a database instruction set. The assigned node then validates the abstract syntax tree. If not valid, the assigned node generates a SQL exception, determines an appropriate correction, and repeats. When the abstract syntax tree is validated, the assigned node then creates an annotated abstract syntax tree. The annotated abstract syntax tree includes the verified abstract syntax tree plus annotations regarding column names, data type(s), data aggregation or not, correlation or not, sub-query or not, and so on.

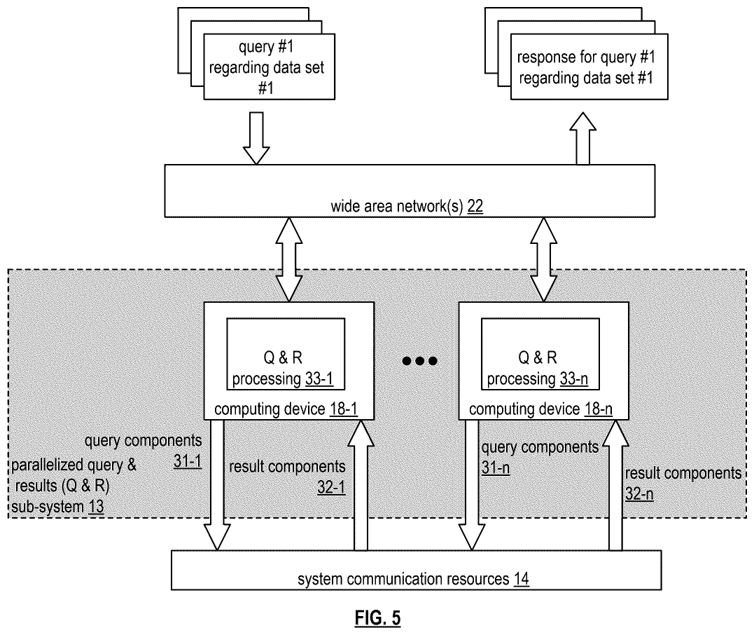

The assigned node then creates an initial query plan from the annotated abstract syntax tree. The assigned node optimizes the initial query plan using a cost analysis function (e.g., processing time, processing resources, etc.) and/or other optimization functions. Having produced the optimized query plan, the parallelized query and response sub-system 13 sends the optimized query plan to the parallelized data store, retrieve, and/or process sub-system 12 for execution. The operation of the parallelized query and response sub-system 13 is discussed in greater detail with reference to FIG. 5.

The parallelized data store, retrieve, and/or process sub-system 12 executes the optimized query plan to produce resultants and sends the resultants to the parallelized query and response sub-system 13. Within the parallelized data store, retrieve, and/or process sub-system 12, a computing device is designated as a primary device for the query plan (e.g., optimized query plan) and receives it. The primary device processes the query plan to identify nodes within the parallelized data store, retrieve, and/or process sub-system 12 for processing the query plan. The primary device then sends appropriate portions of the query plan to the identified nodes for execution. The primary device receives responses from the identified nodes and processes them in accordance with the query plan.

The primary device of the parallelized data store, retrieve, and/or process sub-system 12 provides the resulting response (e.g., resultants) to the assigned node of the parallelized query and response sub-system 13. For example, the assigned node determines whether further processing is needed on the resulting response (e.g., joining, filtering, etc.). If not, the assigned node outputs the resulting response as the response to the query (e.g., a response for query no. 1 regarding data set no. 1). If, however, further processing is determined, the assigned node further processes the resulting response to produce the response to the query. Having received the resultants, the parallelized query and response sub-system 13 creates a response from the resultants for the data processing request.

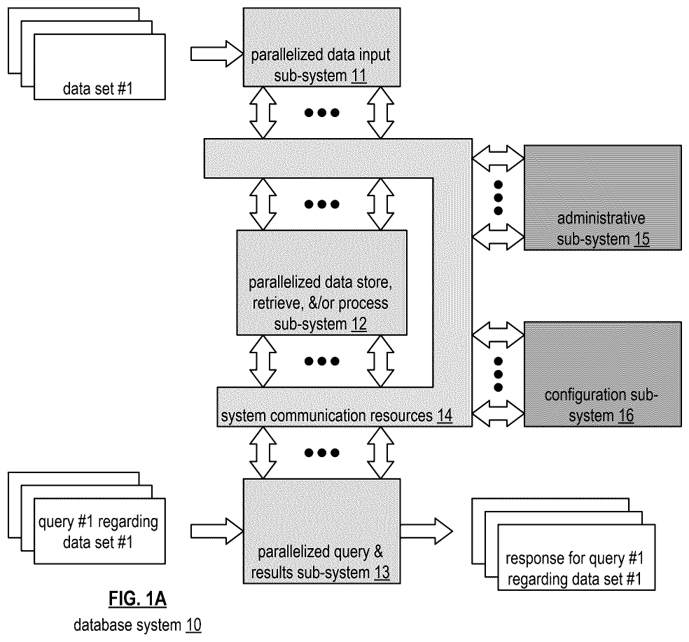

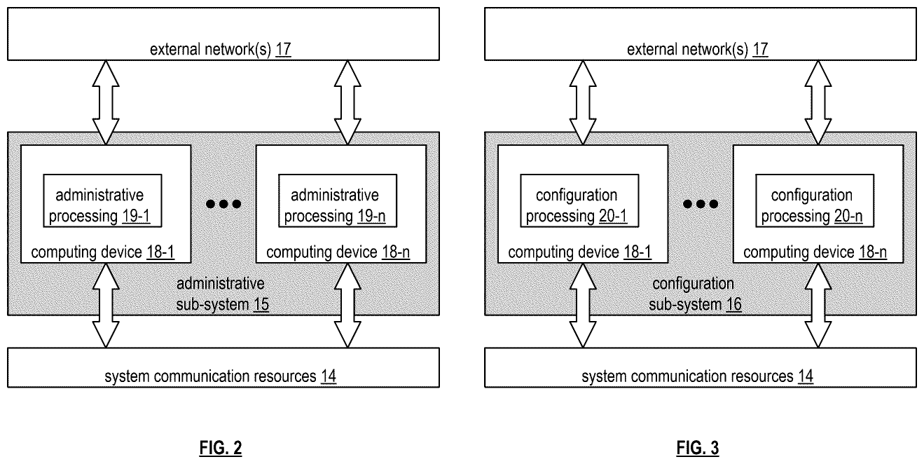

FIG. 2 is a schematic block diagram of an embodiment of the administrative sub-system 15 of FIG. 1A that includes one or more computing devices 18-1 through 18-n. Each of the computing devices executes an administrative processing function utilizing a corresponding administrative processing of administrative processing 19-1 through 19-n (which includes a plurality of administrative operations) that coordinates system level operations of the database system. Each computing device is coupled to an external network 17, or networks, and to the system communication resources 14 of FIG. 1A.

As will be described in greater detail with reference to one or more subsequent figures, a computing device includes a plurality of nodes and each node includes a plurality of processing core resources. Each processing core resource is capable of executing at least a portion of an administrative operation independently. This supports lock free and parallel execution of one or more administrative operations.

The administrative sub-system 15 functions to store metadata of the data set described with reference to FIG. 1A. For example, the storing includes generating the metadata to include one or more of an identifier of a stored table, the size of the stored table (e.g., bytes, number of columns, number of rows, etc.), labels for key fields of data segments, a data type indicator, the data owner, access permissions, available storage resources, storage resource specifications, software for operating the data processing, historical storage information, storage statistics, stored data access statistics (e.g., frequency, time of day, accessing entity identifiers, etc.) and any other information associated with optimizing operation of the database system 10.

FIG. 3 is a schematic block diagram of an embodiment of the configuration sub-system 16 of FIG. 1A that includes one or more computing devices 18-1 through 18-n. Each of the computing devices executes a configuration processing function 20-1 through 20-n (which includes a plurality of configuration operations) that coordinates system level configurations of the database system. Each computing device is coupled to the external network 17 of FIG. 2, or networks, and to the system communication resources 14 of FIG. 1A.

FIG. 4 is a schematic block diagram of an embodiment of the parallelized data input sub-system 11 of FIG. 1A that includes a bulk data sub-system 23 and a parallelized ingress sub-system 24. The bulk data sub-system 23 includes a plurality of computing devices 18-1 through 18-n. A computing device includes a bulk data processing function (e.g., 27-1) for receiving a table from a network storage system 21 (e.g., a server, a cloud storage service, etc.) and processing it for storage as generally discussed with reference to FIG. 1A.

The parallelized ingress sub-system 24 includes a plurality of ingress data sub-systems 25-1 through 25-p that each include a local communication resource of local communication resources 26-1 through 26-p and a plurality of computing devices 18-1 through 18-n. A computing device executes an ingress data processing function (e.g., 28-1) to receive streaming data regarding a table via a wide area network 22 and processing it for storage as generally discussed with reference to FIG. 1A. With a plurality of ingress data sub-systems 25-1 through 25-p, data from a plurality of tables can be streamed into the database system 10 at one time.

In general, the bulk data processing function is geared towards receiving data of a table in a bulk fashion (e.g., the table exists and is being retrieved as a whole, or portion thereof). The ingress data processing function is geared towards receiving streaming data from one or more data sources (e.g., receive data of a table as the data is being generated). For example, the ingress data processing function is geared towards receiving data from a plurality of machines in a factory in a periodic or continual manner as the machines create the data.

FIG. 5 is a schematic block diagram of an embodiment of a parallelized query and results sub-system 13 that includes a plurality of computing devices 18-1 through 18-n. Each of the computing devices executes a query (Q) & response (R) processing function 33-1 through 33-n. The computing devices are coupled to the wide area network 22 to receive queries (e.g., query no. 1 regarding data set no. 1) regarding tables and to provide responses to the queries (e.g., response for query no. 1 regarding the data set no. 1). For example, a computing device (e.g., 18-1) receives a query, creates an initial query plan therefrom, and optimizes it to produce an optimized plan. The computing device then sends components (e.g., one or more operations) of the optimized plan to the parallelized data store, retrieve, &/or process sub-system 12.

Processing resources of the parallelized data store, retrieve, &/or process sub-system 12 processes the components of the optimized plan to produce results components 32-1 through 32-n. The computing device of the Q&R sub-system 13 processes the result components to produce a query response.

The Q&R sub-system 13 allows for multiple queries regarding one or more tables to be processed concurrently. For example, a set of processing core resources of a computing device (e.g., one or more processing core resources) processes a first query and a second set of processing core resources of the computing device (or a different computing device) processes a second query.

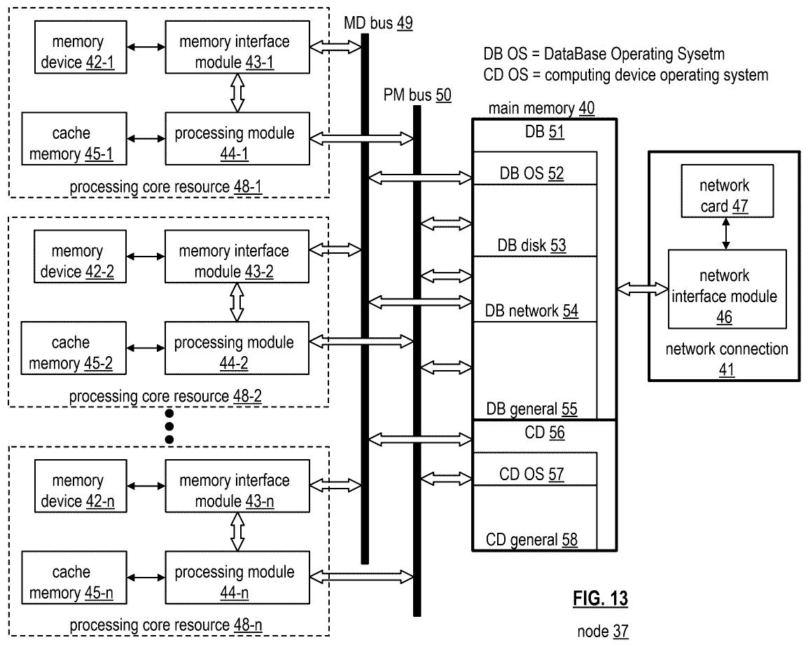

As will be described in greater detail with reference to one or more subsequent figures, a computing device includes a plurality of nodes and each node includes multiple processing core resources such that a plurality of computing devices includes pluralities of multiple processing core resources A processing core resource of the pluralities of multiple processing core resources generates the optimized query plan and other processing core resources of the pluralities of multiple processing core resources generates other optimized query plans for other data processing requests. Each processing core resource is capable of executing at least a portion of the Q & R function. In an embodiment, a plurality of processing core resources of one or more nodes executes the Q & R function to produce a response to a query. The processing core resource is discussed in greater detail with reference to FIG. 13.

FIG. 6 is a schematic block diagram of an embodiment of a parallelized data store, retrieve, and/or process sub-system 12 that includes a plurality of computing devices, where each computing device includes a plurality of nodes and each node includes multiple processing core resources. Each processing core resource is capable of executing at least a portion of the function of the parallelized data store, retrieve, and/or process sub-system 12. The plurality of computing devices is arranged into a plurality of storage clusters. Each storage cluster includes a number of computing devices.

In an embodiment, the parallelized data store, retrieve, and/or process sub-system 12 includes a plurality of storage clusters 35-1 through 35-z. Each storage cluster includes a corresponding local communication resource 26-1 through 26-z and a number of computing devices 18-1 through 18-5. Each computing device executes an input, output, and processing (IO &P) processing function 34-1 through 34-5 to store and process data.

The number of computing devices in a storage cluster corresponds to the number of segments (e.g., a segment group) in which a data partitioned is divided. For example, if a data partition is divided into five segments, a storage cluster includes five computing devices. As another example, if the data is divided into eight segments, then there are eight computing devices in the storage clusters.

To store a segment group of segments 29 within a storage cluster, a designated computing device of the storage cluster interprets storage instructions to identify computing devices (and/or processing core resources thereof) for storing the segments to produce identified engaged resources. The designated computing device is selected by a random selection, a default selection, a round-robin selection, or any other mechanism for selection.

The designated computing device sends a segment to each computing device in the storage cluster, including itself. Each of the computing devices stores their segment of the segment group. As an example, five segments 29 of a segment group are stored by five computing devices of storage cluster 35-1. The first computing device 18-1-1 stores a first segment of the segment group; a second computing device 18-2-1 stores a second segment of the segment group; and so on. With the segments stored, the computing devices are able to process queries (e.g., query components from the Q&R sub-system 13) and produce appropriate result components.

While storage cluster 35-1 is storing and/or processing a segment group, the other storage clusters 35-2 through 35-n are storing and/or processing other segment groups. For example, a table is partitioned into three segment groups. Three storage clusters store and/or process the three segment groups independently. As another example, four tables are independently stored and/or processed by one or more storage clusters. As yet another example, storage cluster 35-1 is storing and/or processing a second segment group while it is storing/or and processing a first segment group.

FIG. 7 is a schematic block diagram of an embodiment of a computing device 18 that includes a plurality of nodes 37-1 through 37-4 coupled to a computing device controller hub 36. The computing device controller hub 36 includes one or more of a chipset, a quick path interconnect (QPI), and an ultra path interconnection (UPI). Each node 37-1 through 37-4 includes a central processing module 39-1 through 39-4, a main memory 40-1 through 40-4 (e.g., volatile memory), a disk memory 38-1 through 38-4 (non-volatile memory), and a network connection 41-1 through 41-4. In an alternate configuration, the nodes share a network connection, which is coupled to the computing device controller hub 36 or to one of the nodes as illustrated in subsequent figures.

In an embodiment, each node is capable of operating independently of the other nodes. This allows for large scale parallel operation of a query request, which significantly reduces processing time for such queries. In another embodiment, one or more node function as co-processors to share processing requirements of a particular function, or functions.

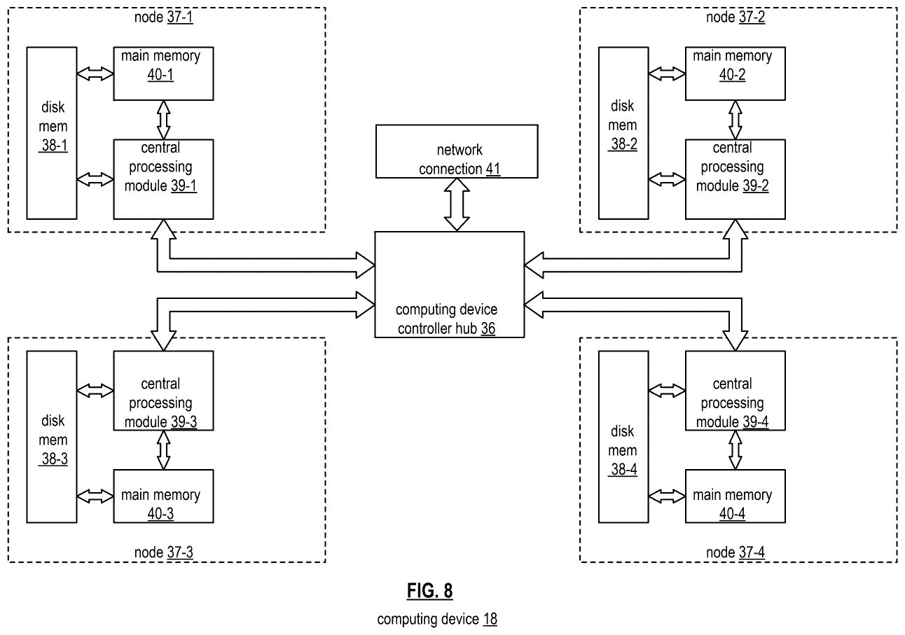

FIG. 8 is a schematic block diagram of another embodiment of a computing device similar to the computing device of FIG. 7 with an exception that it includes a single network connection 41, which is coupled to the computing device controller hub 36. As such, each node coordinates with the computing device controller hub to transmit or receive data via the network connection.

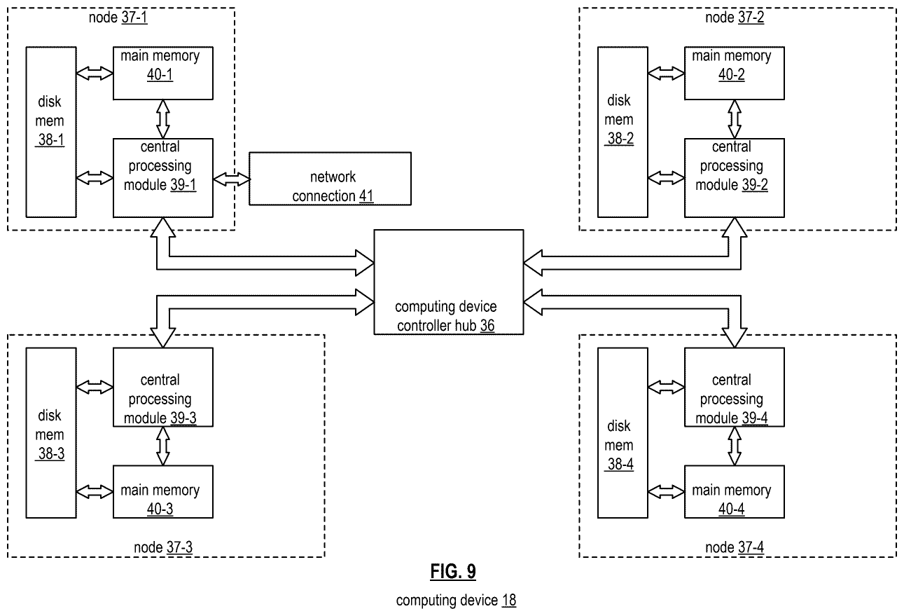

FIG. 9 is a schematic block diagram of another embodiment of a computing device is similar to the computing device of FIG. 7 with an exception that it includes a single network connection 41, which is coupled to a central processing module of a node (e.g., to central processing module 39-1 of node 37-1). As such, each node coordinates with the central processing module via the computing device controller hub 36 to transmit or receive data via the network connection.

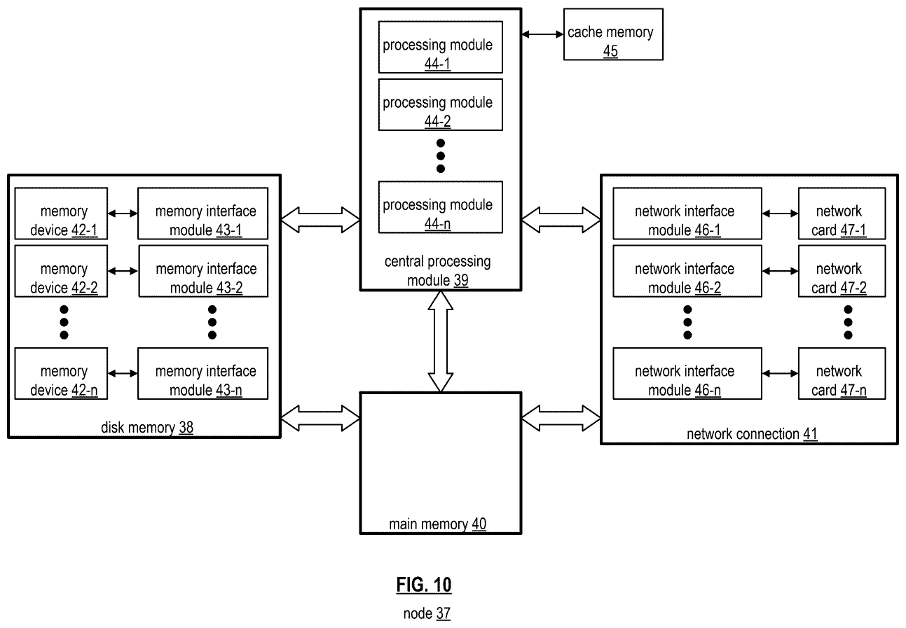

FIG. 10 is a schematic block diagram of an embodiment of a node 37 of computing device 18. The node 37 includes the central processing module 39, the main memory 40, the disk memory 38, and the network connection 41. The main memory 40 includes read only memory (RAM) and/or other form of volatile memory for storage of data and/or operational instructions of applications and/or of the operating system. The central processing module 39 includes a plurality of processing modules 44-1 through 44-n and an associated one or more cache memory 45. A processing module is as defined at the end of the detailed description.

The disk memory 38 includes a plurality of memory interface modules 43-1 through 43-n and a plurality of memory devices 42-1 through 42-n (e.g., non-volatile memory). The memory devices 42-1 through 42-n include, but are not limited to, solid state memory, disk drive memory, cloud storage memory, and other non-volatile memory. For each type of memory device, a different memory interface module 43-1 through 43-n is used. For example, solid state memory uses a standard, or serial, ATA (SATA), variation, or extension thereof, as its memory interface. As another example, disk drive memory devices use a small computer system interface (SCSI), variation, or extension thereof, as its memory interface.

In an embodiment, the disk memory 38 includes a plurality of solid state memory devices and corresponding memory interface modules. In another embodiment, the disk memory 38 includes a plurality of solid state memory devices, a plurality of disk memories, and corresponding memory interface modules.

The network connection 41 includes a plurality of network interface modules 46-1 through 46-n and a plurality of network cards 47-1 through 47-n. A network card includes a wireless LAN (WLAN) device (e.g., an IEEE 802.11n or another protocol), a LAN device (e.g., Ethernet), a cellular device (e.g., CDMA), etc. The corresponding network interface modules 46-1 through 46-n include a software driver for the corresponding network card and a physical connection that couples the network card to the central processing module 39 or other component(s) of the node.

The connections between the central processing module 39, the main memory 40, the disk memory 38, and the network connection 41 may be implemented in a variety of ways. For example, the connections are made through a node controller (e.g., a local version of the computing device controller hub 36). As another example, the connections are made through the computing device controller hub 36.

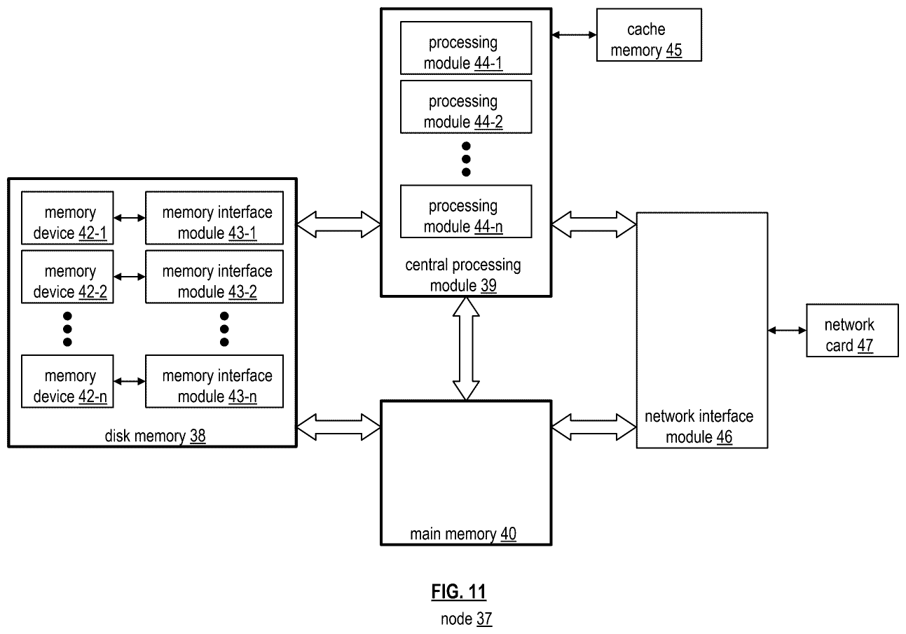

FIG. 11 is a schematic block diagram of an embodiment of a node 37 of a computing device 18 that is similar to the node of FIG. 10, with a difference in the network connection. In this embodiment, the node 37 includes a single network interface module 46 and a corresponding network card 47 configuration.

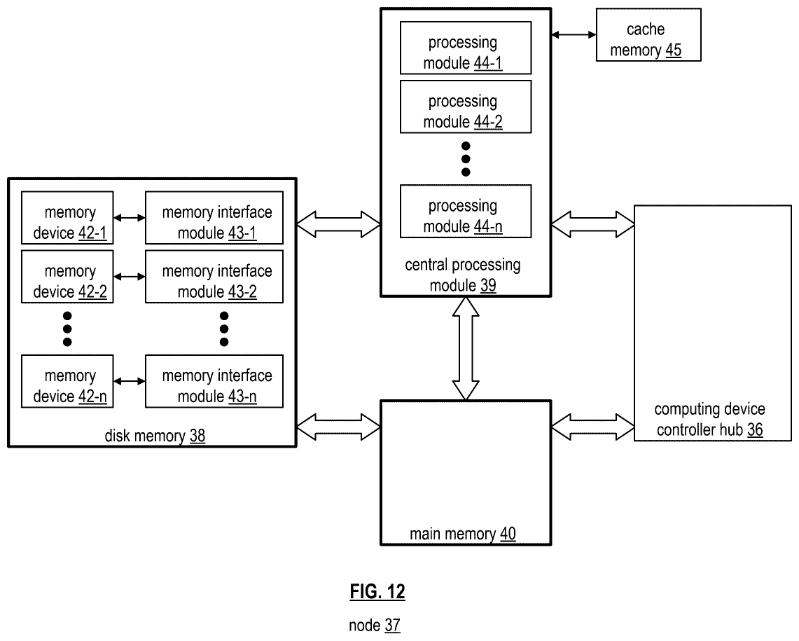

FIG. 12 is a schematic block diagram of an embodiment of a node 37 of a computing device 18 that is similar to the node of FIG. 10, with a difference in the network connection. In this embodiment, the node 37 connects to a network connection via the computing device controller hub 36.

FIG. 13 is a schematic block diagram of another embodiment of a node 37 of computing device 18 that includes processing core resources 48-1 through 48-n, a memory device (MD) bus 49, a processing module (PM) bus 50, a main memory 40 and a network connection 41. The network connection 41 includes the network card 47 and the network interface module 46 of FIG. 10. Each processing core resource 48 includes a corresponding processing module 44-1 through 44-n, a corresponding memory interface module 43-1 through 43-n, a corresponding memory device 42-1 through 42-n, and a corresponding cache memory 45-1 through 45-n. In this configuration, each processing core resource can operate independently of the other processing core resources. This further supports increased parallel operation of database functions to further reduce execution time.

The main memory 40 is divided into a computing device (CD) 56 section and a database (DB) 51 section. The database section includes a database operating system (OS) area 52, a disk area 53, a network area 54, and a general area 55. The computing device section includes a computing device operating system (OS) area 57 and a general area 58. Note that each section could include more or less allocated areas for various tasks being executed by the database system.

In general, the database OS 52 allocates main memory for database operations. Once allocated, the computing device OS 57 cannot access that portion of the main memory 40. This supports lock free and independent parallel execution of one or more operations.

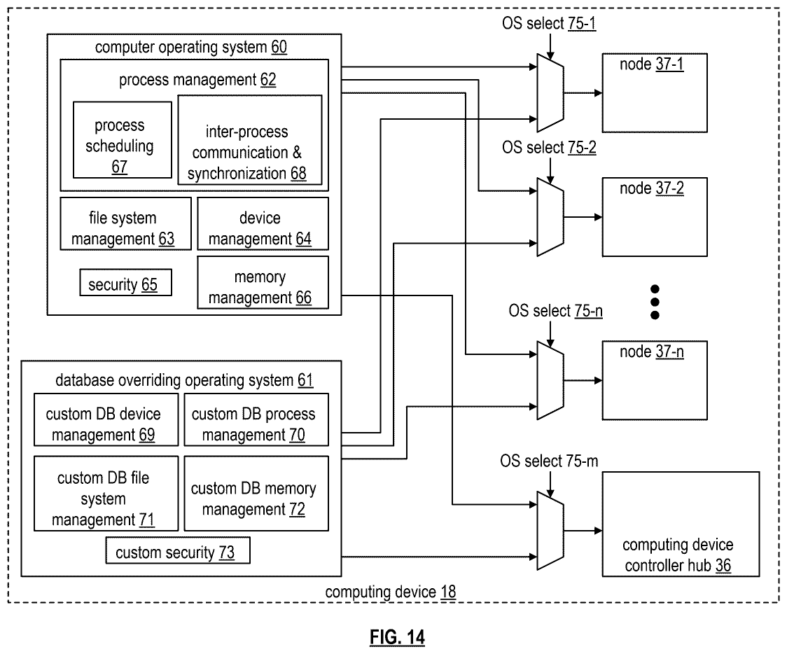

FIG. 14 is a schematic block diagram of an embodiment of operating systems of a computing device 18. The computing device 18 includes a computer operating system 60 and a database overriding operating system (DB OS) 61. The computer OS 60 includes process management 62, file system management 63, device management 64, memory management 66, and security 65. The processing management 62 generally includes process scheduling 67 and inter-process communication and synchronization 68. In general, the computer OS 60 is a conventional operating system used by a variety of types of computing devices. For example, the computer operating system is a personal computer operating system, a server operating system, a tablet operating system, a cell phone operating system, etc.

The database overriding operating system (DB OS) 61 includes custom DB device management 69, custom DB process management 70 (e.g., process scheduling and/or inter-process communication & synchronization), custom DB file system management 71, custom DB memory management 72, and/or custom security 73. In general, the database overriding OS 61 provides hardware components of a node for more direct access to memory, more direct access to a network connection, improved independency, improved data storage, improved data retrieval, and/or improved data processing than the computing device OS.

In an example of operation, the database overriding OS 61 controls which operating system, or portions thereof, operate with each node and/or computing device controller hub of a computing device (e.g., via OS select 75-1 through 75-n when communicating with nodes 37-1 through 37-n and via OS select 75-m when communicating with the computing device controller hub 36). For example, device management of a node is supported by the computer operating system, while process management, memory management, and file system management are supported by the database overriding operating system. To override the computer OS, the database overriding OS provides instructions to the computer OS regarding which management tasks will be controlled by the database overriding OS. The database overriding OS also provides notification to the computer OS as to which sections of the main memory it is reserving exclusively for one or more database functions, operations, and/or tasks. One or more examples of the database overriding operating system are provided in subsequent figures.

The database system 10 can be implemented as a massive scale database system that is operable to process data at a massive scale. As used herein, a massive scale refers to a massive number of records of a single dataset and/or many datasets, such as millions, billions, and/or trillions of records that collectively include many Gigabytes, Terabytes, Petabytes, and/or Exabytes of data. As used herein, a massive scale database system refers to a database system operable to process data at a massive scale. The processing of data at this massive scale can be achieved via a large number, such as hundreds, thousands, and/or millions of computing devices 18, nodes 37, and/or processing core resources 48 performing various functionality of database system 10 described herein in parallel, for example, independently and/or without coordination.

Such processing of data at this massive scale cannot practically be performed by the human mind. In particular, the human mind is not equipped to perform processing of data at a massive scale. Furthermore, the human mind is not equipped to perform hundreds, thousands, and/or millions of independent processes in parallel, within overlapping time spans. The embodiments of database system 10 discussed herein improves the technology of database systems by enabling data to be processed at a massive scale efficiently and/or reliably.

In particular, the database system 10 can be operable to receive data and/or to store received data at a massive scale. For example, the parallelized input and/or storing of data by the database system 10 achieved by utilizing the parallelized data input sub-system 11 and/or the parallelized data store, retrieve, and/or process sub-system 12 can cause the database system 10 to receive records for storage at a massive scale, where millions, billions, and/or trillions of records that collectively include many Gigabytes, Terabytes, Petabytes, and/or Exabytes can be received for storage, for example, reliably, redundantly and/or with a guarantee that no received records are missing in storage and/or that no received records are duplicated in storage. This can include processing real-time and/or near-real time data streams from one or more data sources at a massive scale based on facilitating ingress of these data streams in parallel. To meet the data rates required by these one or more real-time data streams, the processing of incoming data streams can be distributed across hundreds, thousands, and/or millions of computing devices 18, nodes 37, and/or processing core resources 48 for separate, independent processing with minimal and/or no coordination. The processing of incoming data streams for storage at this scale and/or this data rate cannot practically be performed by the human mind. The processing of incoming data streams for storage at this scale and/or this data rate improves database system by enabling greater amounts of data to be stored in databases for analysis and/or by enabling real-time data to be stored and utilized for analysis. The resulting richness of data stored in the database system can improve the technology of database systems by improving the depth and/or insights of various data analyses performed upon this massive scale of data.

Additionally, the database system 10 can be operable to perform queries upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to retrieve stored records at a massive scale and/or to and/or filter, aggregate, and/or perform query operators upon records at a massive scale in conjunction with query execution, where millions, billions, and/or trillions of records that collectively include many Gigabytes, Terabytes, Petabytes, and/or Exabytes can be accessed and processed in accordance with execution of one or more queries at a given time, for example, reliably, redundantly and/or with a guarantee that no records are inadvertently missing from representation in a query resultant and/or duplicated in a query resultant. To execute a query against a massive scale of records in a reasonable amount of time such as a small number of seconds, minutes, or hours, the processing of a given query can be distributed across hundreds, thousands, and/or millions of computing devices 18, nodes 37, and/or processing core resources 48 for separate, independent processing with minimal and/or no coordination. The processing of queries at this massive scale and/or this data rate cannot practically be performed by the human mind. The processing of queries at this massive scale improves the technology of database systems by facilitating greater depth and/or insights of query resultants for queries performed upon this massive scale of data.

Furthermore, the database system 10 can be operable to perform multiple queries concurrently upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to perform multiple queries concurrently, for example, in parallel, against data at this massive scale, where hundreds and/or thousands of queries can be performed against the same, massive scale dataset within a same time frame and/or in overlapping time frames. To execute multiple concurrent queries against a massive scale of records in a reasonable amount of time such as a small number of seconds, minutes, or hours, the processing of a multiple queries can be distributed across hundreds, thousands, and/or millions of computing devices 18, nodes 37, and/or processing core resources 48 for separate, independent processing with minimal and/or no coordination. A given computing devices 18, nodes 37, and/or processing core resources 48 may be responsible for participating in execution of multiple queries at a same time and/or within a given time frame, where its execution of different queries occurs within overlapping time frames. The processing of many concurrent queries at this massive scale and/or this data rate cannot practically be performed by the human mind. The processing of concurrent queries improves the technology of database systems by facilitating greater numbers of users and/or greater numbers of analyses to be serviced within a given time frame and/or over time.

FIGS. 15-23 are schematic block diagrams of an example of processing a table or data set for storage in the database system 10. FIG. 15 illustrates an example of a data set or table that includes 32 columns and 80 rows, or records, that is received by the parallelized data input-subsystem. This is a very small table, but is sufficient for illustrating one or more concepts regarding one or more aspects of a database system. The table is representative of a variety of data ranging from insurance data, to financial data, to employee data, to medical data, and so on.

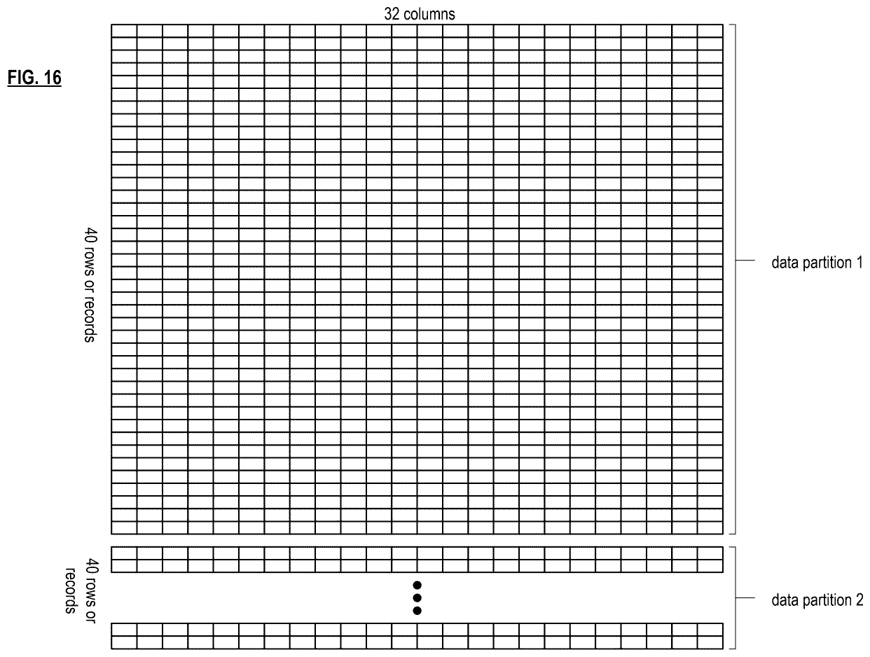

FIG. 16 illustrates an example of the parallelized data input-subsystem dividing the data set into two partitions. Each of the data partitions includes 40 rows, or records, of the data set. In another example, the parallelized data input-subsystem divides the data set into more than two partitions. In yet another example, the parallelized data input-subsystem divides the data set into many partitions and at least two of the partitions have a different number of rows.

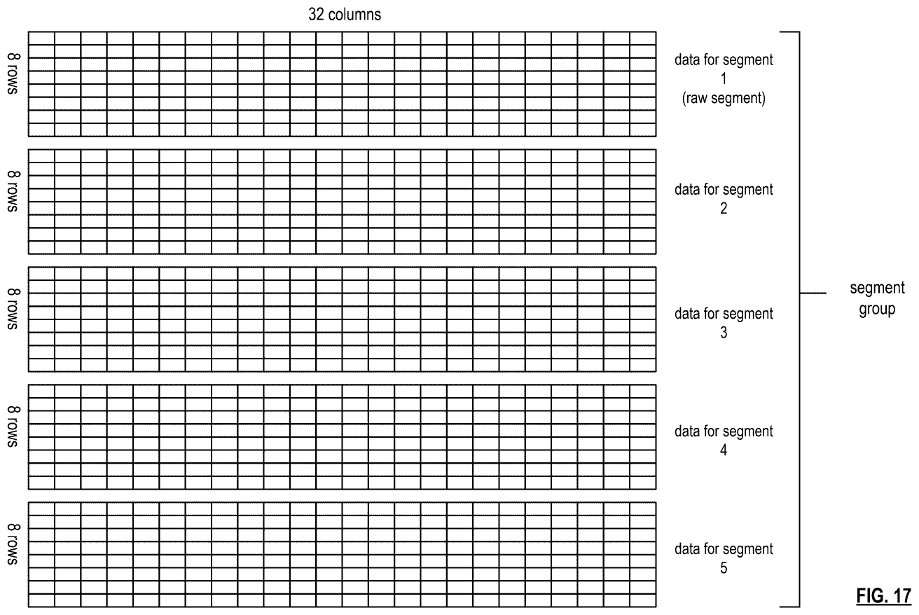

FIG. 17 illustrates an example of the parallelized data input-subsystem dividing a data partition into a plurality of segments to form a segment group. The number of segments in a segment group is a function of the data redundancy encoding. In this example, the data redundancy encoding is single parity encoding from four data pieces; thus, five segments are created. In another example, the data redundancy encoding is a two parity encoding from four data pieces; thus, six segments are created. In yet another example, the data redundancy encoding is single parity encoding from seven data pieces; thus, eight segments are created.

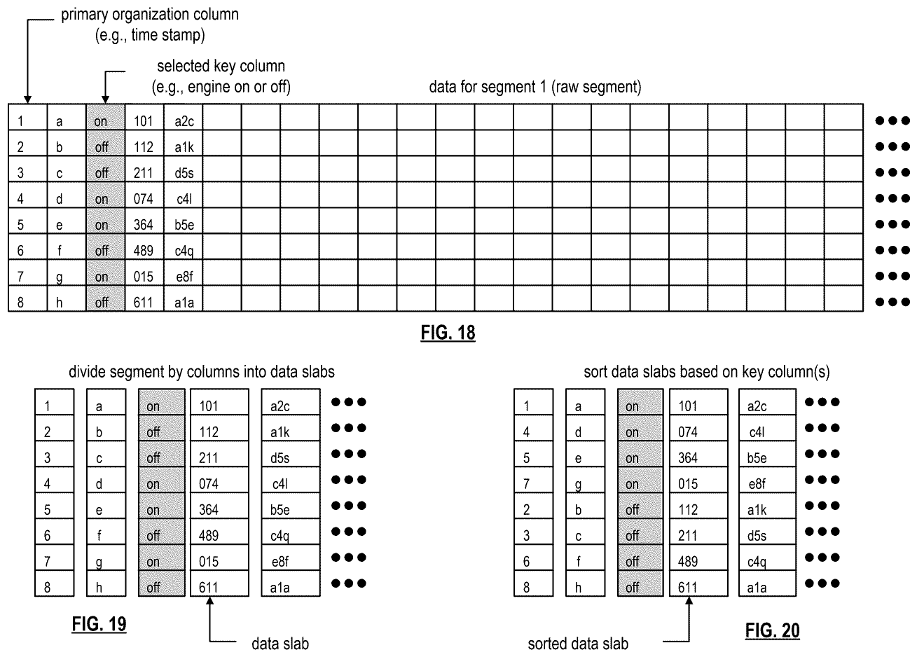

FIG. 18 illustrates an example of data for segment 1 of the segments of FIG. 17. The segment is in a raw form since it has not yet been key column sorted. As shown, segment 1 includes 8 rows and 32 columns. The third column is selected as the key column and the other columns store various pieces of information for a given row (i.e., a record). The key column may be selected in a variety of ways. For example, the key column is selected based on a type of query (e.g., a query regarding a year, where a data column is selected as the key column). As another example, the key column is selected in accordance with a received input command that identified the key column. As yet another example, the key column is selected as a default key column (e.g., a date column, an ID column, etc.)

As an example, the table is regarding a fleet of vehicles. Each row represents data regarding a unique vehicle. The first column stores a vehicle ID, the second column stores make and model information of the vehicle. The third column stores data as to whether the vehicle is on or off. The remaining columns store data regarding the operation of the vehicle such as mileage, gas level, oil level, maintenance information, routes taken, etc.

With the third column selected as the key column, the other columns of the segment are to be sorted based on the key column. Prior to being sorted, the columns are separated to form data slabs. As such, one column is separated out to form one data slab.

FIG. 19 illustrates an example of the parallelized data input-subsystem dividing segment 1 of FIG. 18 into a plurality of data slabs. A data slab is a column of segment 1. In this figure, the data of the data slabs has not been sorted. Once the columns have been separated into data slabs, each data slab is sorted based on the key column. Note that more than one key column may be selected and used to sort the data slabs based on two or more other columns.

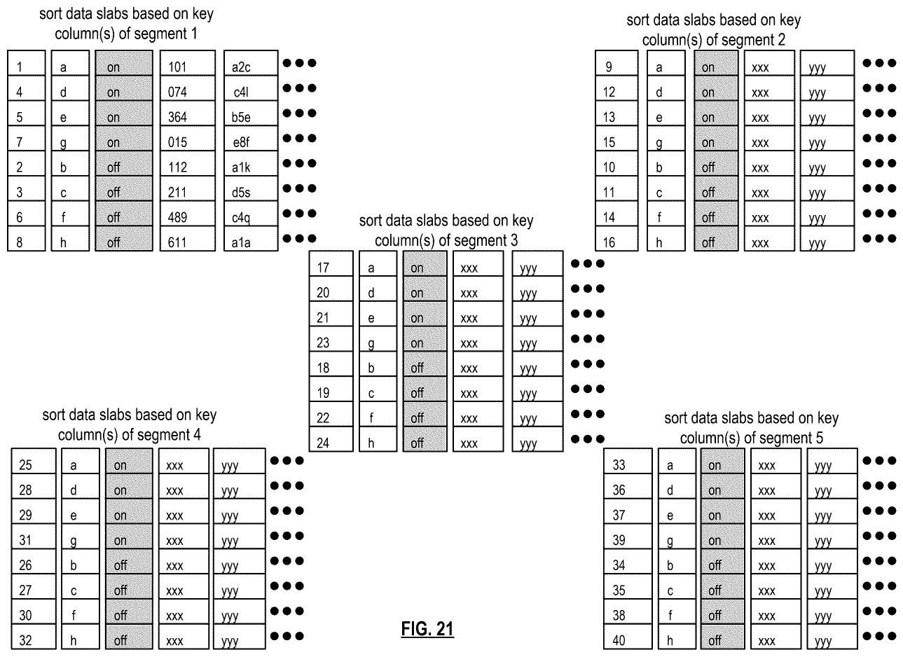

FIG. 20 illustrates an example of the parallelized data input-subsystem sorting the each of the data slabs based on the key column. In this example, the data slabs are sorted based on the third column which includes data of “on” or “off”. The rows of a data slab are rearranged based on the key column to produce a sorted data slab. Each segment of the segment group is divided into similar data slabs and sorted by the same key column to produce sorted data slabs.

FIG. 21 illustrates an example of each segment of the segment group sorted into sorted data slabs. The similarity of data from segment to segment is for the convenience of illustration. Note that each segment has its own data, which may or may not be similar to the data in the other sections.

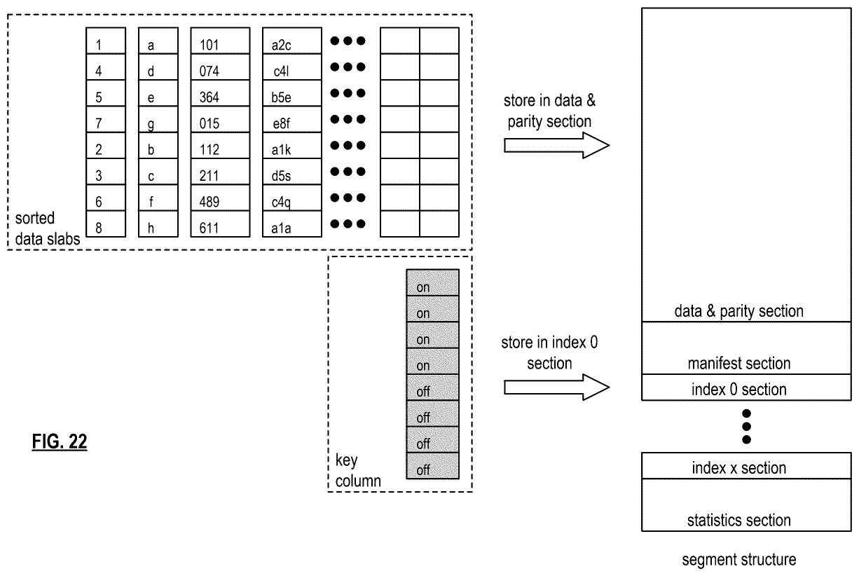

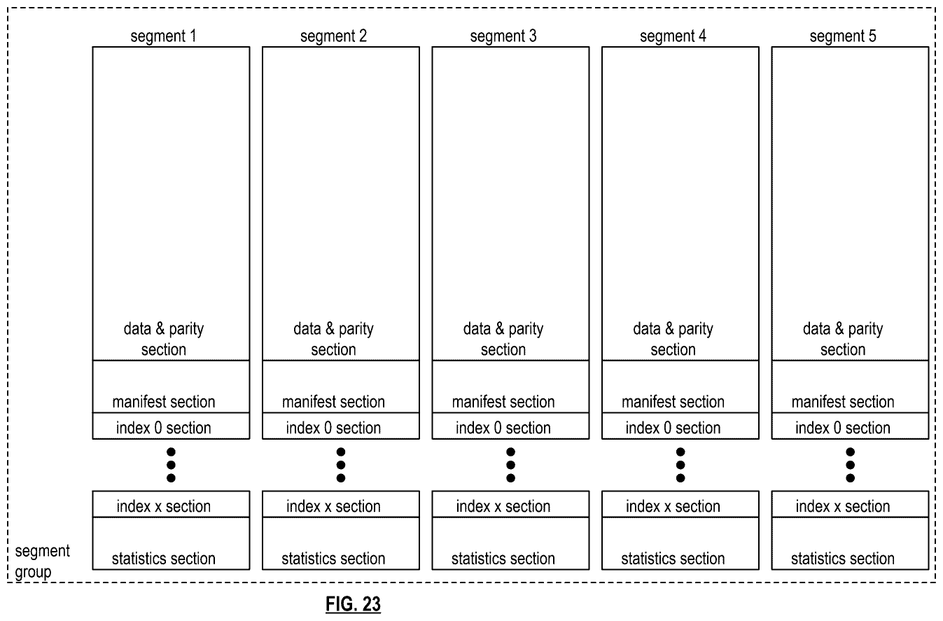

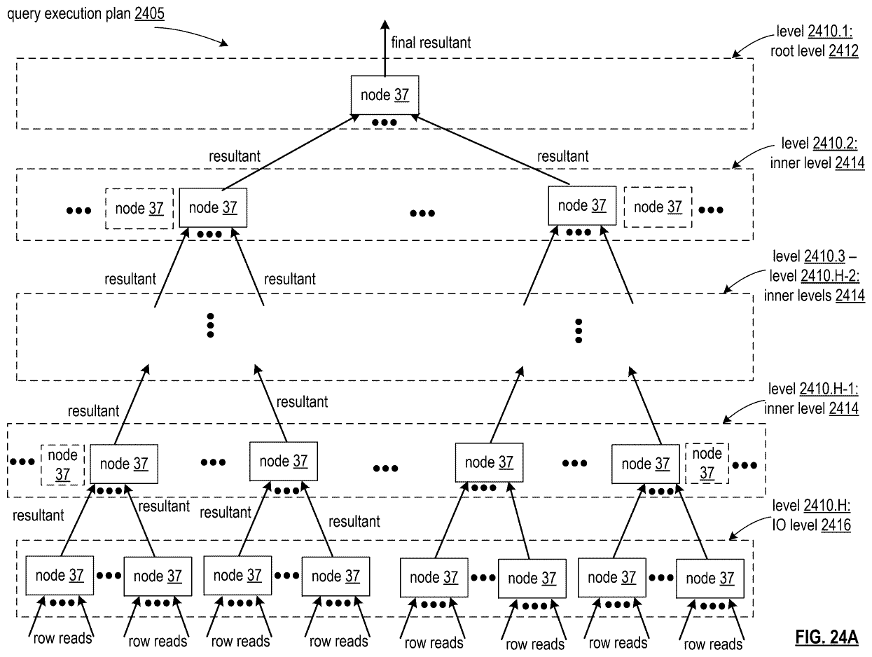

FIG. 22 illustrates an example of a segment structure for a segment of the segment group. The segment structure for a segment includes the data & parity section, a manifest section, one or more index sections, and a statistics section. The segment structure represents a storage mapping of the data (e.g., data slabs and parity data) of a segment and associated data (e.g., metadata, statistics, key column(s), etc.) regarding the data of the segment. The sorted data slabs of FIG. 16 of the segment are stored in the data & parity section of the segment structure. The sorted data slabs are stored in the data & parity section in a compressed format or as raw data (i.e., non-compressed format). Note that a segment structure has a particular data size (e.g., 32 Giga-Bytes) and data is stored within coding block sizes (e.g., 4 Kilo-Bytes).

Before the sorted data slabs are stored in the data & parity section, or concurrently with storing in the data & parity section, the sorted data slabs of a segment are redundancy encoded. The redundancy encoding may be done in a variety of ways. For example, the redundancy encoding is in accordance with RAID 5, RAID 6, or RAID 10. As another example, the redundancy encoding is a form of forward error encoding (e.g., Reed Solomon, Trellis, etc.). As another example, the redundancy encoding utilizes an erasure coding scheme.

The manifest section stores metadata regarding the sorted data slabs. The metadata includes one or more of, but is not limited to, descriptive metadata, structural metadata, and/or administrative metadata. Descriptive metadata includes one or more of, but is not limited to, information regarding data such as name, an abstract, keywords, author, etc. Structural metadata includes one or more of, but is not limited to, structural features of the data such as page size, page ordering, formatting, compression information, redundancy encoding information, logical addressing information, physical addressing information, physical to logical addressing information, etc. Administrative metadata includes one or more of, but is not limited to, information that aids in managing data such as file type, access privileges, rights management, preservation of the data, etc.

The key column is stored in an index section. For example, a first key column is stored in index #0. If a second key column exists, it is stored in index #1. As such, for each key column, it is stored in its own index section. Alternatively, one or more key columns are stored in a single index section.

The statistics section stores statistical information regarding the segment and/or the segment group. The statistical information includes one or more of, but is not limited, to number of rows (e.g., data values) in one or more of the sorted data slabs, average length of one or more of the sorted data slabs, average row size (e.g., average size of a data value), etc. The statistical information includes information regarding raw data slabs, raw parity data, and/or compressed data slabs and parity data.

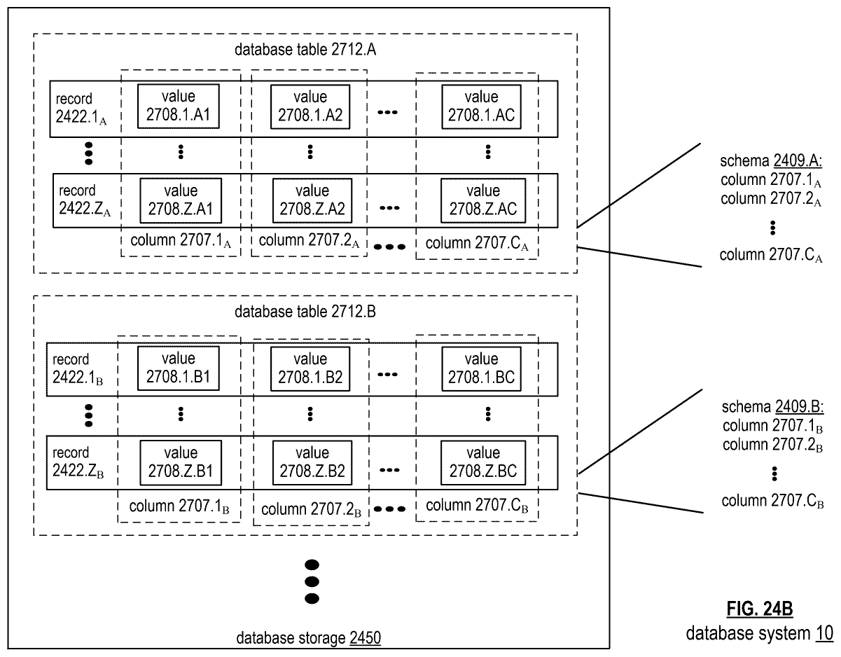

FIG. 23 illustrates the segment structures for each segment of a segment group having five segments. Each segment includes a data & parity section, a manifest section, one or more index sections, and a statistic section. Each segment is targeted for storage in a different computing device of a storage cluster. The number of segments in the segment group corresponds to the number of computing devices in a storage cluster. In this example, there are five computing devices in a storage cluster. Other examples include more or less than five computing devices in a storage cluster.

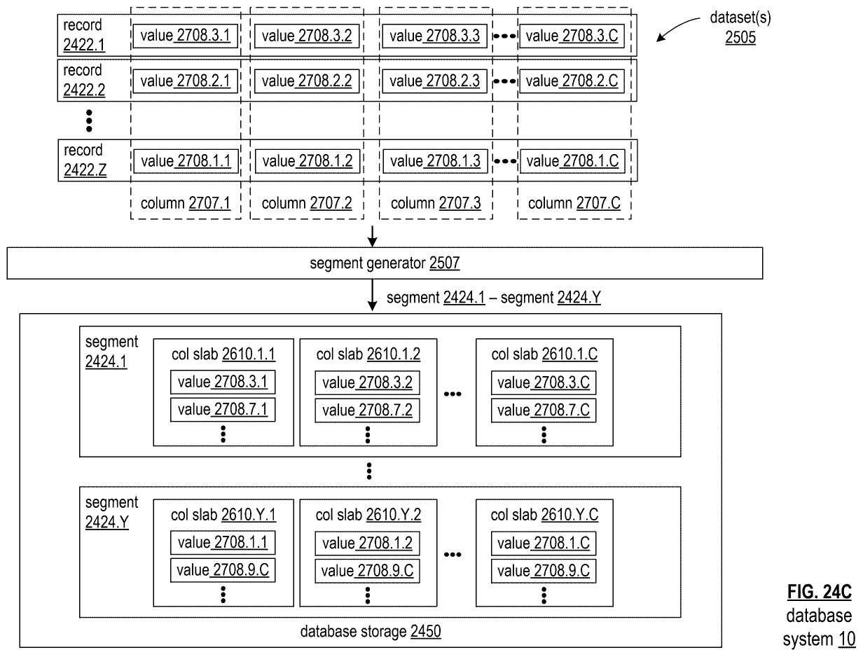

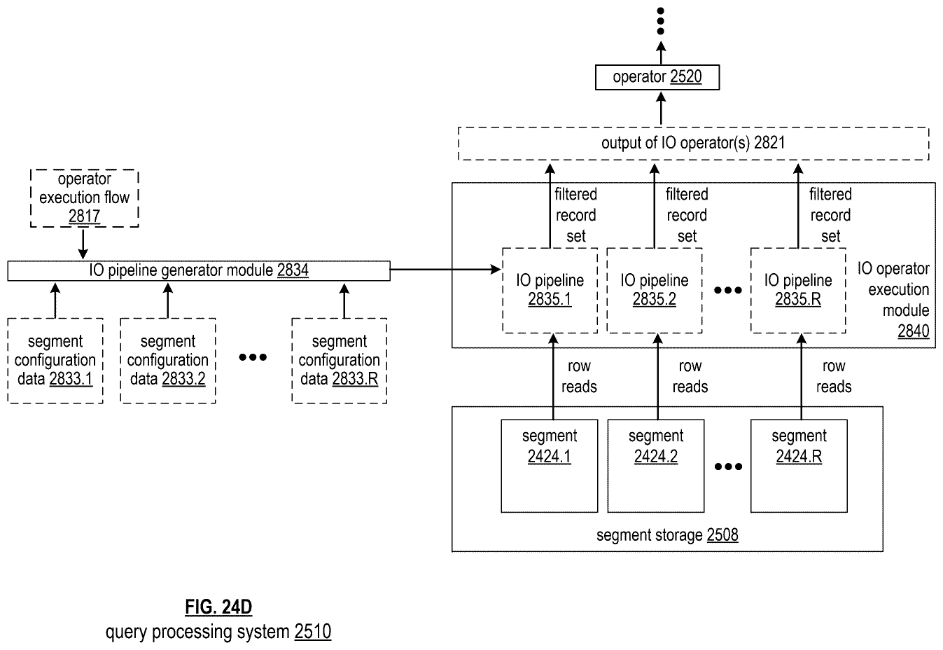

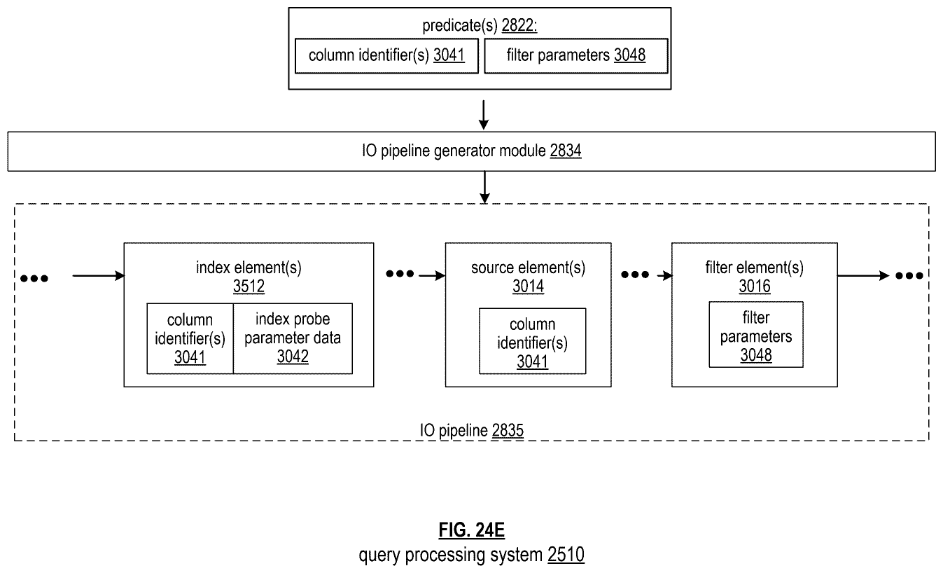

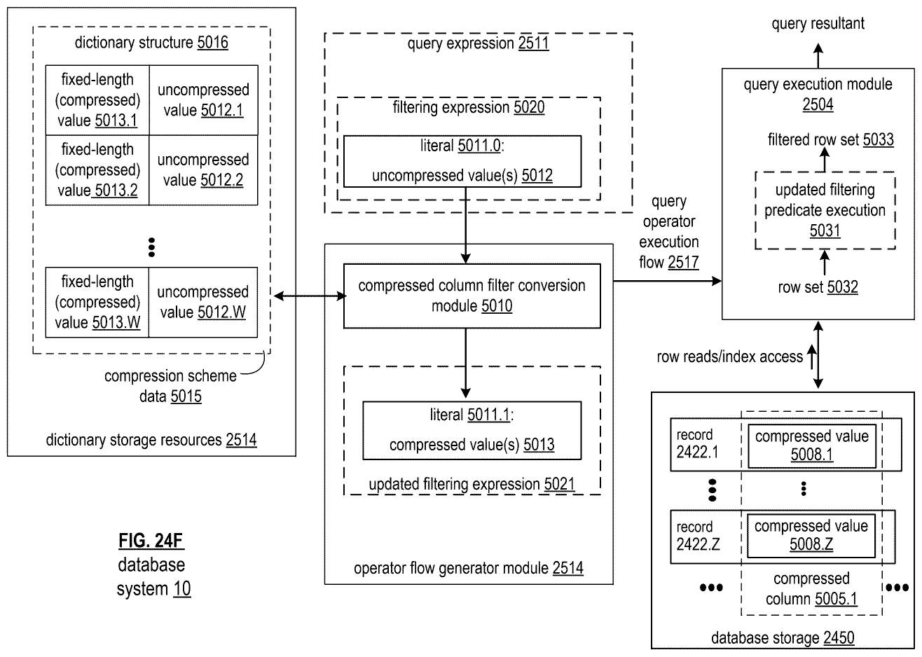

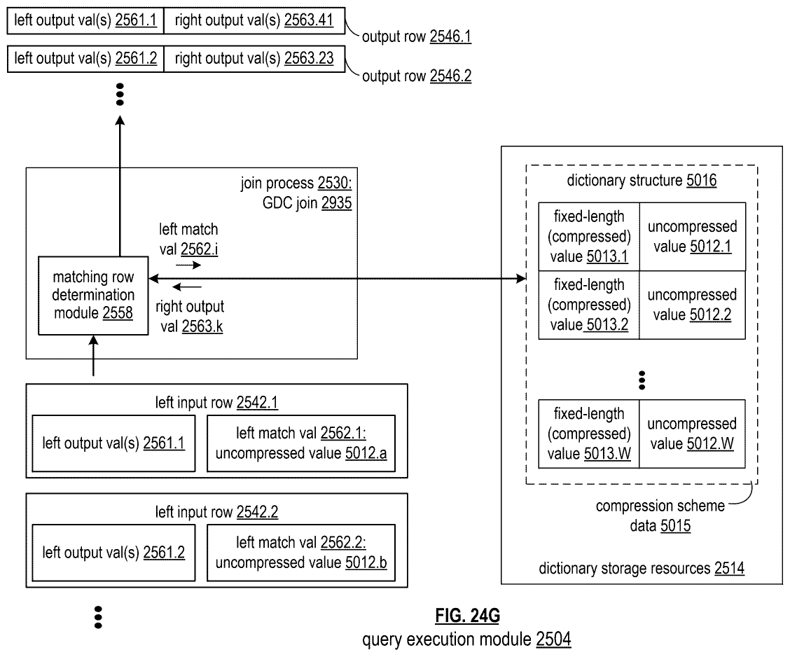

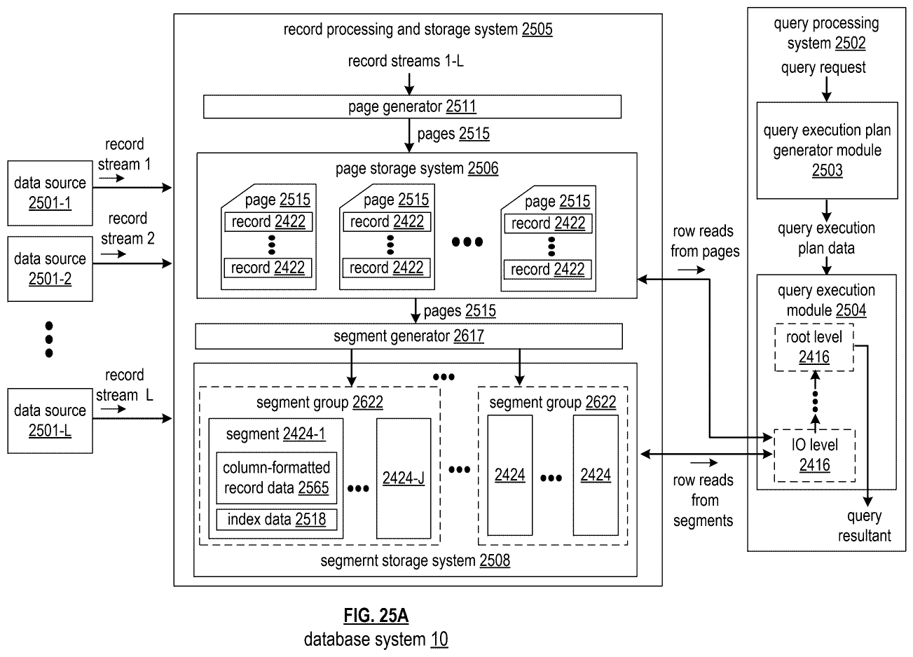

FIG. 24A illustrates an example of a query execution plan 2405 implemented by the database system 10 to execute one or more queries by utilizing a plurality of nodes 37. Each node 37 can be utilized to implement some or all of the plurality of nodes 37 of some or all computing devices 18-1-18-n, for example, of the of the parallelized data store, retrieve, and/or process sub-system 12, and/or of the parallelized query and results sub-system 13. The query execution plan can include a plurality of levels 2410. In this example, a plurality of H levels in a corresponding tree structure of the query execution plan 2405 are included. The plurality of levels can include a top, root level 2412; a bottom, IO level 2416, and one or more inner levels 2414. In some embodiments, there is exactly one inner level 2414, resulting in a tree of exactly three levels 2410.1, 2410.2, and 2410.3, where level 2410.H corresponds to level 2410.3. In such embodiments, level 2410.2 is the same as level 2410.H−1, and there are no other inner levels 2410.3-2410.H−2. Alternatively, any number of multiple inner levels 2414 can be implemented to result in a tree with more than three levels.

This illustration of query execution plan 2405 illustrates the flow of execution of a given query by utilizing a subset of nodes across some or all of the levels 2410. In this illustration, nodes 37 with a solid outline are nodes involved in executing a given query. Nodes 37 with a dashed outline are other possible nodes that are not involved in executing the given query, but could be involved in executing other queries in accordance with their level of the query execution plan in which they are included.

Each of the nodes of IO level 2416 can be operable to, for a given query, perform the necessary row reads for gathering corresponding rows of the query. These row reads can correspond to the segment retrieval to read some or all of the rows of retrieved segments determined to be required for the given query. Thus, the nodes 37 in level 2416 can include any nodes 37 operable to retrieve segments for query execution from its own storage or from storage by one or more other nodes; to recover segment for query execution via other segments in the same segment grouping by utilizing the redundancy error encoding scheme; and/or to determine which exact set of segments is assigned to the node for retrieval to ensure queries are executed correctly.

IO level 2416 can include all nodes in a given storage cluster 35 and/or can include some or all nodes in multiple storage clusters 35, such as all nodes in a subset of the storage clusters 35-1-35-z and/or all nodes in all storage clusters 35-1-35-z. For example, all nodes 37 and/or all currently available nodes 37 of the database system 10 can be included in level 2416. As another example, IO level 2416 can include a proper subset of nodes in the database system, such as some or all nodes that have access to stored segments and/or that are included in a segment set. In some cases, nodes 37 that do not store segments included in segment sets, that do not have access to stored segments, and/or that are not operable to perform row reads are not included at the IO level, but can be included at one or more inner levels 2414 and/or root level 2412.

The query executions discussed herein by nodes in accordance with executing queries at level 2416 can include retrieval of segments; extracting some or all necessary rows from the segments with some or all necessary columns; and sending these retrieved rows to a node at the next level 2410.H−1 as the query resultant generated by the node 37. For each node 37 at IO level 2416, the set of raw rows retrieved by the node 37 can be distinct from rows retrieved from all other nodes, for example, to ensure correct query execution. The total set of rows and/or corresponding columns retrieved by nodes 37 in the IO level for a given query can be dictated based on the domain of the given query, such as one or more tables indicated in one or more SELECT statements of the query, and/or can otherwise include all data blocks that are necessary to execute the given query.

Each inner level 2414 can include a subset of nodes 37 in the database system 10. Each level 2414 can include a distinct set of nodes 37 and/or some or more levels 2414 can include overlapping sets of nodes 37. The nodes 37 at inner levels are implemented, for each given query, to execute queries in conjunction with operators for the given query. For example, a query operator execution flow can be generated for a given incoming query, where an ordering of execution of its operators is determined, and this ordering is utilized to assign one or more operators of the query operator execution flow to each node in a given inner level 2414 for execution. For example, each node at a same inner level can be operable to execute a same set of operators for a given query, in response to being selected to execute the given query, upon incoming resultants generated by nodes at a directly lower level to generate its own resultants sent to a next higher level. In particular, each node at a same inner level can be operable to execute a same portion of a same query operator execution flow for a given query. In cases where there is exactly one inner level, each node selected to execute a query at a given inner level performs some or all of the given query's operators upon the raw rows received as resultants from the nodes at the IO level, such as the entire query operator execution flow and/or the portion of the query operator execution flow performed upon data that has already been read from storage by nodes at the IO level. In some cases, some operators beyond row reads are also performed by the nodes at the IO level. Each node at a given inner level 2414 can further perform a gather function to collect, union, and/or aggregate resultants sent from a previous level, for example, in accordance with one or more corresponding operators of the given query.

The root level 2412 can include exactly one node for a given query that gathers resultants from every node at the top-most inner level 2414. The node 37 at root level 2412 can perform additional query operators of the query and/or can otherwise collect, aggregate, and/or union the resultants from the top-most inner level 2414 to generate the final resultant of the query, which includes the resulting set of rows and/or one or more aggregated values, in accordance with the query, based on being performed on all rows required by the query. The root level node can be selected from a plurality of possible root level nodes, where different root nodes are selected for different queries. Alternatively, the same root node can be selected for all queries.

As depicted in FIG. 24A, resultants are sent by nodes upstream with respect to the tree structure of the query execution plan as they are generated, where the root node generates a final resultant of the query. While not depicted in FIG. 24A, nodes at a same level can share data and/or send resultants to each other, for example, in accordance with operators of the query at this same level dictating that data is sent between nodes.

In some cases, the IO level 2416 always includes the same set of nodes 37, such as a full set of nodes and/or all nodes that are in a storage cluster 35 that stores data required to process incoming queries. In some cases, the lowest inner level corresponding to level 2410.H−1 includes at least one node from the IO level 2416 in the possible set of nodes. In such cases, while each selected node in level 2410.H−1 is depicted to process resultants sent from other nodes 37 in FIG. 24A, each selected node in level 2410.H−1 that also operates as a node at the IO level further performs its own row reads in accordance with its query execution at the IO level, and gathers the row reads received as resultants from other nodes at the IO level with its own row reads for processing via operators of the query. One or more inner levels 2414 can also include nodes that are not included in IO level 2416, such as nodes 37 that do not have access to stored segments and/or that are otherwise not operable and/or selected to perform row reads for some or all queries.

The node 37 at root level 2412 can be fixed for all queries, where the set of possible nodes at root level 2412 includes only one node that executes all queries at the root level of the query execution plan. Alternatively, the root level 2412 can similarly include a set of possible nodes, where one node selected from this set of possible nodes for each query and where different nodes are selected from the set of possible nodes for different queries. In such cases, the nodes at inner level 2410.2 determine which of the set of possible root nodes to send their resultant to. In some cases, the single node or set of possible nodes at root level 2412 is a proper subset of the set of nodes at inner level 2410.2, and/or is a proper subset of the set of nodes at the IO level 2416. In cases where the root node is included at inner level 2410.2, the root node generates its own resultant in accordance with inner level 2410.2, for example, based on multiple resultants received from nodes at level 2410.3, and gathers its resultant that was generated in accordance with inner level 2410.2 with other resultants received from nodes at inner level 2410.2 to ultimately generate the final resultant in accordance with operating as the root level node.

In some cases where nodes are selected from a set of possible nodes at a given level for processing a given query, the selected node must have been selected for processing this query at each lower level of the query execution tree. For example, if a particular node is selected to process a node at a particular inner level, it must have processed the query to generate resultants at every lower inner level and the IO level. In such cases, each selected node at a particular level will always use its own resultant that was generated for processing at the previous, lower level, and will gather this resultant with other resultants received from other child nodes at the previous, lower level. Alternatively, nodes that have not yet processed a given query can be selected for processing at a particular level, where all resultants being gathered are therefore received from a set of child nodes that do not include the selected node.

The configuration of query execution plan 2405 for a given query can be determined in a downstream fashion, for example, where the tree is formed from the root downwards. Nodes at corresponding levels are determined from configuration information received from corresponding parent nodes and/or nodes at higher levels, and can each send configuration information to other nodes, such as their own child nodes, at lower levels until the lowest level is reached. This configuration information can include assignment of a particular subset of operators of the set of query operators that each level and/or each node will perform for the query. The execution of the query is performed upstream in accordance with the determined configuration, where IO reads are performed first, and resultants are forwarded upwards until the root node ultimately generates the query result.

Some or all features and/or functionality of FIG. 24A can be performed via at least one node 37 in conjunction with system metadata applied across a plurality of nodes 37, for example, where at least one node 37 participates in some or all features and/or functionality of FIG. 24A based on receiving and storing the system metadata in local memory of the at least one node 37 as configuration data and/or based on further accessing and/or executing this configuration data to participate in a query execution plan of FIG. 24A as part of its database functionality accordingly. Performance of some or all features and/or functionality of FIG. 24A can optionally change and/or be updated over time, and/or a set of nodes participating in executing some or all features and/or functionality of FIG. 24A can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24B illustrates an embodiment of database storage 2450 operable to store a plurality of database tables 2712, such as relational database tables or other database tables as described previously herein. Database storage 2450 can be implemented via the parallelized data store, retrieve, and/or process sub-system 12, via memory drives 2425 of one or more nodes 37 implementing the database storage 2450, and/or via other memory and/or storage resources of database system 10. The database tables 2712 can be stored as segments as discussed in conjunction with FIGS. 15-23 and/or FIGS. 24B-24D. A database table 2712 can be implemented as one or more datasets and/or a portion of a given dataset, such as the dataset of FIG. 15.

A given database table 2712 can be stored based on being received for storage, for example, via the parallelized ingress sub-system 24 and/or via other data ingress. Alternatively or in addition, a given database table 2712 can be generated and/or modified by the database system 10 itself based on being generated as output of a query executed by query execution module 2504, such as a Create Table As Select (CTAS) query or Insert query.

A given database table 2712 can be in accordance with a schema 2409 defining columns of the database table, where records 2422 correspond to rows having values 2708 for some or all of these columns. Different database tables can have different numbers of columns and/or different datatypes for values stored in different columns. For example, the set of columns 2707.1A-2707.CA of schema 2709.A for database table 2712.A can have a different number of columns than and/or can have different datatypes for some or all columns of the set of columns 2707.1B-2707.CB of schema 2709.B for database table 2712.B. The schema 2409 for a given n database table 2712 can denote same or different datatypes for some or all of its set of columns. For example, some columns are variable-length and other columns are fixed-length. As another example, some columns are integers, other columns are binary values, other columns are Strings, and/or other columns are char types. The schema 2409 for a given database table can denote the name/identifier of a corresponding relational database table.

A given schema 2409 can indicate such schemas for a plurality of tables, for example, of a same dataset, same database, and/or same user entity (e.g. that has access to/supplied data for these tables under the given schema 2409). For example, a given schema 2409 is configured by/otherwise corresponds to a given user entity.

Row reads performed during query execution, such as row reads performed at the IO level of a query execution plan 2405, can be performed by reading values 2708 for one or more specified columns 2707 of the given query for some or all rows of one or more specified database tables, as denoted by the query expression defining the query to be performed. Filtering, join operations, and/or values included in the query resultant can be further dictated by operations to be performed upon the read values 2708 of these one or more specified columns 2707.

In an embodiment, the plurality of tables 2712 of database storage 2450 are stored across a plurality of segments 2424 and/or are otherwise in accordance with a columnar format (e.g. sorted by cluster key and/or by values of one or more columns). For example, a given table 2712 is stored across a plurality of segments 2424 stored across a plurality of nodes 37 of at least one storage cluster, where each of the plurality of segments stores a respective subset of records 2422 of the given table 2712, and/or where each of the plurality of segments optionally stores records 2422 of only one table.

Alternatively or in addition, the plurality of tables 2712 of database storage 2450 can be stored across a plurality of other data structures, such as objects, files, and/or binary large objects (blobs), for example, stored via an object storage system implementing database storage 2450, for example, in conjunction with database system 10 implementing and/or communicating with a data storage platform a data lake architecture and/or data Lakehouse architecture. For example, a given table is stored across a plurality of files (or objects or blobs) having the same or different file type and/or structuring (e.g. the plurality of files of a given table includes files of one or more file formats that includes: a first plurality of files corresponding to structured data, a second plurality of files corresponding to semi-structured data, and/or a third plurality of files corresponding to unstructured data). In an embodiment, the given table 2712 is defined via an open table format (e.g. via utilizing Apache Iceberg, Delta Lake, and/or other open table format) where database storage 2450 implementing a metadata layer (e.g. implemented in conjunction with implementing an open table format) in conjunction with a data lake to implement a corresponding data Lakehouse architecture.

In an embodiment, some or all files of the database storage 2450 do not correspond to and/or do not explicitly contain records 2422 of any relational database table and/or any other table having a predetermined schema. Database system 10 can be operable to execute queries against such files of database storage 2450 and/or their underlying data to identify, access, and/or process some or all data contained in some or all files based on other extracted and/or automatically determined attributes of the files and/or underlying data (e.g. meeting specified filtering parameters or other parameters of the respective query), for example, based on processing metadata associated with the files and/or extracting data included in the files.

FIG. 24C illustrates an embodiment of a database system 10 that implements a segment generator 2507 to generate segments 2424. Some or all features and/or functionality of the database system 10 of FIG. 24C can implement any embodiment of the database system 10 described herein. Some or all features and/or functionality of segments 2424 of FIG. 24C can implement any embodiment of segment 2424 described herein.

A plurality of records 2422.1-2422.Z of one or more datasets 2505 to be converted into segments can be processed to generate a corresponding plurality of segments 2424.1-2424.Y. Each segment can include a plurality of column slabs 2610.1-2610.C corresponding to some or all of the C columns of the set of records.

In an embodiment, the dataset 2505 can correspond to a given database table 2712. In an embodiment, the dataset 2505 can correspond to only portion of a given database table 2712 (e.g. the most recently received set of records of a stream of records received for the table over time), where other datasets 2505 are later processed to generate new segments as more records are received over time. In an embodiment, the dataset 2505 can correspond to multiple database tables. The dataset 2505 optionally includes non-relational records and/or any records/files/data that is received from/generated by a given data source multiple different data sources.

Each record 2422 of the incoming dataset 2505 can be assigned to be included in exactly one segment 2424. In this example, segment 2424.1 includes at least records 2422.3 and 2422.7, while segment 2424 includes at least records 2422.1 and 2422.9. All of the Z records can be guaranteed to be included in exactly one segment by segment generator 2507. Rows are optionally grouped into segments based on a cluster-key based grouping or other grouping by same or similar column values of one or more columns. Alternatively, rows are optionally grouped randomly, in accordance with a round robin fashion, or by any other means.

A given row 2422 can thus have all of its column values 2708.1-2708.C included in exactly one given segment 2424, where these column values are dispersed across different column slabs 2610 based on which columns each column value corresponds. This division of column values into different column slabs can implement the columnar-format of segments described herein. The generation of column slabs can optionally include further processing of each set of column values assigned to each column slab. For example, some or all column slabs are optionally compressed and stored as compressed column slabs.

The database storage 2450 can thus store one or more datasets as segments 2424, for example, where these segments 2424 are accessed during query execution to identify/read values of rows of interest as specified in query predicates, where these identified rows/the respective values are further filtered/processed/etc., for example, via operators 2520 of a corresponding query operator execution flow 2517, or otherwise accordance with the query to render generation of the query resultant.

FIG. 24D illustrates an embodiment of a query processing system 2510 that implements an IO pipeline generator module 2834 to generate a plurality of IO pipelines 2835.1-2835.R for a corresponding plurality of segments 2424.1-2424.R, where these IO pipelines 2835.1-2835.R are each executed by an IO operator execution module 2840 to facilitate generation of a filtered record set by accessing the corresponding segment. Some or all features and/or functionality of the query processing system 2510 of FIG. 24D can implement any embodiment of query processing system 2510, any embodiment of query execution module 2504, and/or any embodiment of executing a query described herein.

Each IO pipeline 2835 can be generated based on corresponding segment configuration data 2833 for the corresponding segment 2424, such as secondary indexing data for the segment, statistical data/cardinality data for the segment, compression schemes applied to the column slabs of the segment, or other information denoting how the segment is configured. For example, different segments 2424 have different IO pipelines 2835 generated for a given query based on having different secondary indexing schemes, different statistical data/cardinality data for its values, different compression schemes applied for some or all of the columns of its records, or other differences.

An IO operator execution module 2840 can execute each respective IO pipeline 2835. For example, the IO operator execution module 2840 is implemented by nodes 37 at the IO level of a corresponding query execution plan 2405, where a node 37 storing a given segment 2424 is responsible for accessing the segment as described previously, and thus executes the IO pipeline for the given segment.

This execution of IO pipelines 2835 by IO operator execution module 2840 correspond to executing IO operators 2421 of a query operator execution flow 2517. The output of IO operators 2421 can correspond to output of IO operators 2421 and/or output of IO level. This output can correspond to data blocks that are further processed via additional operators 2520, for example, by nodes at inner levels and/or the root level of a corresponding query execution plan.

Each IO pipeline 2835 can be generated based on pushing some or all filtering down to the IO level, where query predicates are applied via the IO pipeline based on accessing index structures, sourcing values, filtering rows, etc. Each IO pipeline 2835 can be generated to render semantically equivalent application of query predicates, despite differences in how the IO pipeline is arranged/executed for the given segment. For example, an index structure of a first segment is used to identify a set of rows meeting a condition for a corresponding column in a first corresponding IO pipeline while a second segment has its row values sourced and compared to a value to identify which rows meet the condition, for example, based on the first segment having the corresponding column indexed and the second segment not having the corresponding column indexed. As another example, the IO pipeline for a first segment applies a compressed column slab processing element to identify where rows are stored in a compressed column slab and to further facilitate decompression of the rows, while a second segment accesses this column slab directly for the corresponding column based on this column being compressed in the first segment and being uncompressed for the second segment.

FIG. 24E illustrates an example embodiment of an IO pipeline 2835 that is generated to include one or more index elements 3512, one or more source elements 3014, and/or one or more filter elements 3016. These elements can be arranged in a serialized ordering that includes one or more parallelized paths (e.g. the IO pipeline includes an acyclic directed graph of elements). These elements can implement sourcing and/or filtering of rows based on query predicates 2822 applied to one or more columns, identified by corresponding column identifiers 3041 and corresponding filter parameters 3048.

In an embodiment, the IO pipeline generator module 2834, IO pipeline 2835, IO operator execution module 2840, and/or any embodiment of IO pipeline generation and/or IO pipeline execution described herein, implements some or all features and/or functionality of the IO pipeline generator module 2834, IO pipeline 2835, IO operator execution module 2840, and/or pushing of filtering and/or other operations to the IO level as disclosed by: U.S. Utility application Ser. No. 17/303,437, entitled “QUERY EXECUTION UTILIZING PROBABILISTIC INDEXING” and filed May 28, 2021; U.S. Utility application Ser. No. 17/450,109, entitled “MISSING DATA-BASED INDEXING IN DATABASE SYSTEMS” and filed Oct. 6, 2021; U.S. Utility application Ser. No. 18/310,177, entitled “OPTIMIZING AN OPERATOR FLOW FOR PERFORMING AGGREGATION VIA A DATABASE SYSTEM” and filed May 1, 2023; U.S. Utility application Ser. No. 18/355,505, entitled “STRUCTURING GEOSPATIAL INDEX DATA FOR ACCESS DURING QUERY EXECUTION VIA A DATABASE SYSTEM” and filed Jul. 20, 2023; and/or U.S. Utility application Ser. No. 18/485,861, entitled “QUERY PROCESSING IN A DATABASE SYSTEM BASED ON APPLYING A DISJUNCTION OF CONJUNCTIVE NORMAL FORM PREDICATES” and filed Oct. 12, 2023; all of which hereby incorporated herein by reference in its entirety and made part of the present U.S. Utility patent application for all purposes.

FIGS. 24F and 24G illustrate embodiments of a database system 10 that utilizes a dictionary structure to store compressed columns. Some or all features and/or functionality of the dictionary structure 5016 of FIGS. 24F and/or 24G can implement any compression scheme data and/or means of generating and/or accessing compressed columns described herein. Any other features and/or functionality of database system 10 of FIGS. 24F and/or 24G can implement any other embodiment of database system 10 described herein.

In an embodiment, columns are compressed as compressed columns 5005 based on a globally maintained dictionary (e.g. dictionary structure 5016), for example, in conjunction with applying Global Dictionary Compression (GDC). Applying Global Dictionary Compression can include replaces variable length column values with fixed length integers on disk (e.g. in database storage 2450), where the globally maintained dictionary is stored elsewhere, for example, via different (e.g. slower/less efficient) memory resources of a different type/in a different location from the database storage 2450 that stores the compressed columns 5005 accessed during query execution.

The dictionary structure can store a plurality of fixed-length, compressed values 5013 (e.g. integers) each mapped to a single uncompressed value 5012 (e.g. variable-length values, such as strings). The mapping of compressed values 5013 to uncompressed values 5012 can be in accordance with a one-to-one mapping. The mapping of compressed values 5013 to uncompressed values 5012 can be based on utilizing the fixed-length values 5013 as keys of a corresponding map and/or dictionary data structure, and/or can be based on utilizing the uncompressed values 5012 as keys of a corresponding map and/or dictionary data structure.

A given uncompressed value 5012 that is included in many rows of one or more tables can be replaced (i.e. “compressed”) via a same corresponding compressed value 5013 mapped to this uncompressed value 5012 as the compressed value 5008 for these rows in compressed column 5005 in database storage. As new rows are received for storage over time, their column values for one or more compressed columns 5005 can be replaced via corresponding compressed values 5008 based on accessing the dictionary structure and determining whether the uncompressed value 5012 of this column is stored in the dictionary structure 5016. If yes, the compressed value 5013 mapped to the uncompressed value 5012 in this existing entry is stored as compressed value 5008 in the compressed column 5005 in the database storage 2450. If no, the dictionary structure 5016 can be updated to include a new entry that includes the uncompressed value 5012 and a new compressed value 5013 (e.g. different from all existing compressed values in the structure) generated for this uncompressed value 5012, where this new compressed value 5013 is stored as is applied as compressed value 5008 in the database storage 2450.

The dictionary structure 5016 can be stored in dictionary storage resources 2514, which can be different types of resources from and/or can be stored in a different location from the database storage 2450 storing the compressed columns for query execution. In an embodiment, the dictionary storage resources 2514 storing dictionary structure 5016 can be considered a portion/type of memory as of database storage 2450 that are accessed during query execution as necessary for decompressing column values. In an embodiment, the dictionary storage resources 2514 storing dictionary structure 5016 can be implemented as metadata storage resources, for example, implemented by a metadata consensus state mediated via a metadata storage cluster of nodes maintaining system metadata such as GDCs of the database system 10.

The dictionary structure 5016 can correspond to a given column 5005, where different columns optionally have their own dictionary structure 5016 built and maintained. Alternatively, a common dictionary structure 5016 can optionally be maintained for multiple columns of a same table/same dataset, and/or for multiple columns across different tables/different datasets. For example, a given uncompressed value 5012 appearing in different columns 5005 of the same or different table is compressed via the same fixed-length value 5013 as dictated by the dictionary structure 5016.

This dictionary structure 5016 can be globally maintained (e.g. across some or all nodes, indicating fixed length values mapped across one or more segments stored in conjunction with storing one or more relational database tables) and can be updated overtime (e.g. as more data is added with new variable length values requiring mapping to fixed length values). For example, the dictionary structure 5016 is maintained/stored in state data that is mediated/accessible by some or all nodes 37 of the database system 10 via the dictionary structure 5016 being included in any embodiment of state data described herein.

In an embodiment, dictionary compression via dictionary structure 5016 can implement the compression scheme utilized to generate (e.g. compress/decompress the values of) compressed columns 5005 of FIG. 24F based on implementing some or all features and/or functionality of the compression of data during ingress via a dictionary as disclosed by U.S. Utility application Ser. No. 16/985,723, entitled “DELAYING SEGMENT GENERATION IN DATABASE SYSTEMS”, filed Aug. 5, 2020, which is hereby incorporated herein by reference in its entirety and made part of the present U.S. Utility patent application for all purposes.

In an embodiment, dictionary compression via dictionary structure 5016 can implement the compression scheme utilized to generate (e.g. compress/decompress the values of) compressed columns 5005 of FIG. 24F based on implementing some or all features and/or functionality of global dictionary compression as disclosed by U.S. Utility application Ser. No. 16/220,454, entitled “DATA SET COMPRESSION WITHIN A DATABASE SYSTEM”, filed Dec. 14, 2018, issued as U.S. Pat. No. 11,256,696 on Feb. 22, 2022, which is hereby incorporated herein by reference in its entirety and made part of the present U.S. Utility patent application for all purposes.

In an embodiment, dictionary compression via dictionary structure 5016 can be utilized in performing GDC join processes during query execution to enable recovery of uncompressed values during query execution, for example, based on implementing some or all features and/or functionality of GDC joins as disclosed by U.S. Utility application Ser. No. 18/226,525, entitled “SWITCHING MODES OF OPERATION OF A ROW DISPERSAL OPERATION DURING QUERY EXECUTION”, filed Jul. 26, 2023, which is hereby incorporated herein by reference in its entirety and made part of the present U.S. Utility patent application for all purposes.

FIG. 24G illustrates an embodiment of executing a join process 2530 that is implemented as a global dictionary compression (GDC) join. This can include applying a matching row determination module 2558 via access to a dictionary structure 5016,

In an embodiment, unlike hash maps generated during query execution for access in conjunction with executing other types of JOIN operations (e.g. as described in U.S. Utility application Ser. No. 18/266,525), the dictionary structure 5016 can optionally be accessed during GDC join processes based on being globally maintained, and thus being generated prior to execution of the corresponding query. In particular, the dictionary structure 5016 can be implemented in conjunction with compressing one or more columns, such as a variable length values stored in one or more variable length columns, by mapping these variable length, uncompressed values (e.g. strings, other large values of a given column) to corresponding fixed-length, compressed values 5013 (e.g. integers or other fixed length values).

For example, segments can store the fixed length values to improve storage efficiency and/or queries can access and process these fixed length values, where the uncompressed variable length values are only required via access to dictionary structure 5016 to emit an uncompressed value 5012 for a given fixed-length value 5013 of a given input row. This functionality can be achieved via performing a corresponding join as described herein, where the matching condition 2519 is implemented for a compressed column and indicates matching by the value of the compressed column, such as simply emitting the uncompressed value mapped to the compressed column as the right output value 2563 for a given input row, implemented as a left input row 2542 of a join operation.

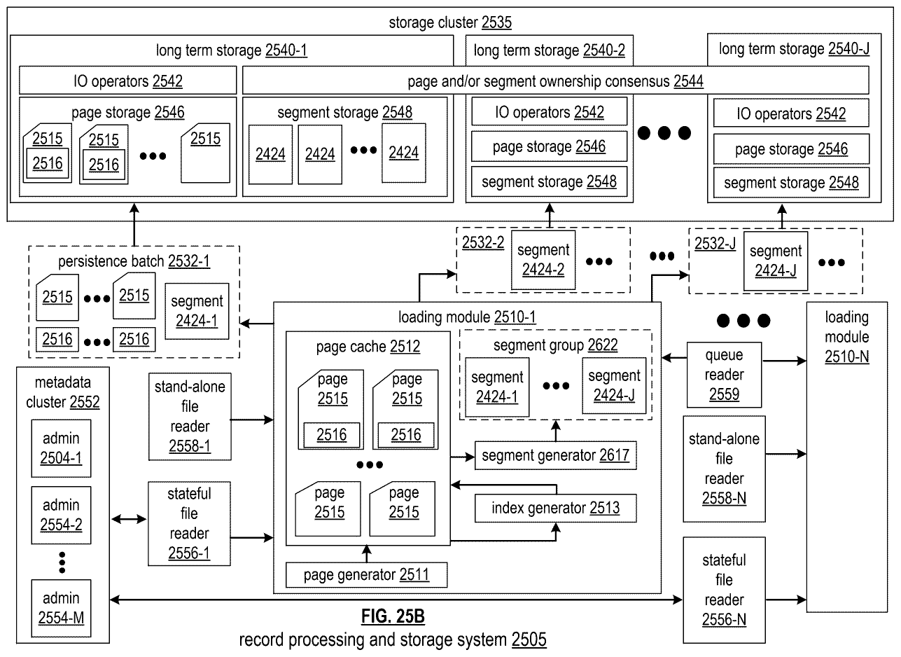

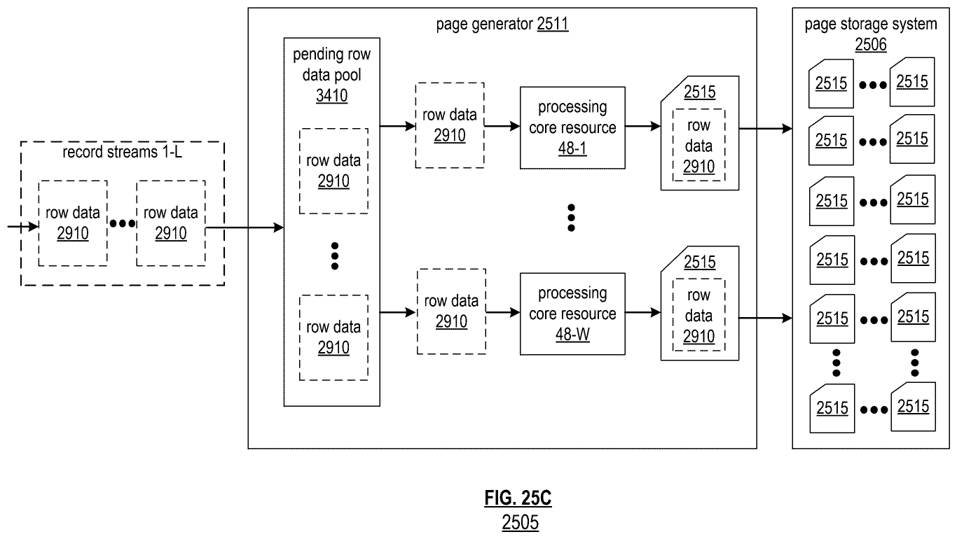

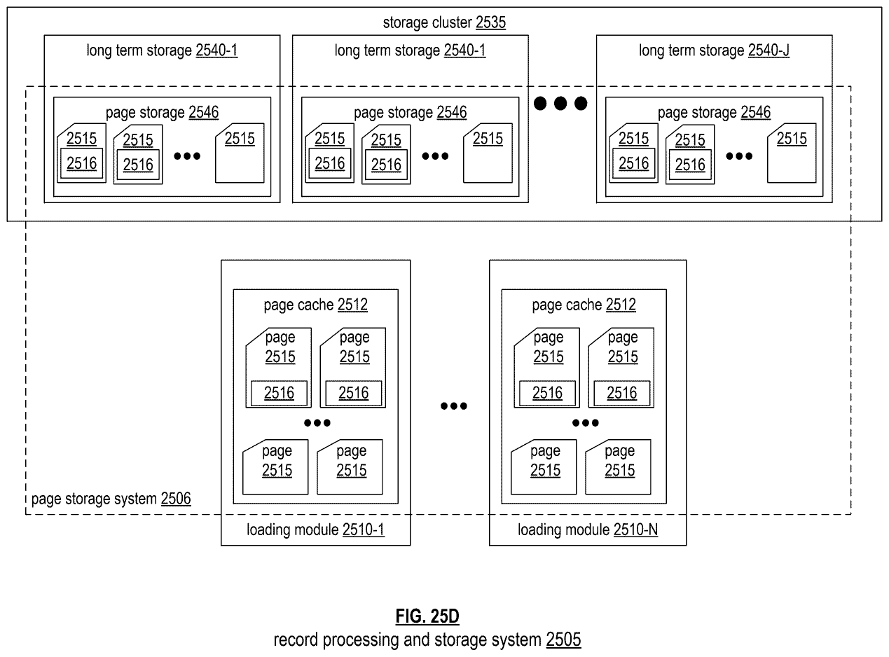

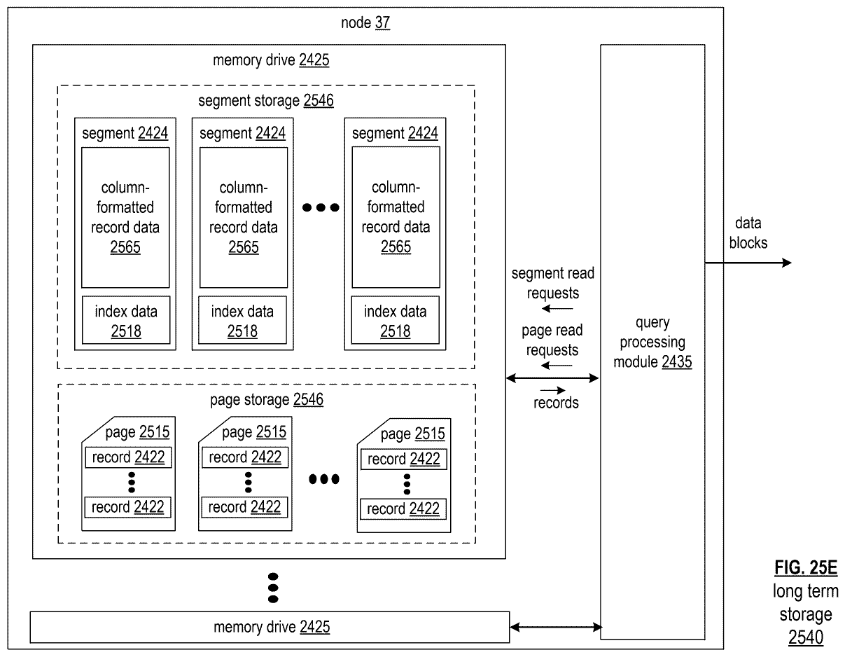

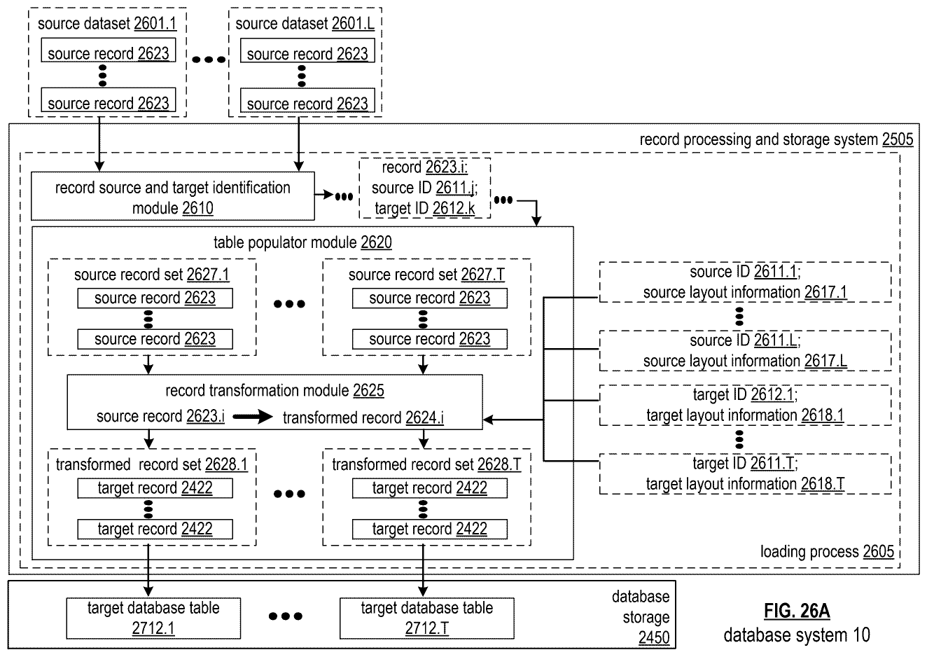

FIG. 25A illustrates an embodiment of a database system 10 that implements a record processing and storage system 2505. The record processing and storage system 2505 can be operable to generate and store the segments 2424 discussed previously by utilizing a segment generator 2617 to convert sets of row-formatted records 2422 into column-formatted record data 2565. These row-formatted records 2422 can correspond to rows of a database table with populated column values of the table, for example, where each record 2422 corresponds to a single row as illustrated in FIG. 15. For example, the segment generator 2617 can generate the segments 2424 in accordance with the process discussed in conjunction with FIGS. 15-23. The segments 2424 can be generated to include index data 2518, which can include a plurality of index sections such as the index sections 0-X illustrated in FIG. 23. The segments 2424 can optionally be generated to include other metadata, such as the manifest section and/or statistics section illustrated in FIG. 23.

The generated segments 2424 can be stored in a segment storage system 2508 for access in query executions. For example, the records 2422 can be extracted from generated segments 2424 in various query executions performed by via a query processing system 2502 of the database system 10, for example, as discussed in FIGS. 25A-25D. In particular, the segment storage system 2508 can be implemented by utilizing the memory drives 2425 of a plurality of IO level nodes 37 that are operable to store segments. As discussed previously, nodes 37 at the IO level 2416 can store segments 2424 in their memory drives 2425 as illustrated in FIG. 24C. These nodes can perform IO operations in accordance with query executions by reading rows from these segments 2424 and/or by recovering segments based on receiving segments from other nodes as illustrated in FIG. 24D. The records 2422 can be extracted from the column-formatted record data 2565 for these IO operations of query executions by utilizing the index data 2518 of the corresponding segment 2424.

To enhance the performance of query executions via access to segments 2424 to read records 2422 in this fashion, the sets of rows included in each segment are ideally clustered well. In the ideal case, rows sharing the same cluster key are stored together in the same segment or same group of segments. For example, rows having matching values of key columns(s) of FIG. 18 utilized to sort the rows into groups for conversion into segments are ideally stored in the same segments. As used herein, a cluster key can be implemented as any one or more columns, such as key columns(s) of FIG. 18, that are utilized to cluster records into segment groups for segment generation. As used herein, more favorable levels of clustering correspond to more rows with same or similar cluster keys being stored in the same segments, while less favorable levels of clustering correspond to less rows with same or similar cluster keys being stored in the same segments. More favorable levels of clustering can achieve more efficient query performance. In particular, query filtering parameters of a given query can specify particular sets of records with particular cluster keys be accessed, and if these records are stored together, fewer segments, memory drives, and/or nodes need to be accessed and/or utilized for the given query.

These favorable levels of clustering can be hard to achieve when relying upon the incoming ordering of records in record streams 1-L from a set of data sources 2501-1-2501-L. No assumptions can necessarily be made about the clustering, with respect to the cluster key, of rows presented by external sources as they are received in the data stream. For example, the cluster key value of a given row received at a first time t₁ gives no information about the cluster key value of a row received at a second time t₂ after t₁. It would therefore be unideal to frequently generate segments by performing a clustering process to group the most recently received records by cluster key. In particular, because records received within a given time frame from a particular data source may not be related and have many different cluster key values, the resulting record groups utilized to generate segments would render unfavorable levels of clustering.

To achieve more favorable levels of clustering, the record processing and storage system 2505 implements a page generator 2511 and a page storage system 2506 to store a plurality of pages 2515. The page generator 2511 is operable to generate pages 2515 from incoming records 2422 of record streams 1-L, for example, as is discussed in further detail in conjunction with FIG. 25C. Each page 2515 generated by the page generator 2511 can include a set of records, for example, in their original row format and/or in a data format as received from data sources 2501-1-2501-L. Once generated, the pages 2515 can be stored in a page storage system 2506, which can be implemented via memory drives and/or cache memory of one or more computing devices 18, such as some or all of the same or different nodes 37 storing segments 2424 as part of the segment storage system 2508.

This generation and storage of pages 2515 stored by can serve as temporary storage of the incoming records as they await conversion into segments 2424. Pages 2515 can be generated and stored over lengthy periods of time, such as hours or days. During this length time frame, pages 2515 can continue to be accumulated as one or more record streams of incoming records 1-L continue to supply additional records for storage by the database system.

The plurality of pages generated and stored over this period of time can be converted into segments, for example once a sufficient amount of records have been received and stored as pages, and/or once the page storage system 2506 runs out of memory resources to store any additional pages. It can be advantageous to accumulate and store as many records as possible in pages 2515 prior to conversion to achieve more favorable levels of clustering. In particular, performing a clustering process upon a greater numbers of records, such as the greatest number of records possible can achieve more favorable levels of clustering, For example, greater numbers of records with common cluster keys are expected to be included in the total set of pages 2515 of the page storage system 2506 when the page storage system 2506 accumulates pages over longer periods of time to include a greater number of pages. In other words. delaying the grouping of rows into segments as long as possible increases the chances of having sufficient numbers of records with same and/or similar cluster keys to group together in segments. Alternatively, the conversion of pages into segments can occur at any frequency, for example, where pages are converted into segments more frequently and/or in accordance with any schedule or determination in other embodiments of the record processing and storage system 2505.

This mechanism of improving clustering levels in segment generation by delaying the clustering process required for segment generation as long as possible can be further leveraged to reduce resource utilization of the record processing and storage system 2505. As the record processing and storage system 2505 is responsible for receiving records streams from data sources for storage, for example, in the scale of terabyte per second load rates, this process of generating pages from the record streams should therefore be as efficient as possible. The page generator 2511 can be further implemented to reduce resource consumption of the record processing and storage system 2505 in page generation and storage by minimizing the processing of, movement of, and/or access to records 2422 of pages 2515 once generated as they await conversion into segments.

To reduce the processing induced upon the record processing and storage system 2505 during this data ingress, sets of incoming records 2422 can be included in a corresponding page 2515 without performing any clustering or sorting. For example, as clustering assumptions cannot be made for incoming data, incoming rows can be placed into pages based on the order that they are received and/or based on any order that best conserves resources. In some embodiments, the entire clustering process is performed by the segment generator 2617 upon all stored pages all at once, where the page generator 2511 does not perform any stages of the clustering process.

In some embodiments, to further reduce the processing induced upon the record processing and storage system 2505 during this data ingress, incoming record data of data streams 1-L undergo minimal reformatting by the page generator 2511 in generating pages 2515. In some cases, the incoming data of record streams 1-L is not reformatted and is simply “placed” into a corresponding page 2515. For example, a set of records are included in given page in accordance with formatted row data received from data sources.

While delaying segment generation in this fashion improves clustering and further improves ingress efficiency, it can be unideal to wait for records to be processed into segments before they appear in query results, particularly because the most recent data may be of the most interest to end users requesting queries. The record processing and storage system 2505 can resolve this problem by being further operable to facilitate page reads in addition to segment reads in facilitating query executions.

As illustrated in FIG. 25A, a query processing system 2502 can implement a query execution plan generator module 2503 to generate query execution plan data based on a received query request. The query execution plan data can be relayed to nodes participating in the corresponding query execution plan 2405 indicated by the query execution plan data, for example, as discussed in conjunction with FIG. 24A. A query execution module 2504 can be implemented via a plurality of nodes participating in the query execution plan 2405, for example, where data blocks are propagated upwards from nodes at IO level 2416 to a root node at root level 2412 to generate a query resultant. The nodes at IO level 2416 can perform row reads to read records 2422 from segments 2424 as discussed previously and as illustrated in FIG. 24C. The nodes at IO level 2416 can further perform row reads to read records 2422 from pages 2515. For example, once records 2422 are durably stored by being stored in a page 2515, and/or by being duplicated and stored in multiple pages 2515, the record 2422 can be available to service queries, and will be accessed by nodes 37 at IO level 2416 in executing queries accordingly. This enables the availability of records 2422 for query executions more quickly, where the records need not be processed for storage in their final storage format as segments 2424 to be accessed in query requests. Execution of a given query can include utilizing a set of records stored in a combination of pages 2515 and segments 2424. An embodiment of an IO level node that stores and accesses both segments and pages is illustrated in FIG. 25E.

The record processing and storage system 2505 can be implemented utilizing the parallelized data input sub-system 11 and/or the parallelized ingress sub-system 24 of FIG. 4. The record processing and storage system 2505 can alternatively or additionally be implemented utilizing the parallelized data store, retrieve, and/or process sub-system 12 of FIG. 6. The record processing and storage system 2505 can alternatively or additionally be implemented by utilizing one or more computing devices 18 and/or by utilizing one or more nodes 37.

The record processing and storage system 2505 can be otherwise implemented utilizing at least one processor and at least one memory. For example, the at least one memory can store operational instructions that, when executed by the at least one processor, cause the record processing and storage system to perform some or all of the functionality described herein, such as some or all of the functionality of the page generator 2511 and/or of the segment generator 2617 discussed herein. In some cases, one or more individual nodes 37 and/or one or more individual processing core resources 48 can be operable to perform some or all of the functionality of the record processing and storage system 2505, such as some or all of the functionality of the page generator 2511 and/or of the segment generator 2617, independently or in tandem by utilizing their own processing resources and/or memory resources.

The query processing system 2502 can be alternatively or additionally implemented utilizing the parallelized query and results sub-system 13 of FIG. 5. The query processing system 2502 can be alternatively or additionally implemented utilizing the parallelized data store, retrieve, and/or process sub-system 12 of FIG. 6. The query processing system 2502 can alternatively or additionally be implemented by utilizing one or more computing devices 18 and/or by utilizing one or more nodes 37.

The query processing system 2502 can be otherwise implemented utilizing at least one processor and at least one memory. For example, the at least one memory can store operational instructions that, when executed by the at least one processor, cause the record processing and storage system to perform some or all of the functionality described herein, such as some or all of the functionality of the query execution plan generator module 2503 and/or of the query execution module 2504 discussed herein. In some cases, one or more individual nodes 37 and/or one or more individual processing core resources 48 can be operable to perform some or all of the functionality of the query processing system 2502, such as some or all of the functionality of query execution plan generator module 2503 and/or of the query execution module 2504, independently or in tandem by utilizing their own processing resources and/or memory resources.

In some embodiments, one or more nodes 37 of the database system 10 as discussed herein can be operable to perform multiple functionalities of the database system 10 illustrated in FIG. 25A. For example, a single node can be utilized to implement the page generator 2511, the page storage system 2506, the segment generator 2617, the segment storage system 2508, the query execution plan generator module, and/or the query execution module 2504 as a node 37 at one or more levels 2410 of a query execution plan 2405. In particular, the single node can utilize different processing core resources 48 to implement different functionalities in parallel, and/or can utilize the same processing core resources 48 to implement different functionalities at different times.

Some or all data sources 2501 can implement utilizing at least one processor and at least one memory. Some or all data sources 2501 can be external from database system 10 and/or can be included as part of database system 10. For example, the at least one memory of a data source 2501 can store operational instructions that, when executed by the at least one processor of the data source 2501, cause the data source 2501 to perform some or all of the functionality of data sources 2501 described herein. In some cases, data sources 2501 can receive application data from the database system 10 for download, storage, and/or installation. Execution of the stored application data by processing modules of data sources 2501 can cause the data sources 2501 to execute some or all of the functionality of data sources 2501 discussed herein.

In some embodiments, system communication resources 14, external network(s) 17, local communication resources 25, wide area networks 22, and/or other communication resources of database system 10 can be utilized to facilitate any transfer of data by the record processing and storage system 2505. This can include, for example: transmission of record streams 1-L from data sources 2501 to the record processing and storage system 2505; transfer of pages 2515 to page storage system 2506 once generated by the page generator 2511; access to pages 2515 by the segment generator 2617; transfer of segments 2424 to the segment storage system 2508 once generated by the segment generator 2617; communication of query execution plan data to the query execution module 2504, such as the plurality of nodes 37 of the corresponding query execution plan 2405; reading of records by the query execution module 2504, such as IO level nodes 37, via access to pages 2515 stored page storage system 2506 and/or via access to segments 2424 stored segment storage system 2508; sending of data blocks generated by nodes 37 of the corresponding query execution plan 2405 to other nodes 37 in conjunction with their execution of the query; and/or any other accessing of data, communication of data, and/or transfer of data by record processing and storage system 2505 and/or within the record processing and storage system 2505 as discussed herein.

The record processing and storage system 2505 and/or the query processing system 2502 of FIG. 25A, and/or any other embodiment of record processing and storage system 2505 and/or the query processing system 2502 described herein, can be implemented at a massive scale, for example, by being implemented by a database system 10 that is operable to receive, store, and perform queries against a massive number of records of one or more datasets, such as millions, billions, and/or trillions of records stored as many Terabytes, Petabytes, and/or Exabytes of data as discussed previously. In particular, the record processing and storage system 2505 and/or the query processing system 2502 can each be implemented by a large number, such as hundreds, thousands, and/or millions of computing devices 18, nodes 37, and/or processing core resources 48 that perform independent processes in parallel, for example, with minimal or no coordination, to implement some or all of the features and/or functionality of the record processing and storage system 2505 and/or the query processing system 2502 at a massive scale.

Some or all functionality performed by the record processing and storage system 2505 and/or the query processing system 2502 as described herein cannot practically be performed by the human mind, particularly when the database system 10 is implemented to store and perform queries against records at a massive scale as discussed previously. In particular, the human mind is not equipped to perform record processing, record storage, and/or query execution for millions, billions, and/or trillions of records stored as many Terabytes, Petabytes, and/or Exabytes of data. Furthermore, the human mind is not equipped to distribute and perform record processing, record storage, and/or query execution as multiple independent processes, such as hundreds, thousands, and/or millions of independent processes, in parallel and/or within overlapping time spans.

Some or all features and/or functionality of FIG. 25A can be performed via at least one node 37 in conjunction with system metadata, applied across a plurality of nodes 37, for example, where at least one node 37 participates in some or all features and/or functionality of FIG. 25A based on receiving and storing the system metadata in local memory of the at least one node 37 as configuration data, and/or based on further accessing and/or executing this configuration data to implement some or all functionality of the record processing storage system and/or to implement some or all functionality of the query processing system as part of its database functionality accordingly. Performance of some or all features and/or functionality of FIG. 25A can optionally change and/or be updated over time, and/or a set of nodes participating in executing some or all features and/or functionality of FIG. 25A can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 25B illustrates an example embodiment of the record processing and storage system 2505 of FIG. 25A. Some or all of the features illustrated and discussed in conjunction with the record processing and storage system 2505 FIG. 25B can be utilized to implement the record processing and storage system 2505 and/or any other embodiment of the record processing and storage system 2505 described herein.

The record processing and storage system 2505 can include a plurality of loading modules 2510-1-2510-N. Each loading module 2510 can be implemented via its own processing and/or memory resources. For example, each loading module 2510 can be implemented via its own computing device 18, via its own node 37, and/or via its own processing core resource 48. The plurality of loading modules 2510-1-2510-N can be implemented to perform some or all of the functionality of the record processing and storage system 2505 in a parallelized fashion.

The record processing and storage system 2505 can include queue reader 2559, a plurality of stateful file readers 2556-1-2556-N, and/or stand-alone file readers 2558-1-2558-N. For example, the queue reader 2559, a plurality of stateful file readers 2556-1-2556-N, and/or stand-alone file readers 2558-1-2558-N are utilized to enable each loading modules 2510 to receive one or more of the record streams 1-L received from the data sources 2501-1-2501-L as illustrated in FIG. 25A. For example, each loading module 2510 receives a distinct subset of the entire set of records received by the record processing and storage system 2505 at a given time.

Each loading module 2510 can receive records 2422 in one or more record streams via its own stateful file reader 2556 and/or stand-alone file reader 2558. Each loading module 2510 can optionally receive records 2422 and/or otherwise communicate with a common queue reader 2559. Each stateful file reader 2556 can communicate with a metadata cluster 2552 that includes data supplied by and/or corresponding to a plurality of administrators 2554-1-2554-M. The metadata cluster 2552 can be implemented by utilizing the administrative processing sub-system 15 and/or the configuration sub-system 16. The queue reader 2559, each stateful file reader 2556, and/or each stand-alone file reader 2558 can be implemented utilizing the parallelized ingress sub-system 24 and/or the parallelized data input sub-system 11. The metadata cluster 2552, the queue reader 2559, each stateful file reader 2556, and/or each stand-alone file reader 2558 can be implemented utilizing at least one computing device 18 and/or at least one node 37. In cases where a given loading module 2510 is implemented via its own computing device 18 and/or node 37, the same computing device 18 and/or node 37 can optionally be utilized to implement the stateful file reader 2556, and/or each stand-alone file reader 2558 communicating with the given loading module 2510.

Each loading module 2510 can implement its own page generator 2511, its own index generator 2513, and/or its own segment generator 2617, for example, by utilizing its own processing and/or memory resources such as the processing and/or memory resources of a corresponding computing device 18. For example, the page generator 2511 of FIG. 25A can be implemented as a plurality of page generators 2511 of a corresponding plurality of loading modules 2510 as illustrated in FIG. 25B. Each page generator 2511 of FIG. 25B can process its own incoming records 2422 to generate its own corresponding pages 2515.

As pages 2515 are generated by the page generator 2511 of a loading module 2510, they can be stored in a page cache 2512. The page cache 2512 can be implemented utilizing memory resources of the loading module 2510, such as memory resources of the corresponding computing device 18. For example, the page cache 2512 of each loading module 2010-1-2010-N can individually or collectively implement some or all of the page storage system 2506 of FIG. 25A.

The segment generator 2617 of FIG. 25A can similarly be implemented as a plurality of segment generators 2617 of a corresponding plurality of loading modules 2510 as illustrated in FIG. 25B. Each segment generator 2617 of FIG. 25B can generate its own set of segments 2424-1-2424-J included in one or more segment groups 2622. The segment group 2622 can be implemented as the segment group of FIG. 23, for example, where J is equal to five or another number of segments configured to be included in a segment group. In particular, J can be based on the redundancy storage encoding scheme utilized to generate the set of segments and/or to generate the corresponding parity data 2426.

The segment generator 2617 of a loading module 2510 can access the page cache 2512 of the loading module 2510 to convert the pages 2515 previously generated by the page generator 2511 into segments. In some cases, each segment generator 2617 requires access to all pages 2515 generated by the segment generator 2617 since the last conversion process of pages into segments. The page cache 2512 can optionally store all pages generated by the page generator 2511 since the last conversion process, where the segment generator 2617 accesses all of these pages generated since the last conversion process to cluster records into groups and generate segments. For example, the page cache 2512 is implemented as a write-through cache to enable all previously generated pages since the last conversion process to be accessed by the segment generator 2617 once the conversion process commences.

In some cases, each loading module 2510 implements its segment generator 2617 upon only the set of pages 2515 that were generated by its own page generator 2511, accessible via its own page cache 2512. In such cases, the record grouping via clustering key to create segments with the same or similar cluster keys are separately performed by each segment generator 2617 independently without coordination, where this record grouping via clustering key is performed on N distinct sets of records stored in the N distinct sets of pages generated by the N distinct page generators 2511 of the N distinct loading modules 2510. In such cases, despite records never being shared between loading modules 2510 to further improve clustering, the level of clustering of the resulting segments generated independently by each loading module 2510 on its own data is sufficient, for example, due to the number of records in each loading module's 2510 set of pages 2515 for conversion being sufficiently large to attain favorable levels of clustering.

In such embodiments, each loading modules 2510 can independently initiate its own conversion process of pages 2515 into segments 2424 by waiting as long as possible based on its own resource utilization, such as memory availability of its page cache 2512. Different segment generators 2617 of the different loading modules 2510 can thus perform their own conversion of the corresponding set of pages 2515 into segments 2424 at different times, based on when each loading modules 2510 independently determines to initiate the conversion process, for example, based on each independently making the determination to generate segments. Thus, as discussed herein, the conversion process of pages into segments can correspond to a single loading module 2510 converting all of its pages 2515 generated by its own page generator 2511 since its own last the conversion process into segments 2424, where different loading modules 2510 can initiate and execute this conversion process at different times and/or with different frequency.

In other cases, it is ideal for even more favorable levels of clustering to be attained via sharing of all pages for conversion across all loading modules 2510. In such cases, a collective decision to initiate the conversion process can be made across some or all loading modules 2510, for example, based on resource utilization across all loading modules 2510. The conversion process can include sharing of and/or access to all pages 2515 generated via the process, where each segment generator 2617 accesses records in some or all pages 2515 generated by and/or stored by some or all other loading modules 2510 to perform the record grouping by cluster key. As the full set of records is utilized for this clustering instead of N distinct sets of records, the levels of clustering in resulting segments can be further improved in such embodiments. This improved level of clustering can offset the increased page movement and coordination required to facilitate page access across multiple loading modules 2510. As discussed herein, the conversion process of pages into segments can optionally correspond to multiple loading modules 2510 converting all of their collectively generated pages 2515 since their last conversion process into segments 2424 via sharing of their generated pages 2515.

An index generator 2513 can optionally be implemented by some or all loading modules 2510 to generate index data 2516 for some or all pages 2515 prior to their conversion into segments. The index data 2516 generated for a given page 2515 can be appended to the given page, can be stored as metadata of the given page 2515, and/or can otherwise be mapped to the given page 2515. The index data 2516 for a given page 2515 correspond to page metadata, for example, indexing records included in the corresponding page. As a particular example, the index data 2516 can include some or all of the data of index data 2518 generated for segments 2424 as discussed previously, such as index sections 0-x of FIG. 23. As another example, the index data 2516 can include indexing information utilized to determine the memory location of particular records and/or particular columns within the corresponding page 2515.

In some cases, the index data 2516 can be generated to enable corresponding pages 2515 to be processed by query IO operators utilized to read rows from pages, for example, in a same or similar fashion as index data 2518 is utilized to read rows from segments. In some cases, index probing operations can be utilized by and/or integrated within query IO operators to filter the set of rows returned in reading a page 2515 based on its index data 2516 and/or to filter the set of rows returned in reading a segment 2424 based on its index data 2518.

In some cases, index data 2516 is generated by index generator 2513 for all pages 2515, for example, as each page 2515 is generated, or at some point after each page 2515 is generated. In other cases, index data 2516 is only generated for some pages 2515, for example, where some pages do not have index data 2516 as illustrated in FIG. 25B. For example, some pages 2515 may never have corresponding index data 2516 generated prior to their conversion into segments. In some cases, index data 2516 is generated for a given page 2515 with its records are to be read in execution of a query by the query processing system 2502. For example, a node 37 at IO level 2416 can be implemented as a loading module 2510 and can utilize its index generator 2513 to generate index data 2516 for a particular page 2515 in response to having query execution plan data indicating that records 2422 be read the particular page from the page cache 2512 of the loading module in conjunction with execution of a query. The index data 2516 can be optionally stored temporarily for the life of the given query to facilitate reading of rows from the corresponding page for the given query only. The index data 2516 alternatively can be stored as metadata of the page 2515 once generated, as illustrated in FIG. 25B. This enables the previously generated index data 2516 of a given page to be utilized in subsequent queries requiring reads from the given page.

As illustrated in FIG. 25B, each loading modules 2510 can generate and send pages 2515, corresponding index data 2516, and/or segments 2424 to long term storage 2540-1-2540-J of a particular storage cluster 2535. For example, system communication resources 14 can be utilized to facilitate sending of data from loading modules 2510 to storage cluster 2535 and/or to facilitate sending of data from storage cluster 2535 to loading modules 2510.

The storage cluster 2535 can be implemented by utilizing a storage cluster 35 of FIG. 6, where each long term storage 2540-1-2540-J is implemented by a corresponding computing device 18-1-18-J and/or by a corresponding node 37-1-37-J. In some cases, each storage cluster 35-1-35-z of FIG. 6 can receive pages 2515, corresponding index data 2516, and/or segments 2424 from its own set of loading modules 2510-1-2510-N, where the record processing and storage system 2505 of FIG. 25B can include z sets of loading modules 2510-1-2510-N that each generate pages 2515, segments 2524, and/or index data 2516 for storage in its own corresponding storage cluster 35.

The processing and/or memory resources utilized to implement each long term storage 2540 can be distinct from the processing and/or memory resources utilized to implement the loading modules 2510. Alternatively, some loading modules can optionally share processing and/or memory resources long term storage 2540, for example, where a same computing device 18 and/or a same node 37 implements a particular long term storage 2540 and also implements a particular loading modules 2510.

Each loading module 2510 can generate and send the segments 2424 to long term storage 2540-1-2540-J in a set of persistence batches 2532-1-2532-J sent to the set of long term storage 2540-1-2540-J as illustrated in FIG. 25B. For example, upon generating a segment group 2522 of J segments 2424, a loading module 2510 can send each of the J segments in the same segment group to a different one of the set of long term storage 2540-1-2540-J in the storage cluster 2535. For example, a particular long term storage 2540 can generate recovered segments as necessary for processing queries and/or for rebuilding missing segments due to drive failure as illustrated in FIG. 24D, where the value K of FIG. 24D is less than the value J and wherein the nodes 37 of FIG. 24D are utilized to implement the long term storage 2540-1-2540-J.

As illustrated in FIG. 25B, each persistence batch 2532-1-2532-J can optionally or additionally include pages 2515 and/or their corresponding index data 2516 generated via index generator 2513. Some or all pages 2515 that are generated via a loading module 2510's page generator 2511 can be sent to one or more long term storage 2540-1-2540-J. For example, a particular page 2515 can be included in some or all persistence batches 2532-1-2532-J sent to multiple ones of the set of long term storage 2540-1-2540-J for redundancy storage as replicated pages stored in multiple locations for the purpose of fault tolerance. Some or all pages 2515 can be sent to storage cluster 2535 for storage prior to being converted into segments 2424 via segment generator 2617. Some or all pages 2515 can be stored by storage cluster 2535 until corresponding segments 2424 are generated, where storage cluster 2535 facilitates deletion of these pages from storage in one or more long term storage 2540-1-2540-J once these pages are converted and/or have their records 2422 successfully stored by storage cluster 2535 in segments 2424.

In some cases, a loading module 2510 maintains storage of pages 2515 via page cache 2512, even if they are sent to storage cluster 2535 in persistence batches 2532. This can enable the segment generator 2617 to efficiently read pages 2515 during the conversion process via reads from this local page cache 2512. This can be ideal in minimizing page movement, as pages do not need to be retrieved from long term storage 2540 for conversion into segments by loading modules 2510 and can instead be locally accessed via maintained storage in page cache 2512. Alternatively, a loading module 2510 removes pages 2515 from storage via page cache 2512 once they are determined to be successfully stored in long term storage 2540. This can be ideal in reducing the memory resources required by loading module 2510 to store pages, as only pages that are not yet durably stored in long term storage 2540 need be stored in page cache 2512.

Each long term storage 2540 can include its own page storage 2546 that stores received pages 2515 generated by and received from one or more loading modules 2010-1-2010-N, implemented utilizing memory resources of the long term storage 2540. For example, the page storage 2546 of each long term storage 2540-1-2540-J can individually or collectively implement some or all of the page storage system 2506 of FIG. 25A. The page storage 2546 can optionally store index data 2516 mapped to and/or included as metadata of its pages 2515. Each long term storage 2540 can alternatively or additionally include its own segment storage 2548 that stores segments generated by and received from one or more loading modules 2010-1-2010-N. For example, the segment storage 2548 of each long term storage 2540-1-2540-J can individually or collectively implement some or all of the segment storage system 2508 of FIG. 25A.

The pages 2515 stored in page storage 2546 of long term storage 2540 and/or the segments 2424 stored in segment storage 2548 of long term storage 2540 can be accessed to facilitate execution of queries. As illustrated in FIG. 25B, each long term storage 2540-1-2540-J can perform IO operators 2542 to facilitate reads of records in pages 2515 stored in their page storage 2546 and/or to facilitate reads of records in segments 2424 stored in their segment storage 2548. For example, some or all long term storage 2540-1-2540-J can be implemented as nodes 37 at the IO level 2416 of one or more query execution plans 2405. In particular, the some or all long term storage 2540-1-2540-J can be utilized to implement the query processing system 2502 by facilitating reads to stored records via IO operators 2542 in conjunction with query executions.

Note that at a given time, a given page 2515 may be stored in the page cache 2512 of the loading module 2510 that generated the given page 2515, and may alternatively or additionally be stored in one or more long term storage 2540 of the storage cluster 2535 based on being sent to the in one or more long term storage 2540. Furthermore, at a given time, a given record may be stored in a particular page 2515 in a page cache 2512 of a loading module 2510, may be stored the particular page 2515 in page storage 2546 of one or more long term storage 2540, and/or may be stored in exactly one particular segment 2424 in segment storage 2548 of one long term storage 2540.

Because records can be stored in multiple locations of storage cluster 2535, the long term storage 2540 of storage cluster 2535 can be operable to collectively store page and/or segment ownership consensus 2544. This can be useful in dictating which long term storage 2540 is responsible for accessing each given record stored by the storage cluster 2535 via IO operators 2542 in conjunction with query execution. In particular, as a query resultant is only guaranteed to be correct if each required record is accessed exactly once, records reads to a particular record stored in multiple locations could render a query resultant as incorrect. The page and/or segment ownership consensus 2544 can include one or more versions of ownership data, for example, that is generated via execution of a consensus protocol mediated via the set of long term storage 2540-1-2540-J. The page and/or segment ownership consensus 2544 can dictate that every record is owned by exactly one long term storage 2540 via access to either a page 2515 storing the record or a segment 2424 storing the record, but not both. The page and/or segment ownership consensus 2544 can indicate, for each long term storage 2540 in the storage cluster 2535, whether some or all of its pages 2515 or some or all of its segments 2424 are to be accessed in query executions, where each long term storage 2540 only accesses the pages 2515 and segments 2424 indicated in page and/or segment ownership consensus 2544.

In such cases, all record access for query executions performed by query execution module 2504 via nodes 37 at IO level 2416 can optionally be performed via IO operators 2542 accessing page storage 2546 and/or segment storage 2548 of long term storage 2540, as this access can guarantee reading of records exactly once via the page and/or segment ownership consensus 2544. For example, the long term storage 2540 can be solely responsible for durably storing the records utilized in query executions. In such embodiments, the cached and/or temporary storage of pages and/or segments of loading modules 2510, such as pages 2515 in page caches 2512, are not read for query executions via accesses to storage resources of loading modules 2510.

Some or all features and/or functionality of FIG. 25B can be performed via at least one node 37 in conjunction with system metadata applied across a plurality of nodes 37, for example, where at least one node 37 participates in some or all features and/or functionality of FIG. 25B based on receiving and storing the system metadata in local memory of the at least one node 37 as configuration data and/or based on further accessing and/or executing this configuration data to implement some or all functionality of a loading module 2510, to implement some or all functionality of a file reader, and/or to implement some or all functionality of the storage cluster 2535 as part of its database functionality accordingly. Performance of some or all features and/or functionality of FIG. 25B can optionally change and/or be updated over time, and/or a set of nodes participating in executing some or all features and/or functionality of FIG. 25B can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 25C illustrates an example embodiment of a page generator 2511. The page generator 2511 of FIG. 25C can be utilized to implement the page generator 2511 of FIG. 25A, can be utilized to implement each page generator 2511 of each loading module 2510 of FIG. 25B, and/or can be utilized to implement any embodiments of page generator 2511 described herein.

A single incoming record stream, or multiple incoming record streams 1-L, can include the incoming records 2422 as a stream of row data 2910. Each row data 2910 can be transmitted as an individual packet and/or a set of packets by the corresponding data source 2501 to include a single record 2422, such as a single row of a database table. Alternatively each row data 2910 can be transmitted by the corresponding data source 2501 as an individual packet and/or a set of packets to include a batched set of multiple records 2422, such as multiple rows of a database table. Row data 2910 received from the same or different data source over time can each include a same number of rows or a different number of rows, and can be sent in accordance with a particular format. Row data 2910 received from the same or different data source over time can include records with the same or different numbers of columns, with the same or different types and/or sizes of data populating its columns, and/or with the same or different row schemas. In some cases, row data 2910 is received in a stream over time for processing by a loading module 2510 via a stateful file reader 2556 and/or via a stand-alone file reader 2558.

Incoming rows can be stored in a pending row data pool 3410 while they await conversion into pages 2515. The pending row data pool 3410 can be implemented as an ordered queue or an unordered set. The pending row data pool 3410 can be implemented by utilizing storage resources of the record processing and storage system. For example, each loading module 2510 can have its own pending row data pool 3410. Alternatively, multiple loading modules 2510 can access the same pending row data pool 3410 that stores all incoming row data 2910, for example, by utilizing queue reader 2559.

The page generator 2511 can facilitate parallelized page generation via a plurality of processing core resources 48-1-48-W. For example, each loading module 2510 has its own plurality of processing core resources 48-1-48-W, where the processing core resources 48-1-48-W of a given loading module 2510 is implemented via the set of processing core resources 48 of one or more nodes 37 utilized to implement the given loading module 2510. As another example, the plurality of processing core resources 48-1-48-W are each implemented by a corresponding one of the set of each loading module 2510-1-2510-N, for example, where each loading module 2510-1-2510-N is implemented via its own processing core resources 48-1-48-W.

Over time, each processing core resource 48 can retrieve and/or can be assigned pending row data 2910 in the pending row data pool 3410. For example, when a given processing core resource 48 has finished another job, such as completed processing of another row data 2910, the processing core resource 48 can fetch a new row data 2910 for processing into a page 2515. For example, the processing core resource 48 retrieves a first ordered row data 2910 from a queue of the pending row data pool 3410, retrieves a highest priority row data 2910 from the pending row data pool 3410, retrieves an oldest row data 2910 from the pending row data pool 3410, and/or retrieves a random row data 2910 from the pending row data pool 3410. Once one processing core resource 48 retrieves and/or otherwise utilizes a particular row data 2910 for processing into a page, the particular row data 2910 is removed from the pending row data pool 3410 and/or is otherwise not available for processing by other processing core resources 48.

Each processing core resource 48 can generate pages 2515 from the row data received overtime. As illustrated in FIG. 25C, the pages 2515 are depicted to include only one row data, such as a single row or multiple rows batched together in the row data 2910. For example, each page is generated directly from corresponding row data 2910. Alternatively, a page 2515 can include multiple row data 2910, for example, in sequence and/or concatenated in the page 2515. The page can include multiple row data 2910 from a single data source 2501 and/or can include multiple row data 2910 from multiple different data sources 2501. For example, the processing core resource 48 can retrieve one row data 2910 from the pending row data pool 3410 at a time, and can append each row data 2910 to a given page until the page 2515 is complete, where the processing core resource 48 appends subsequently retrieved row data 2910 to a new page. Alternatively, the processing core resource 48 can retrieve multiple row data 2910 at once, and can generate a corresponding page 2515 to include this set of multiple row data 2910.

Once a page 2515 is complete, the corresponding processing core resource 48 can facilitate storage of the page in page storage system 2506. This can include adding the page 2515 to the page cache 2512 of the corresponding loading module 2510. This can include facilitating sending of the page 2515 to one or more long term storage 2540 for storage in corresponding page storage 2546. Different processing core resources 48 can each facilitate storage of the page via common resources, or via designated resources specific to each processing core resources 48, of the page storage system 2506.

Some or all features and/or functionality of FIG. 25C can be performed via at least one node 37 in conjunction with system metadata applied across a plurality of nodes 37, for example, where at least one node 37 participates in some or all features and/or functionality of FIG. 25C based on receiving and storing the system metadata in local memory of the at least one node 37 as configuration data and/or based on further accessing and/or executing this configuration data to implement some or all functionality of a loading module 2510, to implement some or all functionality of page generator 2511 and/or page storage system 2506 as part of its database functionality accordingly. Performance of some or all features and/or functionality of FIG. 25C can optionally change and/or be updated over time, and/or a set of nodes participating in executing some or all features and/or functionality of FIG. 25C can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 25D illustrates an example embodiment of the page storage system 2506. As used herein, the page storage system 2506 can include page cache 2512 of a single loading module 2510; can include page caches 2512 of some or all loading module 2510-1-2510-N; can include page storage 2546 of a single long term storage 2540 of a storage cluster 2535; can include page storage 2546 of some or all long term storage 2540-1-2540-J of a single storage cluster 2535; can include page storage 2546 of some or all long term storage 2540-1-2540-J of multiple different storage clusters, such as some or all storage clusters 35-1-35-z; and/or can include any other memory resources of database system 10 that are utilized to temporarily and/or durably store pages.

Some or all features and/or functionality of FIG. 25D can be performed via at least one node 37 in conjunction with system metadata applied across a plurality of nodes 37, for example, where at least one node 37 participates in some or all features and/or functionality of FIG. 25D based on receiving and storing the system metadata in local memory of the at least one node 37 as configuration data and/or based on further accessing and/or executing this configuration data to implement some or all functionality of a loading module 2510 and/or a given long term storage 2540 as part of its database functionality accordingly. Performance of some or all features and/or functionality of FIG. 25D can optionally change and/or be updated over time, and/or a set of nodes participating in executing some or all features and/or functionality of FIG. 25D can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 25E illustrates an example embodiment of a node 37 utilized to implement a given long term storage 2540 of FIG. 25B. The node 37 of FIG. 25E can be utilized to implement the node 37 of FIG. 25B, FIG. 25C, 25D, some or all nodes 37 at the IO level 2416 of a query execution plan 2405 of FIG. 24A, and/or any other embodiments of node 37 described herein. As illustrated a given node 37 can have its own segment storage 2548 and/or its own page storage 2546 by utilizing one or more of its own memory drives 2425. Note that while the segment storage 2548 and page storage 2546 are segregated in the depiction of a memory drives 2425, any resources of a given memory drive or set of memory drives can be allocated for and/or otherwise utilized to store either pages 2515 or segments 2424. Optionally, some particular memory drives 2425 and/or particular memory locations within a particular memory drive can be designated for storage of pages 2515, while other particular memory drives 2425 and/or other particular memory locations within a particular memory drive can be designated for storage of segments 2424.

The node 37 can utilize its query processing module 2435 to access pages and/or records in conjunction with its role in a query execution plan 2405, for example, at the IO level 2416. For example, the query processing module 2435 generates and sends segment read requests to access records stored in segments of segment storage 2548, and/or generates and sends page read requests to access records stored in pages 2515 of page storage 2546. In some cases, in executing a given query, the node 37 reads some records from segments 2424 and reads other records from pages 2515, for example, based on assignment data indicated in the page and/or segment ownership consensus 2544. The query processing module 2435 can generate its data blocks to include the raw row data of the read records and/or can perform other query operators to generate its output data blocks as discussed previously. The data blocks can be sent to another node 37 in the query execution plan 2405 for processing as discussed previously, such as a parent node and/or a node in a shuffle node set within the same level 2410.

Some or all features and/or functionality of FIG. 25E can be performed a given node 37 in conjunction with system metadata applied across a plurality of nodes 37, for example, where the given node 37 performs some or all features and/or functionality of FIG. 25E based on receiving and storing the system metadata in local memory of the at least one node 37 as configuration data, and/or based on further accessing and/or executing this configuration data to implement some or all functionality of the given node 37 of FIG. 25E as part of its database functionality accordingly. Performance of some or all features and/or functionality of FIG. 25E can optionally change and/or be updated over time based on the system metadata applied across the plurality of nodes 37 being updated over time and/or based on nodes on updating their configuration data stored in local memory to reflect changes in the system metadata based on receiving data indicating these changes to the system metadata.

In some embodiments, some or all features and/or functionality of loading new data (e.g. as new pages and/or new segments), for example, via one or more loading modules 2510 and/or via record processing and storage system 2505 as described herein implements some or all features and/or functionality of loading modules, record processing and storage system, and/or any loading of data for storage and access in query execution as disclosed by: U.S. Utility application Ser. No. 18/355,497, entitled “TRANSFER OF A SET OF SEGMENTS BETWEEN STORAGE CLUSTERS OF A DATABASE SYSTEM”, filed Jul. 20, 2023; U.S. Utility application Ser. No. 18/308,954, entitled “QUERY EXECUTION DURING STORAGE FORMATTING UPDATES”, filed Apr. 28, 2023; and/or U.S. Utility application Ser. No. 18/313,548, entitled “LOADING QUERY RESULT SETS FOR STORAGE IN DATABASE SYSTEMS”, filed May 28, 2023; which are hereby incorporated herein by reference in its entirety and made part of the present U.S. Utility patent application for all purposes.

In some embodiments, some or features and/or functionality of loading data, for example, via one or more loading modules 2510 and/or via record processing and storage system 2505 as described herein, can implement processing of a corresponding message stream via a plurality of feed receiver modules in a fault tolerant manner as disclosed by U.S. Utility application Ser. No. 17/119,311, entitled “FAULT-TOLERANT DATA STREAM PROCESSING”, filed Dec. 11, 2020, which hereby incorporated herein by reference in its entirety and made part of the present U.S. Utility patent application for all purposes.

In some embodiments, some or all features and/or functionality of parallelized execution of tasks via a plurality of nodes, assigning different tasks to different nodes for in parallel, handling of node outages and facilitating reassignment of tasks, and/or other handling of node outages and/or execution of tasks can be implemented via some or all features and/or functionality of assigning, executing, and/or reassigning tasks as disclosed by: U.S. Utility application Ser. No. 18/482,939, entitled “PERFORMING SHUTDOWN OF A NODE IN A DATABASE SYSTEM” filed Oct. 9, 2023. which is hereby incorporated herein by reference in its entirety and made part of the present U.S. Utility patent application for all purposes. In some embodiments, some or all tasks described herein are loading-based tasks performed in conjunction with loading data, for example, via loading modules 2510 via record processing and storage system 2505, where such tasks are optionally assigned to nodes 37 implemented as loading modules 2510.

In various embodiments, assigning, monitoring, and/or execution of tasks in parallel as described herein can be in accordance with applying a distributed tasks framework. The distributed tasks framework and/or corresponding assigning, monitoring, and/or execution tasks can be implemented via maintaining of corresponding state data, for example, in conjunction with implementing a consensus protocol via a plurality of nodes as described herein and/or via implementing some or all features and/or functionality as updating of configuration data as disclosed herein.

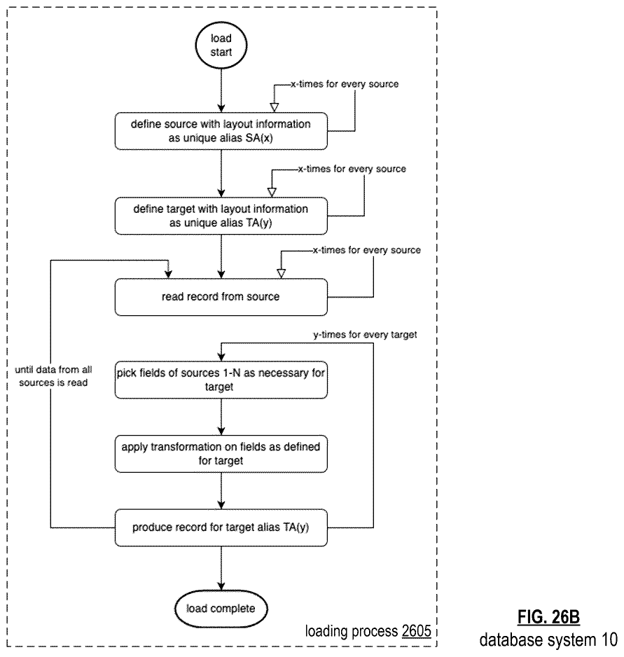

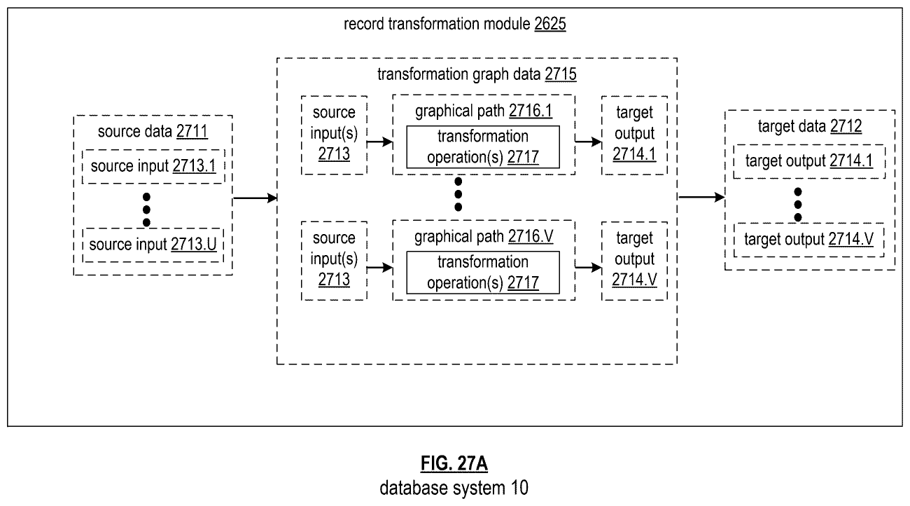

FIGS. 26A-26B illustrate embodiments of a record processing and storage system 2505 that performs a loading process 2605 to process a set of source datasets to generate a set of transformed record sets each for storage in a corresponding target database tables. Some or all features and/or functionality of the record processing and storage system 2505 and/or loading process 2605 of FIGS. 26A-26B can implement any embodiment of record processing and storage system 2505 and/or loading process 2605 described herein. Some or all features and/or functionality of processing source data sets to generate and store transformed record sets of FIGS. 26A-26B can implement any receipt, processing, transformation, loading, and/or storage of data described herein. Some or all features and/or functionality of FIGS. 26A-26B can implement any embodiment of database system 10 described herein.

In some embodiments, loading data to database system 10 can take a significant amount of time. For example, depending on the layout of source data, it can be necessary to perform two or more load operations on different datasets that are later joined, for example, to produce necessary reports. In some cases, some of these reports may even work on subsets of the original datasets, making the initial load operations time and resource consuming, even when only a fraction would be necessary. This problem can become worse, for example, if data resides in different source locations or even different types of data sources, such as files or stream applications (e.g. Apache Kafka).

Some or all of these issues can be alleviated via processing data from one or more source datasets for storage in one or more target tables in one load operation (e.g. one load process 2605, and/or one corresponding loading task), for example, via implementing some or all functionality of FIGS. 26A-26B. Processing data from one or more source datasets for storage in one or more target tables in one load operation can improve the technology of database systems to increase the efficiency of loading data, even when data is received from multiple sources of multiple types.

Each source dataset 2601 of a set of source datasets 2601.1-2601.L processed via a given loading process 2605 can be defined via a corresponding source identifier (ID) 2611 (e.g. a unique symbolic name/alias that is specified and/or that references the source) and corresponding source layout information 2617 (e.g. information about the structure of the data in the source necessary to identify records and/or reference different parts of a record as fields, where the fields optionally each have a unique symbolic name and/or are referenced by number). Each given source dataset 2601 can include a plurality of source records 2623 (e.g. implemented via some or all features and/or functionality of target record 2422, for example, corresponding to data of records 2422 prior to being transformed into these records for storage via a record transformation module 2625), for example, in accordance with a corresponding layout in accordance with the source layout information 2617 for the given source dataset. Different source datasets 2601 can have same or different numbers of records 2623. The set of source datasets 2601.1-2601.L can optionally correspond to/be received from the set of data sources 2501-1-2501-L of FIG. 25A.

Each target database table 2712 of a set of target database tables 2712.1-2712.T to which some or all data of some or all source datasets is to be stored in can similarly be specified via a corresponding target identifier (ID) 2612 (e.g. a unique symbolic name/alias that is specified and/or that references the target) and corresponding target layout information 2618 (e.g. information about the schema of the corresponding target database table 2712, such as the columns of the target are named using a corresponding symbolic name, which can match symbolic names of corresponding fields included in the source layout information).

In some embodiments, if multiple source are used that have different numbers of source records, defaults can be applied, for example, on the target level and/or via derived values, for example, based on available field values of other sources. In some embodiments, the mechanism of aliases can be expanded to system computed source data, such as the time a records was loaded and/or or the number of the records or other source related information like filename. In such embodiments, case, the alias can be utilized (e.g. based on being necessary) to avoid collisions between source/target fields/columns and the name of the computed value (e.g. if they exist in source/target).

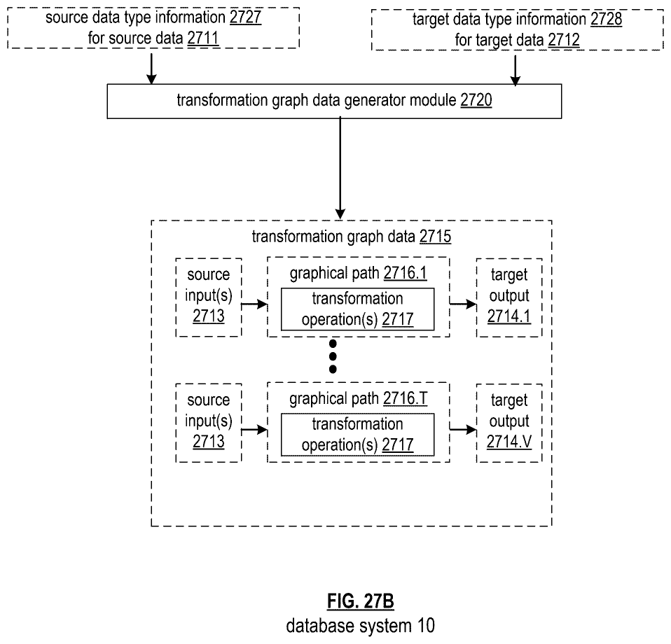

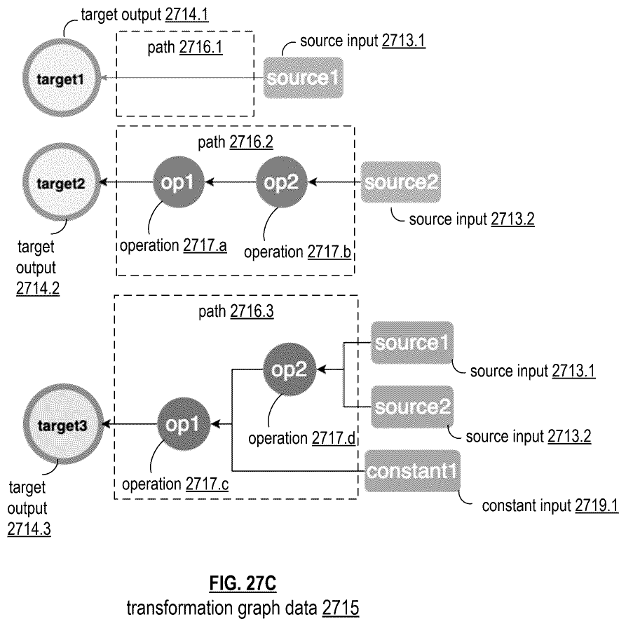

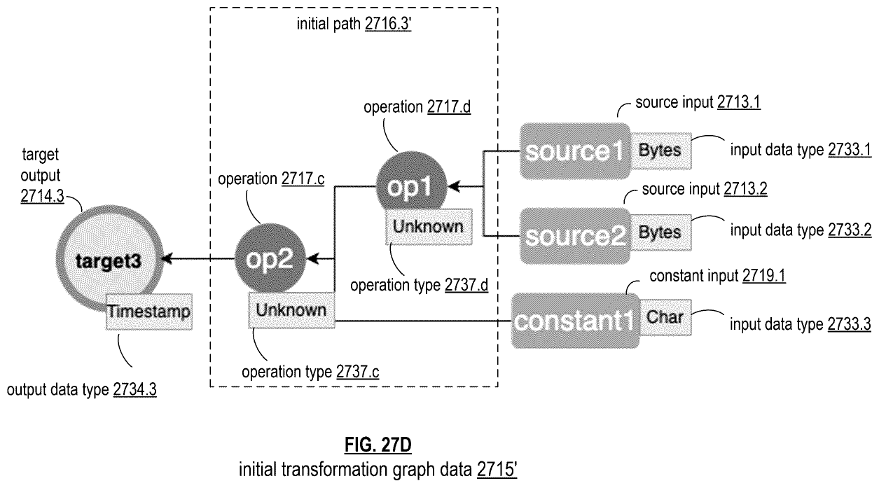

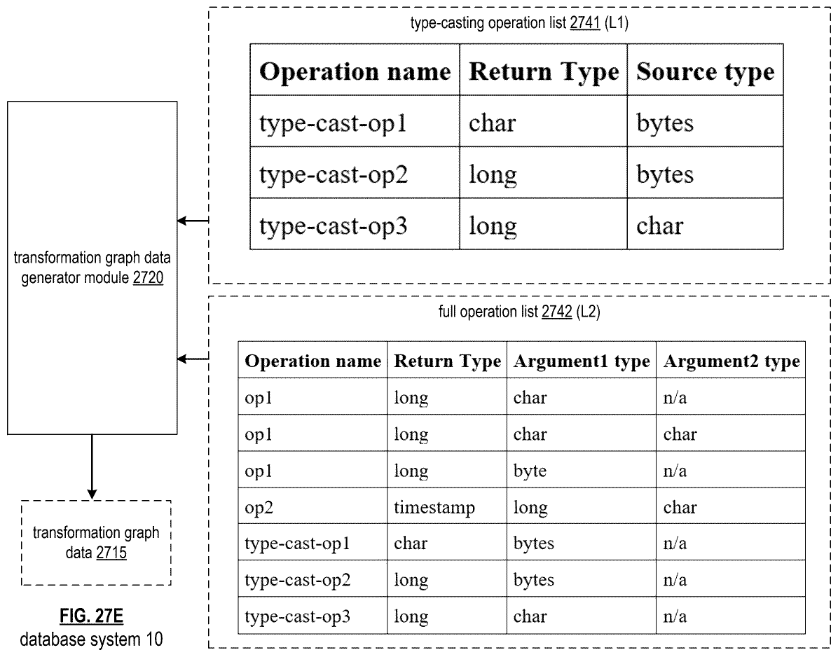

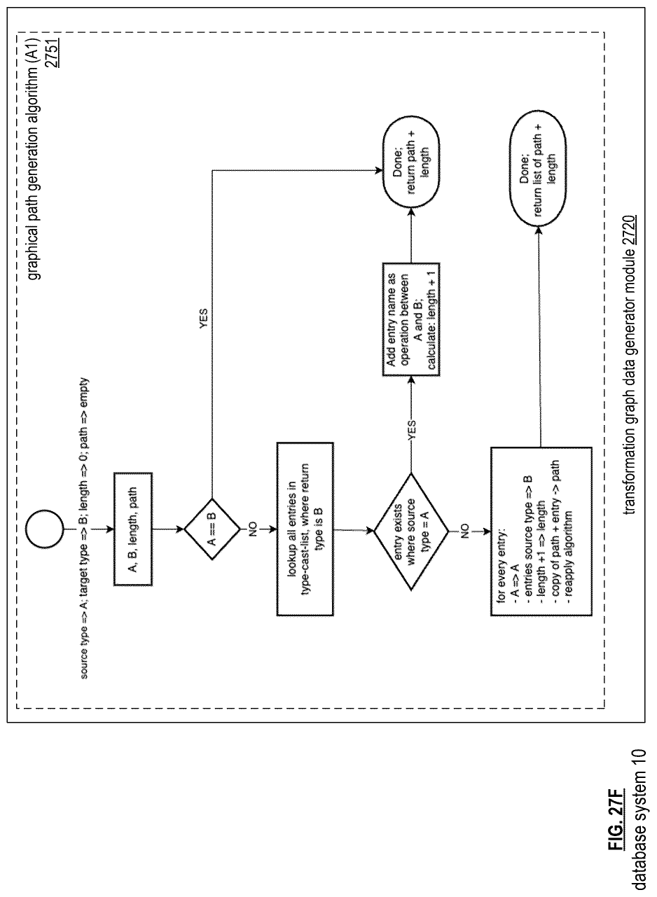

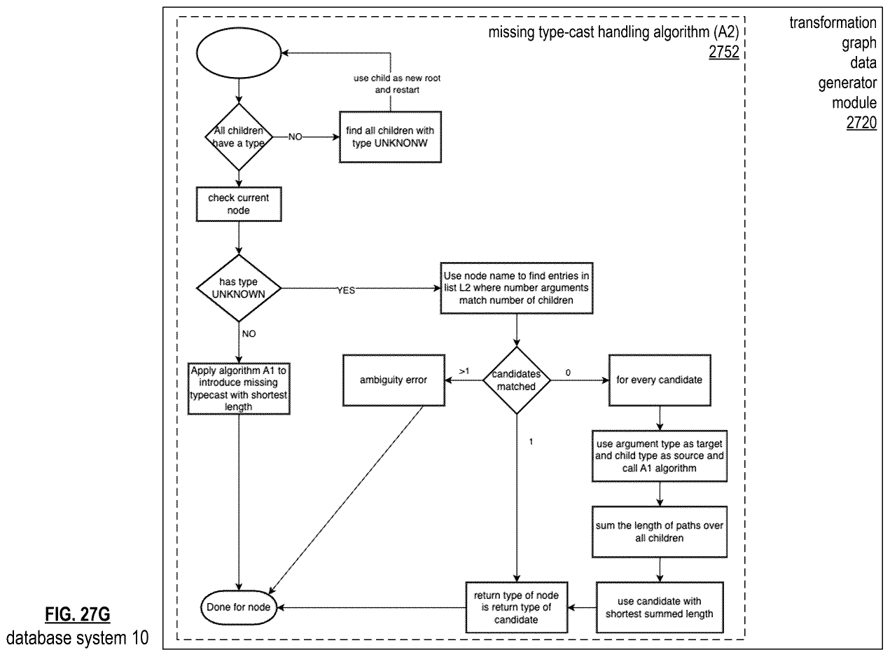

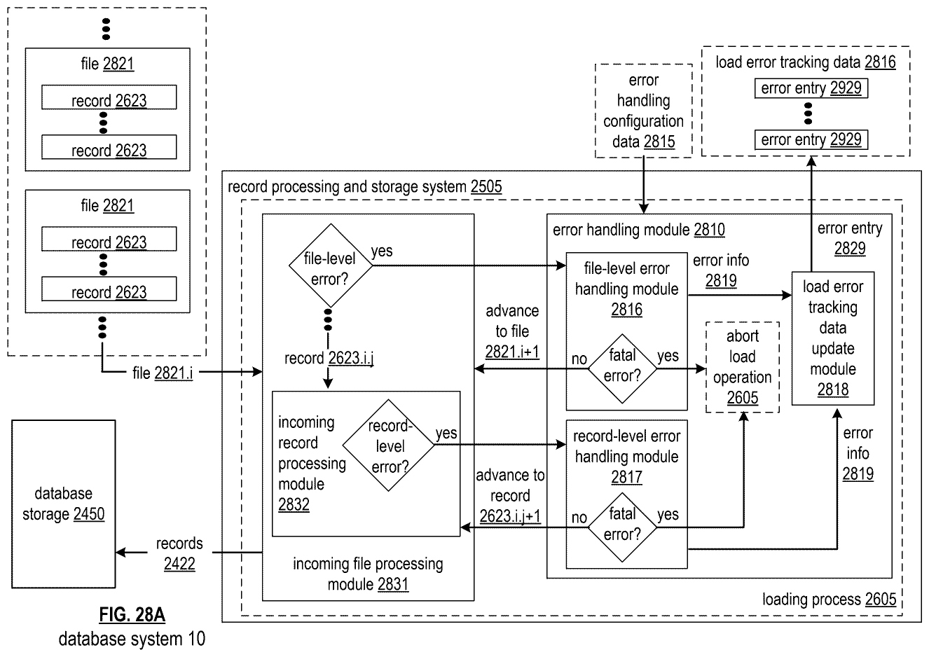

The record transformation module 2625 can further process the source record sets to generate the transformed record sets based on applying a specification linking source fields of difference aliases with target columns of different aliases, for example, allowing the specification of additional transformation operations. This can be based on implementing some or all features and/or functionality of FIGS. 27A-27G and/or otherwise accessing information specifying how/which transformation operations be performed to generate a given transformed record 2624 from a given record 2623.

As illustrated in FIG. 26A, a record source and target identification module 2610 can be utilized to identify a source identifier 2611 and target identifier 2612 for each source record 2623 of a given source dataset 2601. where a source identifier 2611.j assigned to a given record 2623.i identifies that record 2623.i is included in a particular source dataset 2601.j of the set of source datasets 2601.1-2601.L, and/or where a target identifier 2612.k assigned to the given record 2623.i identifies that record 2623.i is destined for a particular target database table 2712.k of the set of target database tables 2712.1-2712.T.

Each record 2623 can be processed via a table populator module 2620 to determine a plurality of source record sets 2627.1-2627.T, each corresponding to one of the set of target database tables 2712.1-2712.T, based on the target identifier mapped to each record 2623 (e.g. record 2623.i is included in source record set 2627.k destined for target database table 2712.k based on having target identifier 2612.k).

Different source record sets 2627 can have same or different numbers of records 2623. In some or all cases, all source records of a given source dataset 2601 can be destined for a same target database table 2712 and can thus be included in a same source record set 2627. In some or all cases, different source records of a given source dataset 2601 can optionally be destined for different target database table 2712 and can thus be included in different source record sets 2627. One or more given source record sets 2627 can include source records from multiple different source datasets 2601, for example, based on some or all records of these different source datasets being destined for the same table to which records of a given source record set 2627 are destined.

A record transformation module 2625 can generate each of a set of transformed record sets 2628.1-2628.T from a corresponding one of the set of source record sets 2627.1-2627.T. Each transformed record set 2628 can include a plurality of target records 2422, for example, implemented as and/or based on transformed records 2624 generated from source records 2623 of a corresponding source record set. The records 2422 can be stored in (e.g. added to) the corresponding target database table accordingly via being stored in database storage 2450. For example, records 2422 of a given transformed record set 2628 are stored in pages 2515 and/or sets of multiple such pages are converted into sets of segments 2424 for the corresponding table 2712 each stored via a memory drive of a corresponding node 37, for example, in conjunction with implementing some or all features and/or functionality of FIGS. 24A-25E.

Generating each given transformed record 2624.i from a given source record 2623.i can include applying corresponding source information 2617.j and corresponding target layout information 2618.k, based on the given source record 2623.i having the source identifier 2611.j and the target identifier 2618.k. For example, a given source record set 2627.k may include records 2623 from various sources, where generating a first given transformed record for the given target database table 2712.k can include performing a first transformation (e.g. first types/arrangement of one or more transformation operations) to a first corresponding source record 2623 of the source record set 2627.k based on the first corresponding source record 2623 being from a first source dataset 2601, while generating a second given transformed record for the given target database table 2712.k can include performing a second transformation (e.g. second types/arrangement of one or more transformation operations different from the first types/arrangement of one or more transformation operations) to the second corresponding source record 2623 of the source record set 2627.k based on the second corresponding source record 2623 being from a second source dataset 2601 different from the first source dataset 2601 (e.g. based on the second source dataset 2601 having different source layout information from that of the first source dataset rendering records 2623 having different layouts/structuring requiring different transformations being applied to generate target records having the schema for the target table 2712).

A particular transformation (j,k) to be applied to generate a transformed record 2624 destined for a particular transformed record set 2628.k from a source record 2623 from source dataset 2501.j can be dictated by the source layout information 2617.j and target layout information 2617.k, and can involve a corresponding types/arrangement of one or more transformation operations dictated by the source layout information 2617.j and target layout information 2617.k. In some embodiments, determining and/or applying the types/arrangement of one or more transformation operations defining a particular transformation j,k) to generate a transformed record 2624 destined for a particular transformed record set 2628.k from a source record 2623 from source dataset 2501.j can be based on applying corresponding transformation graph data 2715 defined for transforming source data 2711 into target data 2712 via implementing some or all features and/or functionality of FIGS. 27A-27G (e.g. source data 2711 includes some or all fields of a given source record 2623 and/or target data 2712 includes some or all columns of a given target record 2422).

FIG. 26B illustrates an example logic flow performed to implement loading process 2605. Some or all features and/or functionality of the loading process 2605 of FIG. 26B can implement the loading process of FIG. 26A and/or any embodiment of loading process 2605 and/or corresponding loading of data to database system 10 described herein.

Each source can be defined with layout information as a unique alias SA(x) (e.g. each source record 2623 of a given source dataset 2601 having x records 2623 is defined via a unique alias SA, for example, indicating the source ID 2611 of the given source dataset 2601). Each target can be defined with layout information as unique alias TZ(y) (e.g. each source record 2623 of a given source dataset 2601 having x records 2623 is further defined via a unique alias TA, for example, indicating the target ID 2612 of the given target database table 2712 to which the source record 2623 is destined). Each record 2623 can be read from a given source dataset 2601 in conjunction with loading records of the source dataset 2601 (e.g. x source record 2623 are read from a given source dataset 2601 having x records 2623).

For each given target database table 2712, in reading each given record 2623 from one or more source datasets 2601 having records 2623 destined for the given target database table 2712 (e.g. y records total across one or more source datasets 2601 are destined for the given target database table, for example, based on all having target identifiers 2612 identifying the given target database table), fields are selected as necessary for the target and the transformation is applied to these selected fields as necessary for the target (e.g. based on applying the source layout information 2617 for the source dataset identified via the source ID 2611 of the given record 2623 and further applying the target layout information 2618 for the given target database table 2712) to produce the record 2422 for the given target alias TA(y) (e.g. denoting the given target database table 2712). This process can continue for each given target database table 2712, for example, until all data from all sources are read.

FIGS. 27A-27G illustrate embodiments of a record transformation module 2625 that generates target data from source data via applying transformation graph data. Some or all features and/or functionality of the record transformation module 2625 of FIGS. 27A-27G can implement any embodiment of record transformation module 2625, record processing and storage system 2505 and/or loading process 2605 described herein. Some or all features and/or functionality of processing source data to generate and store transformed data of FIGS. 27A-27G can implement any receipt, processing, transformation, loading, and/or storage of data described herein. Some or all features and/or functionality of FIGS. 27A-27G can implement any embodiment of database system 10 described herein.

In various embodiments, loading data into database system 10 involves reading data from different sources having different encodings, different endianness, and/or different charset than the target platform. In addition, transformation operations may be parts of the loading process.

In some embodiments, information regarding the encoding, endianness, and/or charset (or other information regarding the layout/configuration data) can be denoted as source layout information 2617 for a corresponding source. In some embodiments, this information regarding the encoding, endianness, and/or charset (or other information regarding the layout/configuration data) can be provided via a corresponding user entity (e.g. configured via user input), for example, where source layout information 2617 is optionally configured via user input. The information regarding the encoding, endianness, and/or charset can otherwise be indicated in corresponding information, for example, with corresponding details with details about the format that should be loaded and/or some additional input options.

In some embodiments, minimal user input/predetermined information is provided for transformation operations that may be required in transforming source data to target data. However, most transformation operations rely on arguments with a specific type, which often require an additional transformation operation (e.g. type casts). The same applies if no transformation operations are specified, but source data needs to be converted to match the databases target format (e.g. based on source layout information 2617 and target layout information 2618 for the respective source and target).

FIGS. 27A-27G present embodiments of a database system 10 that handles such transformations required in loading source data to a target table via implementing a record transformation module 2625 that applies transformation graph data 2715 to convert given source data 2711 to corresponding target data 2712.

As illustrated in FIG. 27A, transformation graph data 2715 can be implemented via one or more graphical paths 2716.1-2716.V, each indicating a graphical arrangement of particular transform operations 2717 indicating ordering in which the transform operations 2717 be applied to one or more source inputs 2713 of the source data 2711 to render generation of a given target output 2714.

A given target output 2714 can be a function of a single source input 2713 or multiple source inputs 2713. A given source input 2713 can optionally be involved in generating multiple different target outputs 2714 as input to multiple different graphical paths 2716. Alternatively, in some embodiments, a given source input 2713 is only ever input to no more than one target output 2714.

In some embodiments, the source data 2711 can be implemented as a given source record 2623, a particular portion of a source record 2623 (e.g. one or more given fields of source record 2623). In some embodiments, the source data 2711 can have one or more source inputs 2713.1-2713.U (e.g. some or all inputs 2723 corresponding to one or more different values of different fields for the given record 2623 being transformed, and/or some or all inputs 2723 correspond to constant values).

In some embodiments, the target data 2712 can be implemented as a given target record 2422 and/or a particular portion of a given target record 2422 (e.g. one or more given columns of target record 2422). In some embodiments, the target data 2712 can have one or more target outputs 2714.1-2714.V (e.g. some or all outputs 2724 corresponding to one or more different values of different columns for the given record 2422 being generated). V can be the same or different from U. V and/or U can be equal to one, or can be greater than one.

In some embodiments, given transformation graph data 2715 corresponds to a particular arrangement of transformation operations 2717 for implementing a particular transformation j,k) transforming source data 2711 (e.g. records 2623) of a given source dataset 2601.j to target data 2712 (e.g. records 2422) of a given target database table 2712.k, in accordance with their respective source layout information 2617.j and target layout information 2618.k, respectively. Different transformation graph data 2715 can be generated to implement respective transformations for other source datasets and/or other target tables.

As illustrated in FIG. 27B, a transformation graph data generator module 2720 can be implemented to generate transformation graph data 2715 based on source data type information 2727 for source data 2711 (e.g. data type for each target input 2713) and target data type information 2728 for target data 2712 (e.g. data type for each target output 2714). The source data type information 2727 and/or the target data type information 2728 can be configured via user input and/or can otherwise be determined (e.g. for a given source dataset and/or given target table). The source data type information 2727 can optionally be included in and/or can optionally be implemented in a same or similar fashion as source layout information 2617, where the source data type information 2727 optionally corresponds to a given source dataset 2601. The target data type information 2728 can optionally be included in and/or can optionally be implemented in a same or similar fashion as target layout information 2618, where the target data type information 2728 optionally corresponds to a given target database table 2712.

FIG. 27C illustrates example graphical paths 2716 of one or more transformation graph data 2715. A given graphical path 2716 can define the path from source to target as a graph, which might have multiple graph nodes along the path representing corresponding transformation operations. Example path 2617.1 has no nodes, denoting no transformation operations 2717 are required to generate target output 2714.1 from source input 2713.1 (e.g. set target output 2714.1 as source 2713.1). Example path 2617.2 includes two serialized graphical nodes denoting serial performance of operations 2717.b and 2717.a upon source input 2713.2 to render target output 2714.2 (e.g. target output 2712.2 equals operation_a(operation_b(source input 2713.2))). As transformation operations might use more than one input, the graph can expand and become a tree of nodes, as illustrated in example path 2713.3 from source inputs 2713.3 and 2713.4 to target output 2714.3 via tree arrangement of graphical nodes for operations 2717.c and 2717.d (e.g. target output 2717.3 equals operation_c (operation_d(source input 2717.3, source input 2717.4), constant input 2719.1)).

The source inputs 2713.1 and 2714.2 for path 2716.3 can optionally be implemented as source inputs 2713.1 and 2713.2 of paths 2716.1 and 2716.2, respectively (e.g. based on source inputs 2713.1 and 2714.2 being “reused” in generating target output 2714.3 in addition to being used to generate target outputs 2714.1 and 2714.2, respectively). Alternatively, the source inputs 2713.1 and 2714.2 for path 2716.3 are optionally different from source inputs 2713.1 and 2714.2 of paths 2716.1 and 2716.2, respectively (e.g. are some different source inputs 2717.3 and 2717.4 based on none of the source inputs being “reused” in generating multiple target outputs).

FIG. 27D illustrates initial transformation graph data 2715′ which can be ultimately transformed into transformation graph data 2715. For example, within a given path 2716, initially, only the types for the graph node representing the target (e.g. a column) and the source(s) (e.g. one or more corresponding fields in the source data) are typically known (E.g. indicated in the target data type information 2728 and source data type information 2727 respectively). Corresponding operation type information can be attached to every graph node along the path. Initially, they can be UNKNOWN (e.g. “missing” due to not yet being assigned). Each graph node along the patch can further have a corresponding identifier (e.g. name, such as “op1” and “op2” or other identifying names). The transformation graph data generator module 2720 can be implemented to generate each graphical path 2716 from corresponding initial paths based on selecting the operator types for any unknown operator types, which can optionally involve setting a given operator having a missing type as multiple operators required to fulfil the corresponding transformation from input to output).

In the example of FIG. 27D, initial path 2713.3′ (e.g. corresponding to an initial path created for graphical path 2713.3 of FIG. 27C) indicates that: input data type 2733.1 for source input 2713.1 corresponds to a bytes data type; input data type 2733.2 for source input 2713.2 also corresponds to the bytes data type; input data type 2733.3 for constant input 2719.1 corresponds to a char data type; output data type 2734.3 for target output 2713.2 corresponds to a timestamp data type; operation type 2737.c for operation 2717.c is unknown (e.g. missing); operation type 2737.d for operation 2717.d is also unknown (e.g. missing).

FIG. 27E illustrates an embodiment of transformation graph data generator module 2720 that generates transformation graph data 2715 via applying a type-casting operation list 2741 (L1) and/or a full operation list 2742 (L2). List L1 can contain operations that use argument only and can be used to transition from a source data type to a target data type. The list 2741 of FIG. 27E can correspond to an example list L1, where other embodiments include different lists (e.g. longer lists with more operations and/or operations having different names). A second list (L2) can contain all operations that are supported by the loading system (e.g. including the operations of the first list). Note that some operations (e.g. op1) are duplicated based on having a given return type, despite having different “versions” supporting different input arguments.

For example, the transformation graph data generator module 2720 can determine the missing operations op1 and op2 of FIG. 27D based on these lists. For example, operation 2717.c is ultimately selected as performance of operation op2 having return type timestamp and arguments 1 and 2 of type long and char; and/or operation 2717.d is ultimately selected as performance of an arrangement of three operations: (1) operation op1 having return type long (e.g. to render generation of input for the selected operation op2 based on op2 requiring the long type as its input) and arguments 1 and 2 of type char and char, which is applied to two char inputs generated via two additional operations (2) and (3): (2) a type-cast-op-1 applied to source input 2713.1, based on source input 2713.1 having the byte input type required as source type of type-cast-op-1, to generate first char input to op1 as its output; (3) type-cast-op-1 applied to source input 2713.2, based on source input 2713.2 having the byte input type required a source type of type-cast-op-1, to generate first char input to op1 as its output.

Generating some or all graphical paths 2716 (and populating any unknown operators with one or more operators from list L1 and/or L2 can generated via transformation graph data generator module 2720 based on performing a set of corresponding algorithms, which can include executing some or all logic of a graphical path generation algorithm 2751 (A1) of FIG. 27F and/or executing some or all logic of a missing type-cast handling algorithm 2762 (A2) of FIG. 27G.

A graphical path generation algorithm 2751 can be executed via performing some or all logic of algorithm A1 of FIG. 27F to generate a list of paths each having a corresponding length (e.g. via a corresponding recursive process). This graphical path generation algorithm A1 can be performed to generate an initial path 2716 from given source input(s) 2713 having some known type A to given target output 2714 having some known type B (e.g. having known data types dictated by source data type information 2727 and/or target data type information 2728). The path in the list having the shortest length can be selected as the initial path 2716′ from the given source input to given target output. The returned path can have some or all operator nodes set as type UNKNOWN.

A missing type-cast handing algorithm 2752 can be executed via performing some or all logic of algorithm A2 FIG. 27G to process an initial path 2716′ (e.g. selected via execution of graphical path generation algorithm 2751 of FIG. 27F) to introduce missing typecasts for nodes with unknown type to render generation of the corresponding graphical path no longer having unknown types, which can be implemented as graphical path 2716 in transformation graph data 2715 applied via record transformation module 2625 accordingly.

Performing the missing type-cast handing algorithm 2752 can include, first, starting at the top graph node of the given input path (e.g. initial path 2716′) to find all children nodes with UNKNOWN type, where the child as new top (e.g. restart). When all children have a type, and when the current node has a type algorithm A1 is applied to introduces missing typecasts with shortest length. When the current node has UNKNOWN type, node name can be utilized to lookup candidates in list (L2), where number of arguments match the number of children. In this lookup, if only one candidate matches where arguments have same type as children nodes, the return type of node is the return type of the candidate; if multiple candidates match, then error out, and if no candidates match, then for every candidate: (1) use the arguments type and the children's type and apply AI algorithm; (2) sum the length of introduced typecast over all children; (3) compare the summed lengths for each candidate, where candidate with lowest summed length wins; and (4) set the return type of this node to the return type of the candidate.

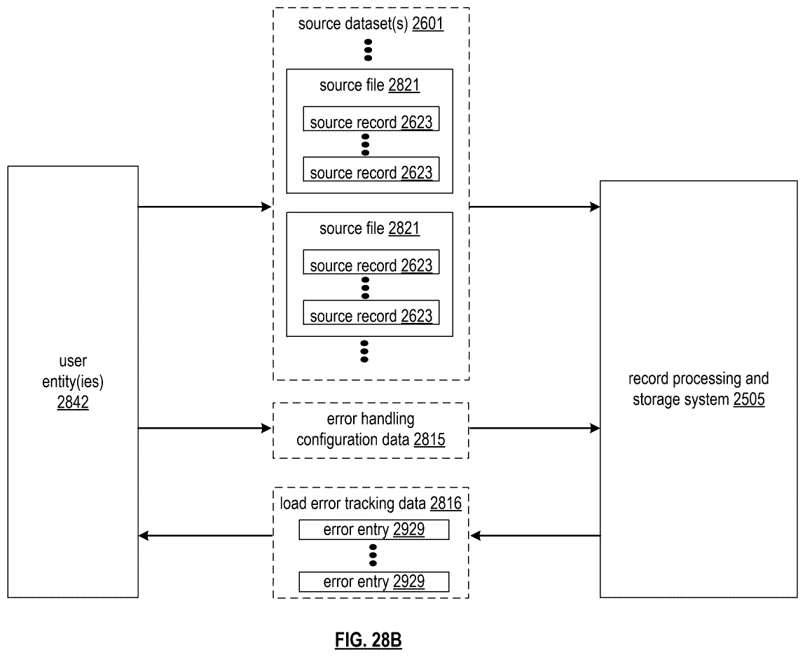

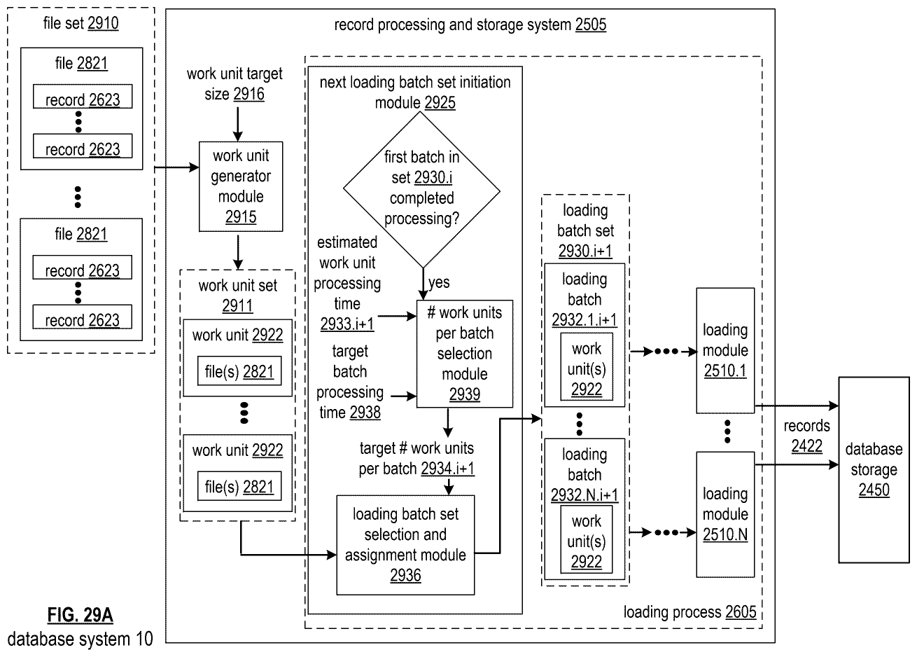

FIGS. 28A-28B illustrate embodiments of a record processing and storage system 2505 that performs a loading process 2605 to process a plurality of files that each include a plurality of records for storage based on performing error handling when encountering record-level errors and/or file-level errors in accordance with error handling configuration data, and/or based on maintaining load error tracking data based on encountering the record-level errors and/or the file-level errors. Some or all features and/or functionality of the record processing and storage system 2505 and/or loading process 2605 of FIGS. 28A-28B can implement any embodiment of record processing and storage system 2505 and/or loading process 2605 described herein. Some or all features and/or functionality of processing and storing records included in files of FIGS. 28A-28B can implement any receipt, processing, transformation, loading, and/or storage of data described herein. Some or all features and/or functionality of FIGS. 28A-28B can implement any embodiment of database system 10 described herein.

In some embodiments of loading process 2605, by default, a corresponding pipeline (e.g. implemented via record transformation module 2625, such as via one or more graphical paths 2716) will stop processing and fail immediately upon seeing an error. It can be preferred in some cases to prevent such errors from blocking the execution of the rest of the load. It can also be preferred to enable user configuration of which/how many errors are acceptable before load failure, and/or to render logging of errors for viewing/access by users (e.g. corresponding one or more same or different user entities).

FIGS. 28A-28B present embodiments of record processing and storage system 2505 where such error handling and logging is performed, which can improve the technology of database systems based on increasing transparency and enhancing usability based on making error tracking and handling more visible and/or more configurable by users of the database system 10.

As illustrated in FIG. 28A a plurality of files 2821 that each include a plurality of records 2623 can be received/accessed by database system 10 for loading (e.g. the plurality of files 2821 correspond to one or more source datasets 2601). A given file 2821.i can be processed via an incoming file processing module 2831 enabling to processing of its records 2623, where a given record 2623.i.j of the given file 2821.i is processed via an incoming record processing module 2832 of the incoming file processing module 2831. As files are processed, records 2422 can be generated from records 2623 (e.g. via implementing record transformation module 2625).

During processing of files 2821 and/or individual records 2623 within files 2821, file-level errors and/or record level errors can be encountered and handled via an error handling module 2810, which can implement corresponding error handling in accordance with error handling configuration data 2815 to implement: a file-level error handling module 2816 to handle file-level errors; and/or a record-level error handling module 2817 to handle record-level errors. For example, a non-fatal record-level error of a given record 2623.i.j can be handled via advancing to a next record 2623.i.j+1 in the given file 2821.i (e.g. skipping the given record 2623), and/or a non-fatal file-level error of a given file 2821.i can be handled via advancing to a next file 2821.i+1 (e.g. skipping remaining processing of remaining records in the given file). A fatal record-level error and/or fatal file-level error can be handled via aborting the load operation (e.g. foregoing processing of any remaining records/files). Furthermore, as errors are encountered, corresponding error information 2819 can be processed via a load error tracking data update module 2818 to render population of load error tracking data 2816 with error entries 2929 indicating corresponding error information 2819 (e.g. one error entry 2929 is logged per error encountered). The error handling configuration data 2815 (e.g. configured via user input and/or received from/configured by user entity) can indicate: which errors/corresponding conditions correspond to fatal errors vs. non-fatal errors; what the error information 2819 indicate; whether error entries 2929 be generated for all errors, for only fatal errors, or for errors meeting other configured specifications; configured thresholds dictating how many errors be handled before aborting a query; where/how load error tracking data 2816 be sent/stored/made accessible; etc.

FIG. 28B illustrates communication between one or more user entities 2842 and record processing and storage system 2505. One or more user entities 2842 can be responsible for sending, and/or otherwise facilitating loading from a corresponding location, of one or more source datasets 2601 that include the plurality of source files 2821 of FIG. 28A to be loaded by record processing and storage system 2505. The same or different one or more user entities 2842 can be responsible for configuring and/or sending the error handling configuration data 2815, dictating how errors in loading the source dataset(s) 2601 be handled, for processing by record processing and storage system 2505. The record processing and storage system 2505 can generate, send to the one or more same or different user entities 2842, and/or otherwise make accessible to the one or more same or different user entities 2842, the load error tracking data 2816.

Such users can correspond to one or more same or different user entities, which can be: user entities corresponding to external requesting entities 2912 that request queries; user entities corresponding to data sources 2501 that load their data to the system for use in query execution; user entities corresponding to administrators of the database system that ensure loading is performed properly and/or that handle errors; user entities corresponding to humans; user entities corresponding to automated entities, such as one or more computing devices and/or server systems, that automatically handle errors and/or automatically present improvements automatically to reduce future errors; user entities within database system 10; user entities external to database system 10, and/or other user entities.

In some embodiments, users can configure their load to tolerate record-level or file-level errors to prevent such errors from blocking the execution of the rest of the load. If a record-level error is encountered (e.g. one record has a corrupted field that cannot be transformed), the load can skip the problem record and continue processing the next record. If a file-level error is encountered (e.g. a file is corrupted and cannot be decompressed), the load can skip the problem file and continue processing the next file.

In some embodiments, when an error is encountered during a loading process 2605, the details of the error are made accessible by the user, enabling the user to access the details of that error so they can identify and respond to it. For example, in the case of a record-level error, the user may even need to reload the problem record via a different pipeline to process it properly. This need is amplified and complicated when a load can encounter multiple (perhaps even hundreds or thousands of) errors.

In some embodiments, the load error tracking data 2816 is accessible via one or more one or more places (e.g. if they configure their load to put error information in those places via error handling configuration data 2815). For example, a user can access error information about their loa via a persistent system catalogue table (e.g. “sys.pipeline_errors” and/or other persistent system table implemented as a table 2712 of database system 10 where error entries 2929 are records 2422 of the table 2712 and/or where the table 2712 is query-able via query requests for execution as described herein) and/or in an optional error sink (e.g. one or more targets, such as a “BAD_DATA_TARGET” of the pipeline and or any target, for example, implemented via at least one Apache Kafka topic, at least one local file target, at least one S3 file target, and/or at least one other type(s) of target.

In some embodiments, by default, all errors the load encounters are loaded to the designated persistent system catalogue table (e.g. sys.pipeline_errors). When a corresponding extractor engine pipeline (e.g. implemented via one or more loading modules 2510 of loading process 2505, for example, via execution of record transformation module 2625 and/or corresponding graphical path(s) 2716 of transformation graph data 2715) encounters an error, it can add the error to the current batch of errors. In some embodiments, if there are enough errors in the batch to reach a flush threshold (e.g. configured in error handling configuration data 2815 or otherwise predetermined), and/or if the extractor engine pipeline is completing, extractor engine can send the error information to a metadata layer (e.g. a rolehostd metadata layer, and/or other metadata layer, for example, where the error information is stored in system metadata implemented). In some embodiments, the metadata layer can then forward the error information to a stream loader (e.g. loading module 2510), and the stream loader will load the error information to the designated persistent system catalogue table (e.g. a designated table 2712 stored via in database storage 2450), for example, where one record will be loaded for each error.

In some embodiments, the user can configure (e.g. in error handling configuration data) to only load the final (fatal) error be logged via a corresponding error entry 2929 in load error tracking data, for example, if desired for performance reasons and/or memory reasons, and/or can configure that only a proper subset of errors meeting particular criteria be logged vs. logging of every error.

The user can access and/or process the information in the load error tracking data to identify and analyze errors their load encountered. This can be useful when developing and testing a new pipeline and/or when identifying corrupted source data from a load that tolerates errors. Some or all of such analysis can optionally be performed via an automated process via database system 10 and/or can be performed via query execution by database system 10 of one or more queries against the table 2712 implementing a designated persistent system catalogue table storing the load error tracking data 2816.

In some embodiments, when an error sink and/or corresponding target (e.g. BAD_DATA_TARGET) is configured and the extractor engine pipeline encounters a record-level error, that error will be loaded to that target. For example, the corresponding target can receive both metadata about the error (e.g. location, error message, error type) and/or the bytes of the record that produced the error (e.g. so that the bad record can be loaded from the target if desired). For example, when the target is implemented via an Apache Kafka topic, the bytes are the Kafka record, and the metadata is produced to Kafka as header values. Record-level errors can be identified by error entry class (e.g. they are implemented as an instance of “RecordBasedErrorEntry”). In some embodiments, the “bad” records inducing errors can be loaded using another pipeline that sources from the BAD_DATA_TARGET in order to complete their original load or otherwise process the bad records.

In some embodiments, when the load encounters a record-level error, the record-level error handling module 2817 can be implemented via applying some or all of the following logic:

First, the error count is incremented (e.g. via the extractor engine);

Second, the error is logged (e.g. via load error tracking data update module 2818). For example, “logging” an error includes adding it to extractor engine's in memory error target (e.g. the extractor engine keeps track of a configurable number of errors per pipeline in memory. This list of in-memory errors can be queried via extractor engine's REST API, for example, as long as the corresponding pipeline exists). The error can be added to the current batch of errors to be sent to sys.pipeline_errors or other persistent table, and/or the error can be to the BAD_DATA_TARGET or other target (e.g. if the pipeline is configured with a BAD_DATA_TARGET).

Third, if the error count from the first step exceeds the error limit of the pipeline (e.g. configured when starting the pipeline, for example, indicated by error handling configuration data 2815), then recovery will not occur, processing will halt at the errored record, and/or the load will fail. If the error count is below the error limit, then the errored record will be rolled back and processing will continue with the next record.

In some embodiments, when the load encounters a file-level error, the file-level error handling module 2816 can be implemented via applying some or all of the following logic:

First, if the error occurs before tokenization, then the error will be propagated downstream (e.g. towards the tokenization phase). Pre-tokenization processing (e.g. extracting files, decompressing files) can continue with the next file.

Second, at the tokenization phase, if the load is not configured to tolerate file-level errors, then recovery will not occur, processing will halt at the errored file, and/or the load will fail. If the load is configured to tolerate file-level errors, then the errored file will be marked as errored, and any further data from the file will be ignored at the tokenization phase; the error handling proceeds to the third step.

Third, the error is logged (e.g. via load error tracking data update module 2818). For example, “logging” an error includes adding it to extractor engine's in memory error target, adding the error to the current batch of errors to be sent to sys.pipeline_errors or other persistent table, and loading the error to the BAD_DATA_TARGET or other target (e.g. if the pipeline is configured with a BAD_DATA_TARGET, and/or the file-level error is such that the error occurs on a specific record that can be captured, such as an unrecoverable record tokenization error; the error occurs on a specific record, but the occurrence of the error means that no records following the errored record in the file can be successfully tokenized, since the successful detection of the beginning of the next record depends on the successful detection of the end of the current record).

Fourth, any partial record data from the errored file is discarded, and/or processing will continue with the next file. In some embodiments, any records from the errored file that were completely tokenized before the error was accounted for in step two are unaffected and proceed to transformation.

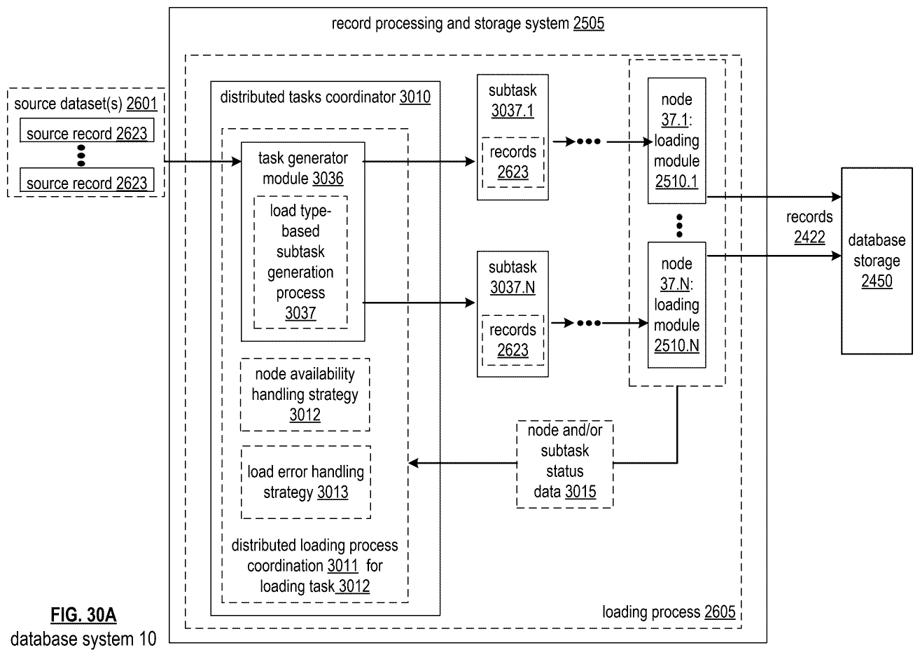

FIG. 29A illustrates an embodiment of a record processing and storage system 2505 that performs a loading process 2605 to process a plurality of files that each include a plurality of records for storage based on generating a plurality of work units in accordance with a work unit target size, and generating a plurality of loading batch sets for assignment to a set of loading modules for processing over time, for example, based on adapting a target number of work units per batch based on updates to estimated work unit processing time during processing. Some or all features and/or functionality of the record processing and storage system 2505, loading process 2605, and/or loading modules 2510 of FIG. 29A can implement any embodiment of record processing and storage system 2505, loading process 2605, and/or loading modules 2510 described herein. Some or all features and/or functionality of processing and storing records included in files of FIG. 29A can implement any receipt, processing, transformation, loading, and/or storage of data described herein. Some or all features and/or functionality of FIG. 29A can implement any embodiment of database system 10 described herein.

In various embodiments of database system 10, when a file load is performed using multiple loaders (e.g. multiple loading modules 2510), it can be ideal to implement a means of splitting the files into batches such that each loader is engaged for the majority of the load. If some N number of files is assigned to each batch (e.g. with each batch being loaded by one task, and all the tasks being created up front), it can be possible to run into a scenario where all the larger files will be assigned to one batch, and that one batch will be oversized, leading to one loader having to perform 90% of the load while the other loaders are idle for most of that time. This can lead to the appearance of a “tail” in the load, where one loader is left processing a long tail of files.

Use of distributed tasks to orchestrate the load can help ameliorates this situation: tasks aren't assigned to loaders up front, so if there are enough tasks, then faster loaders will naturally execute more tasks, reducing the length of the tail. However, if the load consists of less than (number of loaders)*N number of files, and/or if the load is split into less tasks than loaders, then the problem can still persist.

FIG. 29A presents a solution to this problem that improves the technology of database systems based on rendering more efficient loading of data via a plurality of loaders. This can include dispersing the files into batches based on their file sizes, dynamically size these batches to adapt to the current conditions (e.g. of the cluster, network, and other aspects of the load environment), and/or not creating all the tasks up front.

As illustrated in FIG. 29A, the record processing and storage system 2505 can be operable to process a given file set 2910 (e.g. a bulk set of files determined up front, which can be optionally implemented a portion of or the entirety of one or more source datasets 2601, where the records in each file are optionally implemented as source records 2623) that includes a plurality of files 2821 that each include a plurality of records. A work unit generator module 2915 can generate a work unit set 2911 that includes a plurality of work units 2922 generated from the plurality of files, where each work unit 2922 includes a set of one or more files 2821 based on a work unit target size 2916 (e.g. target number of bytes/target number of records), where work units 2922 are built to meet/be as close to the work unit target size 2916 as possible. This can include different work units having different numbers of files 2821 based on different files 2821 being different sizes (e.g. one work unit has a few large files, another work unit has many small files, both work units have close to the same number of bytes close to the work unit target size 2916). Generating work units 2922 can be based on keeping files whole (e.g. a given file is placed in exactly one work unit).

As a particular example, after listing files at the start of a load as file set 2910, the files can be distributed up front into work units with a work unit target size 2916 of S bytes, for example, where S=(least common multiple of the numbers of cores for the loaders used)*(average size of files in this load), for example, where number of cores corresponds to processing core resources 48 of nodes 37 implementing the loading modules 2510.1-2510.N. Each work unit should contain at least one file. Since the work units should be approximately evenly sized, they can be utilized as the unit by which batches are measured.

The loading process 2605 can be implemented after the work unit set 2911 is created up front by implementing a next loading batch set initiation module 2925 that implements a loading batch set selection and assignment module 2936 to assign a given set of loading batches 2932.1-2932.N of a given loading batch set 2930.

For example, a given loading batch set 2930 includes only N loading batches 2932 (e.g. assigned via N corresponding tasks, such as N subtasks 3037.1-3037.N), where each of the N loading modules 2510 is thus assigned one of these batches 2932. A first loading batch 2930.1 can includes a first set of loading batches set of loading batches 2932.1.1-2932.1.N assigned to the N loading modules 2510.1-2510.N. Each of these N initial batches can be configured to include a same number of work units, such as exactly one work unit for the for the first loading batch processed by each loading module consists of one work unit (e.g. each task should process about S bytes worth of files).

The next loading batch set initiation module 2925 can determine when the first batch in a given (e.g. current) batch set 2930.i has completed processing by a corresponding loading module 2510 (e.g. a corresponding task is completed by the corresponding loading module), where the next loading batch set 2930.i+1 of N batches to be assigned across the N loading modules is determined only once a first loading batch 2932.j.i in the given set 2930.i has completed processing.

A number of work units per batch selection module 2939 can be implemented to configure a target number of work units per batch 2934 for the next batch set 2930.i+1 enabling batches 2932 to have sizes that change dynamically over time. For example, an estimated work unit processing time 2933.i+1 for a current/upcoming time frame can be estimated based on current conditions, how long the most recent batch set took to process, changes to the network/memory/processing/storage/nodes of the system, etc. The target number of work units per batch 2934.i+1 to be applied in generating the next loading batch set 2930.i+1 can be generated as a function of configured work unit processing time 2933.i+1 (e.g. as an inverse function of estimated work unit processing time 2933.i+1. For example, all N loading batches 2932.i+1.1-2932.i+1.N can have a number of work units 2922 equal to and/or close to the target number of work units per batch 2934.i+1 selected based on the estimated work unit processing time 2933.i+1. As the estimated work unit processing time 2933 changes overtime, the target number of work units per batch 2934 (and thus actual number of work units per batch) can change accordingly to adapt loading batch sizes to changing of conditions during the loading process 2605. As a particular example, the number of work units per batch selection module 2939 can generate the target number of work units per batch 2934.i+1 such that a target batch processing time 2938 is expected to be met, based on the estimated work unit processing time (e.g. include a number of work units in the batch such that processing time of the new batches is expect to get as close to target batch processing time 2938 as possible).

This process of generating loading batch sets 2930 to all have a number of work units configured based on the target number of work units per batch 2934 selected for the given loading batch set 2930 can continue until all work units of work unit set 2911 are assigned in loading batches.

As a particular example, once the first of the N tasks completes for a given loading batch set 2930.i, the next loading batch set initiation module 2925 can be implemented to:

First, recalculate the number of work units W (e.g. target number of work units per batch 2934) that should be in a batch as target number of work units per batch 2934.i+1, for example, such that each task has a predicted execution time of T, where T is some configurable value (e.g. target batch processing time 2938), for example, that defaults to 10 minutes or some other default. This can be based on applying the assumption that W is proportional to task execution time. This first step can be performed via implementing the number of work units per batch selection module 2939.

Second, create another set of N tasks (e.g. n loading batches 2932.1-2932.N). Each of these tasks should load a batch that consists of W work units (e.g. target number of work units per batch 2934). For example, each loading batch 2932/corresponding task should process about S*W bytes worth of files. This second step can be performed via implementing loading batch set selection and assignment module 2936.

Third, once the first of these new tasks completes, repeat the first and second step for this new set of N tasks. For example, the recalculation of W and task creation is only performed once per set of tasks (e.g. once per loading batch set 2930).

These first, second, and third steps can be repeated until there are no work units left. This implementation can limit the length of the tail to be about T (e.g. target batch processing time 2938).

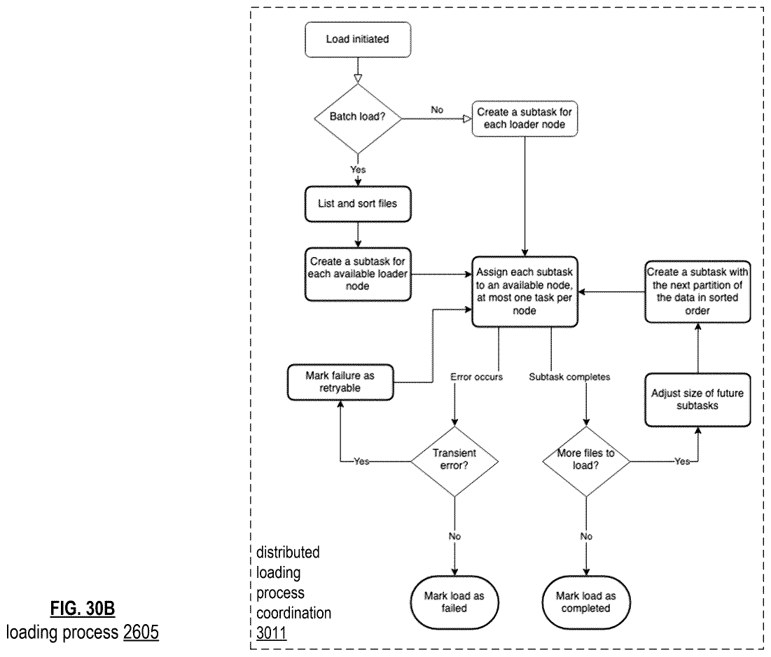

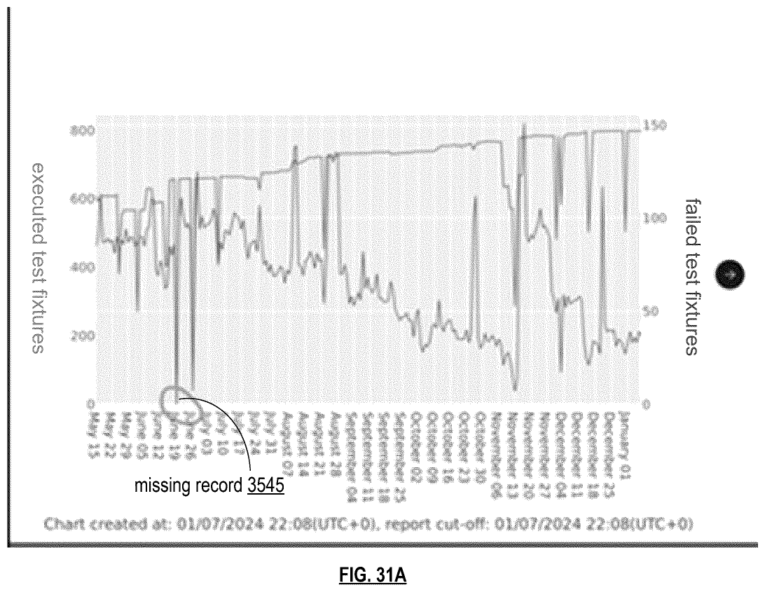

FIG. 30A-30B illustrate embodiments of a record processing and storage system 2505 that performs a loading process 2605 to process source records of one or more source datasets based on generating and assigning a plurality of subtasks to a plurality of nodes for execution via implementing a distributed tasks coordinator, for example, in accordance with a distributed tasks framework. Some or all features and/or functionality of the record processing and storage system 2505, loading process 2605, and/or loading modules 2510 of FIGS. 30A-30B can implement any embodiment of record processing and storage system 2505, loading process 2605, and/or loading modules 2510 described herein. Some or all features and/or functionality of nodes 37.1-37.N can implement any nodes 37 described herein, for example, via implementing any embodiment of a consensus protocol and/or task assignment and/or execution via nodes 37 described herein. Some or all features and/or functionality of processing and storing source records of one or more source datasets of FIGS. 30A-30B can implement any receipt, processing, transformation, loading, and/or storage of data described herein. Some or all features and/or functionality of FIGS. 30A-30B can implement any embodiment of database system 10 described herein.

In some embodiments, in order to quickly load data into database system 10, it can be desirable to load data using multiple nodes at the same time. However, doing this reliably can require requires that the loading process handles problems common to distributed systems (node outages, network partitions, etc.), while preserving data correctness.

FIGS. 30A-30B present embodiments that improve the technology of database systems based on being configured to handle these scenarios. This can include dividing the entire loading task 3012 (e.g. for a corresponding loading process 2605, and/or a single load operation) into subtasks (e.g. subtasks 3037). Execution of each subtask can corresponding to loading of a partition of the data, and can be executed on any available node 37 in the system (e.g. in conjunction with being implemented as a loading module 2510). The subtasks can be coordinated using a corresponding distributed tasks framework, for example, via implementing some or all features and/or functionality disclosed by U.S. Utility application Ser. No. 18/482,939, entitled “PERFORMING SHUTDOWN OF A NODE IN A DATABASE SYSTEM” in conjunction with assigning various tasks to nodes for execution in parallel. In some embodiments, once all subtasks are complete, the load can be marked as complete. If a subtask fails, we mark the load as failed.

As illustrated in FIG. 30A, record processing and storage system 2505 can implement a loading process 2605 based on processing one or more source datasets 2601 in conjunction with performing a corresponding given loading task 3012 (e.g. a given load operation and/or given loading process 2605). A distributed tasks coordinator 3010 can perform distributed loading process coordination 3011 in conjunction with assigning subtasks 3037 to nodes and handling any errors/changes in node availability as needed in conjunction with facilitating completion of the loading task 3012 as a whole, for example, based on receiving and/or processing node and/or subtask status data 3015 over time (e.g. indicating when subtasks are completed/their progress; indicating node availability/node outages; indicating errors encountered in processing records in conjunction with executing a subtask; etc.)

The distributed tasks coordinator 3010 can implement a task generator module 3036 to generate one or more sets of subtasks 3037.1-3037.N for assignment to different nodes 37.1-37.N for execution (e.g. in conjunction with nodes 37.1-37.N implementing a corresponding set of loading modules 2510.1-2510.N). For example, a given node 37 is assigned one or more subtasks 3037 over time for processing (e.g. one at a time if receiving multiple subtasks over time), where each subtask 3037 includes a corresponding set of one or more records for processing.

In some embodiments, subtasks are created and assigned based on the type of load being performed, where different types of subtasks are created for different load types in conjunction with implementing the load-type based subtask generation process. The different load types can include a batch load type and/or a continuous load type.

The batch load type can correspond to a load of a predetermined batch of files, for example, where the file(s) to be loaded are listed and sorted (e.g. based on a user-specified sort order). The load-type based subtask generation process can implement a batch load-based subtask generation process when the load type is the batch load type.

Implementing the batch load-based subtask generation process can include, initially, creating a subtask for each node in the system, where each subtask loads a partition of the files. Subtasks that are created earlier are executed earlier to render earlier loading of files that are sorted earlier than later loading of files sorted later. As subtasks complete, more subtasks can be created to load files later in the sorted order. For example, the time that earlier subtasks took to complete can be utilized to adjust the number of files in later subtasks (e.g. targeting a 10-minute duration for each subtask by default). This can include implementing some or all features and/or functionality of the next loading batch set initiation module 2925.

A given node can execute a newly created subtask once it has completed its current subtask. Because of this, each node will execute one subtask at a time. This allows parallelization of the load to the greatest possible extent while loading data approximately in sorted order.

In some embodiments, the subtasks 3037 can be configured to each indicate a corresponding loading batch 2932 for loading, where the task generator module 3036 implements some or all features and/or functionality of next loading batch set initiation module 2925 to generate sets of subtasks over time, where a given subtask 3037 indicates a given loading batch 2932 for loading, where a given set of subtasks indicates N subtasks 3037.1-3037.N for processing by the N nodes 37.1-37.N and corresponds to a given loading batch set 2930, and where subsequent sets of N subtasks are generated for subsequent loading batch sets 2930. In such embodiments, the one or more source datasets 2601 for the loading task can be implemented as the file set 2910, for example, where the bulk loading of the predefined file set 2910 of FIG. 29A corresponds to the batch loading type.

Meanwhile, the continuous load type can correspond to a load if a continuous streaming source (e.g. implemented via Apache Kafka). The load-type based subtask generation process can implement a continuous load-based subtask generation process when the load type is the continuous load type.

Implementing the continuous load-based subtask generation process can include, create one subtask for each node in the system (e.g. each of the N nodes 37.1-37.N participating in the loading task 3012). All these N subtasks 3037.1-3037.N can be executed in parallel, one on each node. Streaming data source can be responsible for rebalancing data partitions among the nodes in the system. None of the subtasks ever complete (e.g. while the streaming source is active/still emitting data); instead, execution of these subtasks can include continually polling the streaming data source for more data to load (e.g. indicating more data is requested/needed for loading).

The distributed tasks coordinator 3010 can be configured to further implement a node availability handling strategy 3012 in conjunction with performing the distributed loading process coordination 3011. For example, in order to handle situations where one or more nodes are not available (e.g. due to hardware failure or network issues), the distributed tasks framework can be applied to maintains knowledge of which nodes are available and assigns subtasks to available nodes. If a node becomes unavailable, its subtask is reassigned to a different, available node.

Implementing the node availability handling strategy 3012 can be based on detecting and responding to changes in node availability of any of the nodes 37.1-37.N to ensure that any of the nodes 37.1-37.N encountering outages/failure have their subtasks 3037 reassigned to other nodes 37 accordingly (e.g. a given node 37.x implementing loading module 2510.x fails, and is “replaced” by another node 37.y that implements this loading module 2510.x via reassignment of the corresponding subtask(s) 3037 assigned to this failed node, where the new node continues/restarts any subtasks to ensure subtasks assigned to loading module 2510.x are completed accordingly despite the node outage).

This reassigning can result in a task being executed multiple times on different nodes, in sequence or at once. The node availability handling strategy 3012 can be configured to guarantee that all data is loaded, and that no data being loaded twice. This can be based on configuring each subtask to be idempotent: if it is executed more than once, data will be deduplicated (e.g. by a rolehostd) to ensure that the exact, correct data is loaded. This can be accomplished by assigning a unique and unchanging stream source ID to each data partition (e.g. where IDs are maintained as system metadata mediated as state data in conjunction with a consensus protocol, for example, based on the IDs being managed via a metadata-layer Raft-based store).

The distributed tasks coordinator 3010 can be configured to further implement a load error handling strategy 3013 in conjunction with performing the distributed loading process coordination. For example, the loading process can fail and/or otherwise encounter errors requiring handing. Monitoring and handling of errors occurring during/failure of the loading process can be performed via implementing the load error handling strategy 3013 to ensure that all data is ultimately loaded correctly (e.g. exactly once).

Loading failure can occur due to transient or non-transient errors. Some or all network-related errors can be classified as transient errors (e.g. timeouts, connection failures, broken connections, etc.) while some or all data-related errors can be classified as non-transient errors (e.g. data transform failures or datatype mismatches).

Implementing the load error handling strategy 3013 can include, when a transient error occurs, marking the subtask in which it occurred as failed. However, this failure can be marked as retriable (e.g. based on the error being a transient error vs. a non-transient error). In response to the failed task being marked as retriable, the distributed tasks framework can randomly reassign this retriable task to an available node to be run again. In some embodiments, if the number of transient errors on a single subtask reaches a user-specified threshold, the corresponding retrying ends and the entire load is marked as failed.

Implementing the load error handling strategy 3013 can include, when a non-transient error occurs, marking the subtask in which it occurred as failed, and marking that failure as non-retriable (e.g. based on the error being a non-transient error vs. a transient error). Once the distributed tasks coordinator notices that a task has failed (e.g. and is also non-retriable), it can communicate to all nodes that their running tasks be cancelled, and the entire loading task 3012 can be marked as failed.

In some embodiments, some or all errors occurring rendering transient or non-transient failure can correspond to file-level errors or record-level errors. In some embodiments, the Implementing the load error handling strategy 3013 includes implementing some or all features and/or functionality of error handling module 2810.

In some embodiments, each subtasks 3037 is executed on a loader node (e.g. a node 37 implemented as a loading module 2510), for example, as part of a rolehostd process. In some embodiments, the rolehostd function that executes the subtask is a wrapper around a JNI call to an intra-process JVM (e.g. implemented as an “extractor engine”), which can be implemented to perform the actual work of retrieving source data and transforming it (e.g. as discussed in conjunction with execution of loading process 2605 as described herein), and then sending the transformed data back (e.g. to rolehostd) over network sockets. The extractor engine can be designed to be stateless other than its knowledge of the subtasks currently assigned to it. This can enable idempotency required for data correctness.

Each subtask can be divided into further partitions within the extractor engine. The number of partitions can correspond to a number of CPU cores available to the extractor engine (E.g. number of processing core resources 48 available on a corresponding node 37). However, the number of partitions can differ in the case of a node outage, for example, since the subtask may have been originally assigned to a node with a different CPU configuration.

FIG. 30A is a schematic block diagram of a record processing and storage system that performs a loading process based on implementing a distributed tasks coordinator that generates a plurality of subtasks each for execution via a corresponding node of a plurality of nodes in accordance with various embodiments;

FIG. 30B illustrates an example logical flow of distributed loading processing coordination performed in conjunction with performing a loading process in accordance with various embodiments. Some or all features and/or functionality of the process of FIG. 30B can implement any embodiment of loading process 2605 and/or distributed loading process coordination 3011 described herein.

A load can be initiated (e.g. in conjunction with a corresponding loading task 3012). If the load is a batch load, the files are listed and sorted, and/or a subtask is created for each available loader node 37. If the load is a continuous load, a subtasks is created for each loader node.

Each subtask can be assigned to an available node (e.g. up to one task per node at a given time). If an error occurs in executing a subtask, the load is marked as failed when the error is transient and, when the error is non-transient, the subtask is marked as retriable for assignment to an available node (e.g. a new node) to attempt re-execution of some or all of the subtask (e.g. ensuring no data is duplicated or missed in loading).

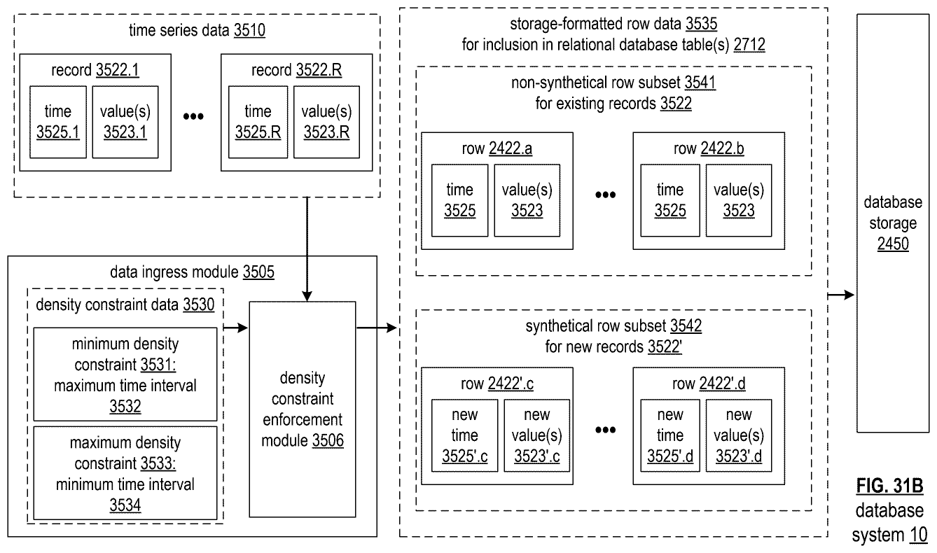

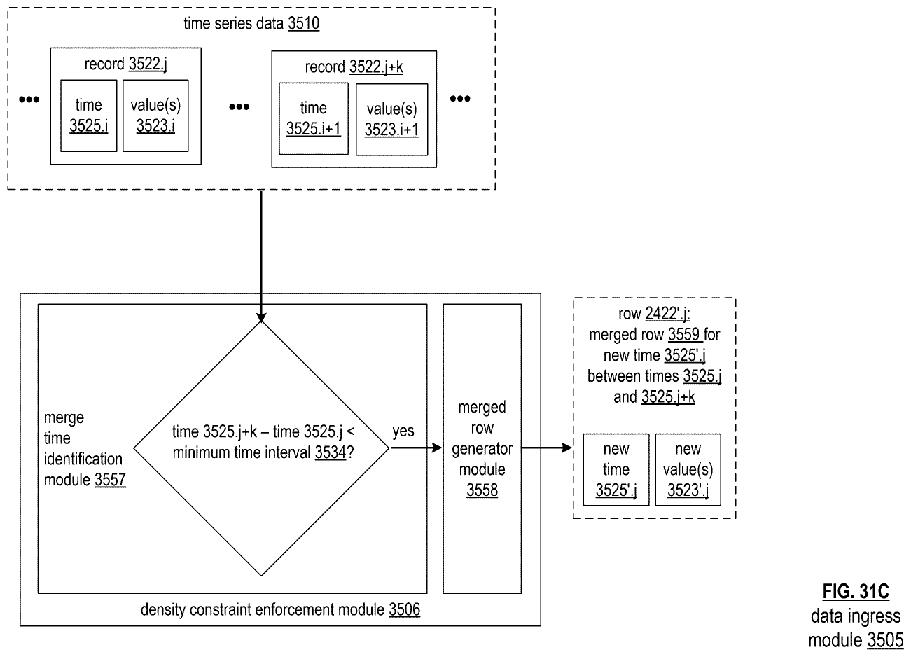

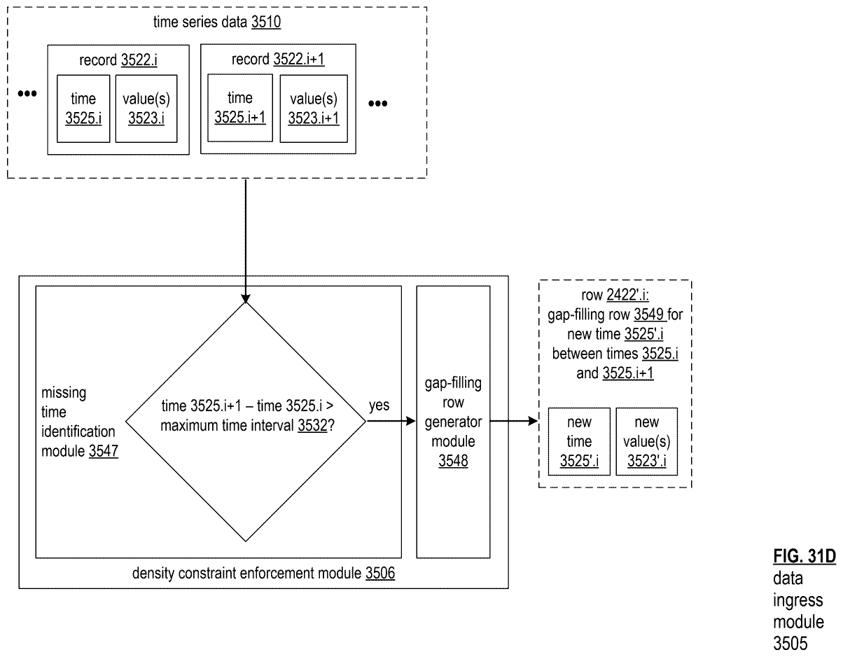

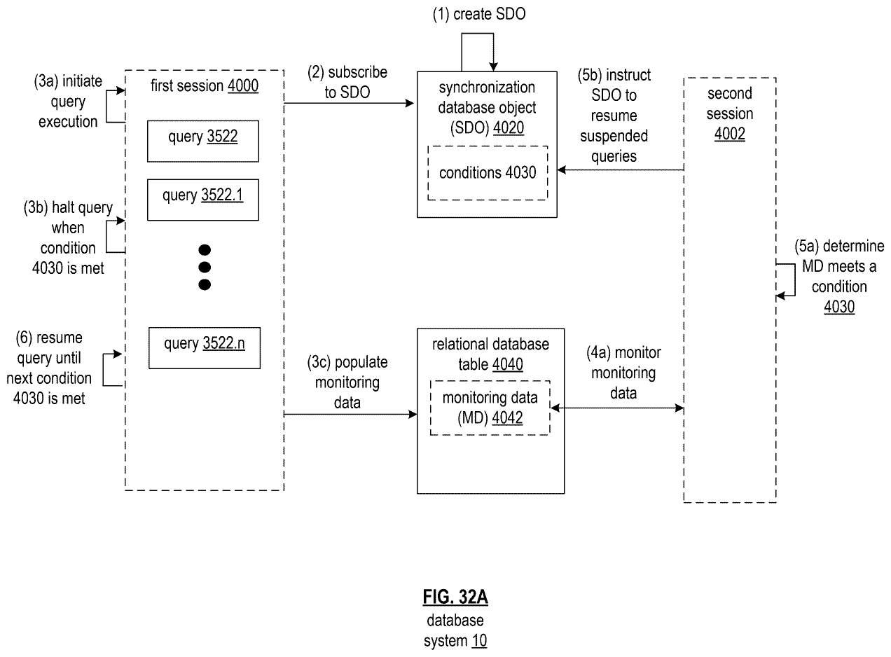

FIG. 31A is a chart illustrating an example of performing test executions for time series data in accordance with various embodiments. As shown, time series data can have one or more gaps, caused by missing records 3545. In some examples, the missing record 3545 results from broken builds, data corruption, or infrastructure issues. The gaps in the time series data can cause a significant amount of complexity in fulfilling accurate queries and/or maintaining accurate time series data. In an example, the gaps can be propagated to other systems via replication and batch unloading processes.

In the example of FIG. 31A, test executions are run every day. The missing record 3545 results in no value being available for the test for a certain day where a record should have been stored. Without a record for each time period (e.g., a day), the scale of the x-axis is not equi-distant or linear. If the missing record is assigned a value of zero (“0”), the graph gives the wrong impression. For example, in the chart of 25A, it would appear that the date associated with the missing record 3545 had zero text execution failures, which is most cases is not accurate. In some cases, linear interpolation may be more appropriate than entering a zero value, and different interpolations may be adopted for different use cases. Further, querying the data and performing such interpolations in SQL can be complex and expensive.

In some examples, gaps need to be identified. As an example, a gap is two rows of a time series data table with adjacent timestamps, but the difference between those timestamps exceeds a certain threshold (e.g. more than 1 day, more than a minute, more than a tenth of a second, etc.). Such gaps can be found in a SQL query using window functions or joins.

As an example, consider the following table representing time series data:

| Timestamp | Value |
|---|---|
| 2024 Feb. 15 14:13:18.706657 | 1 |
| 2024 Feb. 15 14:13:27.249909 | 2 |
| 2024 Feb. 15 14:13:36.288357 | 3 |
| 2024 Feb. 15 14:13:41.547569 | 4 |
| 2024 Feb. 15 14:13:47.571496 | 5 |

An example of an SQL query to identify a gap is shown by the following:

```
SELECT cur_timestamp, next_timestamp, cur_value
FROM ( SELECT timestamp AS cur_timestamp,
    value AS cur_value,
    LEAD(timestamp) OVER (ORDER BY timestamp) AS
    next_timestamp
  FROM measurements ) AS t
WHERE DATEDIFF(second, cur_timestamp, next_timestamp) > 5;
```

This produces the following table:

| | | Current |
|---|---|---|
| Current Timestamp | Next Timestamp | Value |
| 2024 Feb. 15 14:13:18.706657 | 2024 Feb. 15 14:13:27.249909 | 1 |
| 2024 Feb. 15 14:13:27.249909 | 2024 Feb. 15 14:13:36.288357 | 2 |
| 2024 Feb. 15 14:13:41.547569 | 2024 Feb. 15 14:13:47.571496 | 4 |

Thus, this SQL query returns the information which consecutive timestamps have a gap exceeding 5 seconds. However, in this example, the table does not include the next row's value, which is needed for calculating missing values via interpolation, which increases complexity.

As an example of adding the next value, an SQL query expression can include:

```
SELECT cur_timestamp, next_timestamp, cur_value, m.value AS
next_value
FROM ( SELECT timestamp AS cur_timestamp,
      value AS cur_value,
      LEAD(timestamp) OVER (ORDER BY timestamp) AS
      next_timestamp
    FROM measurements ) AS t
  JOIN measurements AS m ON t.next_timestamp = m.timestamp
WHERE DATEDIFF(second, cur_timestamp, next_timestamp) > 5;
```

This produces the following table:

| | | Current | Next |
|---|---|---|---|
| Current Timestamp | Next Timestamp | Value | Value |
| 2024 Feb. 15 14:13:18.706657 | 2024 Feb. 15 14:13:27.249909 | 1 | 5 |
| 2024 Feb. 15 14:13:27.249909 | 2024 Feb. 15 14:13:36.288357 | 2 | 3 |
| 2024 Feb. 15 14:13:41.547569 | 2024 Feb. 15 14:13:47.571496 | 4 | 2 |

In an example where no window functions are available, joins can be employed. However, a join may be even more complex because the same table needs to be joined three times in order to find exactly the one preceding row. Because these specific join conditions have to use greater-than/less-than comparisons, they do not always lend themselves to the best and most efficient join algorithms (e.g. hash joins).

This very simple example already demonstrates the complexity that such a SQL query brings. In one example, this gap-detection mechanism may be implemented in a procedural language like Python or in a stored procedure. In some examples, consecutive rows of the result set can be compared and processed in any way necessary. However, this is much less generic and querying the same data for different purposes (e.g. in new applications) is difficult at best.

In some examples, missing values can be interpolated if the preceding/next values are known. For example, a very simple approach is to calculate the mean as shown by the following equation:

$$interpolated\_value = ( prev\_value + next\_value ) / 2$$

In some examples, more complex calculations can be implemented like cubic splines etc. However, in examples where multiple consecutive values are missing, the interpolation becomes even more complex. Further, expressing the interpolation in SQL syntax can be challenging.

In an example where no next value is known (e.g., because the most recent measurement isn't currently available), extrapolation can be implemented. However, in most examples, extrapolation is more complex than interpolation. Thus, when time series data is stored with a gap, numerous complexities arise when attempting to execute a query on the time series data.

To reduce complexity, ensure data constraint conformity, and/or increase database time series data storage reliability and/or accuracy, the database system defines a table in a relational database system such that it will store measurements deterministically for a time grid. Depending on the defined granularity/resolution, a measurement is guaranteed to exist for each time interval. The measurement is either stored in the table by ingesting it (e.g., an INSERT statement), or by interpolating/extrapolating it from existing values to produce an estimated or synthetic value that attempts to accurately recreate expected data for a particular time of the time series data. In an example, the measured value (or calculated value) is stored persistently. In another example, the synthetic data is also stored persistently. In some examples, if a measure value is later obtained, the measured value replaces the synthetic value. In some examples, once the measured value is obtained, the synthetic value is deleted, hidden, and/or changes storage locations.

In an example, a specification for the storing measurements deterministically is employed to define one or more of: granularity/precision/resolution/interval size (e.g., use an interval size of “1 hour”), a formula for missing values, (e.g., when the next interval (based on CURRENT_TIMESTAMP) expires and no value is available for this interval, calculate a “substitute value”, (e.g., via interpolation, extrapolation, merging, substitution, shifting, etc.)) and how to handle/merge multiple values (calculated and/or measured) that fall into a single time interval (e.g., always discard “substitute value”, compute the average of multiple measurements, attempt to shift measurements into the previous or next interval in case those intervals don't have a value or just a “substitute value”, etc.).

Further, among some of many of the benefits of this system for storing measurements deterministically include the database system guaranteeing the presence of values. Thus, any SQL query processing the data in such a table does not have to worry about the complexities of the following: (a) missing values, (b) handling multiple values in the same interval, and/or (c) dealing with the intervals and their resolutions.

In some examples, the improvements for storing measurements deterministically provide the benefit that no outer joins are needed in the SQL query to detect gaps (for (a)). Further, no formula needs to be embedded into the SQL statement to calculate missing values (for (b)). Still further, truncation of timestamps is needed (for (c)) as would be the case if each measurement is accompanied with a timestamp with nanoseconds precision but having a constraint of only one measurement per minute. In an example, a result of the specification for handling the intervals may lead to all timestamps/intervals to be stored with the same precision. This paves the way for better index exploitation during query execution because of the no longer needed timestamp truncation. That's especially relevant if no simple “drop fractions of seconds” are used to reduce the timestamp's precision but rather “round to the nearest minute”. Such rounding mechanisms are more complex, of course.

Further benefits by persistently storing missing values include automatically improving audit-ability. If an SQL query were to calculate missing values (or this is embedded into a view definition), changes to the SQL query/view definition can lead to different results. Auditing such queries is inherently more complex.

In an example, to resolve the issues of missing records, introducing a MIN_DENSITY constraint is proposed for the system. Such a constraint is enforced while submitting DML and on the ingestion from event streaming sources like, for example, Kafka and others. In case of a missing data point, different fill strategies are available: For example, creating a synthetical data point holding default values, creating a synthetical data point holding null values, creating a synthetical data point holding values from a predefined inter/extrapolation method, and creating a synthetical data point holding values calculated by an SQL expression.

As an example, one SQL expression for calculating a synthetic data point include:

```
  CREATE TABLE measures (
    time float NOT NULL,
    value int,
    CONSTRAINT my_constraint MIN_DENSITY (time, 1.0, <SQL
expression>) # (column, precision, SQL expression)
  );
```

In an example, a constraint can be added to a table using an ALTER TABLE < > ADD CONSTRAINT < > statement. In an example, when setting up the deterministically storing measurements, the system can perform a function to close all time gaps in the already existing data (e.g., previous records of the time series data) for consistency and to enable the optimizer to use equi-joins unconditionally.

In some examples, another constraint can be implemented that enforces density not backwards and relies on the DBAs filling the gaps in a different manner. Hence, for data points prior to the constraint or the specification for the deterministically storing measurements creation, this is an informational constraint. One of the benefits to this approach is reducing the high level lock contention significantly and allowing constraint creation to be less expensive.

In some examples, the system can determine that a time series has become too dense in some time areas and/or is too dense for a constraint.

In an example, a density SQL expression can be implemented as follows:

```
  CREATE TABLE measures (
    time float NOT NULL,
    value int,
    CONSTRAINT my_constraint DENSITY (time, 1.0, <SQL
expression>) # (column, precision, SQL expression)
  );
```

In some examples where the times series data is determined to have a density exceeding a threshold density, the database e system can create synthetical data points by merging existing data points of the dense time series data to achieve the desired density.

As a few examples of generating synthetical data, the database system may create a synthetical data point with a default values, create a synthetical data point with null values, create a synthetical data point holding values from a predefined inter/extrapolation method, create a synthetical data point with values calculated by a generic SQL expression, create a synthetical data point from existing ones using one or more of a linear interpolation (e.g., sum and divide), a proportional interpolation (e.g., dependent on the timely distance), and a percentile value.

In some examples, to ensure the constraints are not violated, the synthetical data points are injected before to the ingestion step where new data points become visible to queries in the database system. Typically, this means before to the page/segment/data file creation but not necessarily before indexing, etc.

In some examples, data points arrive in strict ascending (by time) order: This means that that a missing data point is not hiding in older data. On every new data point that arrives, the database system (e.g., a processing module) can check the delta to the last data point and, if needed, calculate a synthetical data point to fill a potential gap.

In some examples, ascending data points arrive in parallel via multiple streams: In this case the database system can utilize a bloom filter on the received times in every, parallel data receiving agents tracking which times have been seen already. When enough data is received and a segment/page/data file is to be created by one of the agents, all the bloom filter arrays can be checked if a missing data point has been seen in a parallel stream. When the missing data point can not be found and at least one higher value was found in every bloom filter array, the database system determines that the data point is missing and creates a synthetical data point. (Likewise, calculation can be started if the next time interval—as specified in the constraint—has expired.)

In some examples, data arrives without being ordered by time (e.g., in a parallel batch load scenario). In this case, the already received data must be searched for missing data points every time a batch of data was loaded and missing data points are to be created before this data batch becomes visible. Synthetical data points are marked in a hidden column so they can be replaced with real data points when they arrive. Data replication to other targets must be stopped until the whole batch load operation is completed for consistency reasons. If data arrives without being ordered by time but not as part of a finite operation, data replication to other targets must ensure the replacement of synthetical data points when the real ones arrive too. In an example, this is performed using idempotency keys.

In some examples, the database system tracks which data points/rows are synthetical ones, which allows the database system to filter them out again, if needed. For example, the database system filters out the synthetical records to determine various diagnostics about the database system (e.g., event emitting, verifying interpolation precision, etc.).

In some examples, tracking the synthetic records (or portions thereof (e.g., a column of the row associated with the record)) includes one or more of an implicit Boolean column to keep track (e.g., hidden or regular), a hash set that contains the timestamps the database system has actually received, and a flag in the timestamp data type.

In some examples, the time series data is complex (e.g., date and time in two columns). In this case, the database system implements density constraints for complex keys.

In some examples, the database system reduces the overhead for calculating missing values (and filling gaps) by performing the constraint fulfillment “just-in-time”. As an example, each table with constraints has a timestamp or segment identifiers for which constraint fulfillment (e.g., gap detection and filling of missing values) has been performed. When a new query is executed by the system (involving such a table), the system checks if there are segments associated with fulfillment of the query for which gap detection and filling of missing values has not been completed. If the system identifies a segment that has not had the constraint fulfillment performed, the database system can initiate constraint fulfillment for this identified segment right before query execution starts. This can be combined with a normal scheduling mechanism, which does these checks and calculations in regular intervals.

These, along with other various embodiments of storing measurements deterministically such as gap filling measures, reduce complexity in fulfilling accurate queries, ensure a value is present that more accurately reflects measured data, and provide numerous other improvements as will be discussed in one or more subsequent Figures.

FIG. 31B is a schematic block diagram of a database system enforcing a density constraint on time series data in accordance with various embodiments. Some or all features and/or functionality of the database 10 of FIG. 31B can be utilized to implement any embodiment of database system 10 described herein. In an example, the data ingress module 3505 can be implemented by a query processing module 2435.

In various embodiments, the data ingress module 3505 operates to ensure a record exists for each time in a time period associated with time series data 3510, that includes records 3522.1 through 3522.R. In an example, the time series data 3510 is data records that include a time 3525, which may include one or more of a date value (e.g., year, month, day), a time value, a time offset value (e.g., UTC offset), a date format value, and a time format value. The data records 3522 also include one or more value(s) 3523, which may be any data associated with a corresponding time 3525. For example, the value 3523 includes frames of a security video as time elapses. In an example, each frame corresponds to a time of a set of times of the time period. As another example, the value 3523 indicates a valve pressure of a valve being monitored. As yet another example, the value(s) 3523 include a first value that indicates the speed of a delivery drone for delivering packages, a second value that indicates a latitude/longitude data value of a location of the delivery drone, and a third value that indicates a current battery voltage for the delivery drone.

In an example, ensuring a record exists is based on density constraint data 3530, which defines a maximum time interval 3532 based on a minimum density constraint 3531. In another example, ensuring a record exists for the time series data 3510 is based on a maximum density constraint 3533 which defines a minimum time interval 3534 for the time series data 3510. The generate density constraint enforcement module 3506 compares the time series data 3510 to the density constraint data 3530 to maintain a desired density of the time series data 3510. For example, density constraint data 3530 indicates a minimum density constraint that a maximum time interval is every second. Thus, the density constraint enforcement module 3506 operates to ensure that each of the records of the time series data 3510 only include a record for every second.

When the density constraint enforcement module 3506 analyzes the time series data 3510 and does not find a record for a particular time (e.g., 15:35:32, 15:35:34, 15:35:35) that should be present according to the density constraint data 3530, the density constraint enforcement module 3506 determines that a data record is missing (e.g., 15:35:33) from the time series data 3510 and generates a new data record 3522′ that includes synthetic value(s) for time 3525 and measured value(s) 3523. When the density constraint enforcement module 3506 analyzes the time series data 3510 and finds multiple records for a particular time (e.g., a record at 15:35:33.0, 15:35:33.5, 15:35:34.0), the density constraint enforcement module 3506 determines, based on the maximum time interval 3532, that the data records need to be merged, moved, and/or excluded from the time series data 3510. For example, the density constraint enforcement module 3506 determines to delete the record at 15:35:33.5. As another example, the density constraint enforcement module 3506 determines to store the record at 15:35:33.5 apart from the relational database table 2712. As yet another example, the density constraint enforcement module 3506 determines to merge the record at 15:35:33.5 with the record at 15:35:33.0 to generate a new data record 3522′ that includes synthetic value(s) 3523 for times 3525 and/or value(s) 3523.

In an example, the new record 3522′ may include a measured value and a synthetic value. In some examples, the merging may include one or more of averaging, combining, weighting, multiplying and other functions. For example, value(s) 3523 from the records 3522 are averaged by added the records together and dividing the total by two. As another example, frame data from a first record 3522 is combined with frame data from a second record, where unchanged frame data is constant (e.g., the same) and changed frame data is weighted based on a weighting function applied to x frames of previous data from x number of previous records 3522 to estimate a value for the changed frame data.

The data ingress module 3505 then generates synthetical row subset 3542 for new records 3522′ that include rows 2422′.c through 2422′.d, which include new times 3525′ and new values 3523′. In an example, the data ingress module stores these records distinctly from the non-synthetical row subset 3541 (e.g., measured values) for existing records 3522, which can include rows 2422.a through 2422.b. Storing distinctly includes one or more of including a flag within the new record, including a hidden column with the record, storing the new records in a different portion of memory of the database storage 2450, and storing the new records apart from the non-synthetical row subset 3541 within the relational database table(s) 2712. In an example, existing records 3522 include previous records that include measured (e.g., non-synthetical) values and records within time series data 3510 that include measured values.

FIG. 31C is a schematic block diagram of a data ingress module 3505 that includes a density constraint enforcement module 3506 in accordance with various embodiments. The density constraint enforcement module 3506 includes merge time identification module 3557 and a merged row generator module 2588. The density constraint enforcement module 3506 operates to merge two or more rows of data records for time series data 3510 into a single row of time series data based on a density constraint (e.g., a minimum time interval 3534).

In an example of operation, the density constraint enforcement module 3506 obtains (e.g., generates, receives, etc.) time series data 3510, which contains a plurality of records 3522.j through 3522.j+k. Each of the records 3522 includes a time 3525 (e.g., timestamp, date and time of day, etc.) of a particular time period for the time series data 3510 and more and more values associated with the corresponding time. Note in some examples, the records are not received in chronological order (e.g., batch records, received in parallel, etc.) and the data ingress module organizes the records 3522 based on the time associated with each record for the data records received in a particular time period.

The merge time identification module 3557 determines whether any two or more of the times 3525 associated with the records 3522 are less than a minimum time interval 3534 based on density constraint data associated with the time series data 3510 and/or the database system 10. For example, the merge time identification module 3557 subtracts a first time of a first record 3522 from an adjacent time (e.g., next time (e.g., a second time)) of an adjacent record (e.g., closest time in time series data to the first record) and determines whether the difference between the first time and the adjacent time has violated (e.g., is less than) a minimum time interval 3534. As a specific example, when the minimum time interval 3534 is one second (1 s), and a difference between the first time and the adjacent time is 0.4 s, the merge time identification module 3557 determines to merge the records 3522 associated with the first time and the adjacent time.

When determining to merge the records 3522, the merged row generator module 3588 merges values for the records 3522 in violation (e.g., the first and adjacent records) to produce new row 2422′.j, which is a merged row 3559 for a new time 3525′ between and/or including times 3525.j and 3525.j+k. As a specific example, the merged row generator module 3588 generates a new row 2422′.j that includes a time equidistant between the first time and the adjacent time, and averages values 3523 between the records 3522.j and 3522.j+k. As another example, the merged row generator module 3558 determines, for a set of 10 records in violation (e.g., a record every 0.1 s from 0.0 s to 0.9 s), to merge the records into a single record by selecting one of the records (e.g., at random, based on a record source (e.g., higher confidence, oldest data source, additional security verification, etc.), closest to desired time interval, etc.). For example, the merged row generator module takes a record associated with a time of 0.5 s, when the record is associated with a highest confidence value and merged row generator also takes the data values from the record as the new row 2422′.

FIG. 31D is a schematic block diagram of a data ingress module 3505 that includes a density constraint enforcement module 3506 in accordance with various embodiments. The density constraint enforcement module 3506 includes a missing time identification module 3547 and a gap-filling row generator module 3548. The data ingress module functions to enforce a density constraint on time series data in accordance with various embodiments.

In an example of operation, the missing time identification module 3547 obtains time series data 3510 and determines whether a difference between any two adjacent records (e.g., in time) exceeds a maximum time threshold. For example, the missing time identification module determines that a time difference between a first timestamp associated with record 3522.i and a second timestamp associated with record 3522.i+1 exceeds the maximum time threshold. When receiving an indication that time difference exceeds the maximum time threshold, the gap filling row generator module 3548 generates row 2422′.1, which is a gap-filling row 3549 for new time 3525′.i between times 3525.i and 3525.i+1.

As a specific example, times series data 3510 is regarding location of a delivery drone. A density constraint associated with time series data 3510 indicates a maximum time interval 3532 is ten seconds. Thus, time series data 3510 should include a record for every ten seconds of time that elapses. The missing time identification module 3547 determines that for the time series data received in a particular time period (e.g., the last minute, hour, the last “x” number of batches, etc.), that a time between a first record 3522.i and a second record 3522.i_1 is twenty seconds, and thus violates the maximum time interval 3532. For example, a time 3525.i of record 3522.i has a value of 12:22:20 and a time 3525.i of record 3522.i has a value of 12:22:40.

Thus, the gap-filling row generator module 3548 generates a record for time 12:22:30, where the record includes the new time 3525′.i of 12:22:30, and a new location value. For example, when the location associated with record 3522.i is the same location as the location associated with record 3522.i+1, the gap-filling row generator module 3548 generates the new value 3523′.i to be the constant location. In another example, when the location associated with record 3522.i is a different location than the location associated with record 3522.i+1, the gap-filling row generator module 3548 generates the new value 3523′.i based on an estimation of the location for the gap-filling row 3549.

As an example, the new value 3523′.i is generated based on an average of the first location and the different location. In another example, other values (e.g., velocity, acceleration, etc.) of the records 3522 are utilized to more accurately estimate the location for the record associated with the new time 3525.i.

FIG. 32A is a schematic block diagram of a database system that functions to externally control SQL statement execution. In an example, the external control improves testing on database systems as discussed herein. In various examples, a database system can be programmed to expedite execution of SQL statements (e.g., in particular queries). However, there are situations where expediting execution is counter productive (e.g., certain instances of testing the database system) and can cause issues.

For example, a requirement in some examples of testing of the database system can include avoiding time-based synchronization, because time-based synchronization can be unreliable. However, the database system needs a way to run tests, and monitor the tests and the test results to increase accuracy of analytical data (e.g., predicted performance, measured performance, etc.) regarding the database system.

In some examples, setting up tests can include the following use cases and/or issues:

Monitoring tests: One or more test queries are actively running in the database system when retrieving monitoring information. If the query starts execution or finishes because the timing of the tests was inaccurate or incurred an error, different results may be returned—and the test code has to deal with those. Further, it is challenging to catch queries in different phases (e.g., if different monitoring data is available). For example, a query in the virtual machine (VM) may track heap consumption while a query currently being optimized may have a counter for the number of different plans analyzed so far.

Cancellation tests: One or more queries needs the be running in the database system. Further, testing cancellation during different phases (e.g., queuing, parsing, optimization, execution vs. result set fetching, etc.) can be problematic.

Precisely stress testing: generally, there are challenges in obtaining a great amount of accuracy to test a volume for certain components. For example, having many queries queued up for the scheduler to handle at once or to saturate network components to the points that TCP/IP stacks run full.

Use cases (1) and (2) above are faced with the issue of having sufficiently long running SQL statement, while use case (3) above needs very fine-grained control of execution phases of SQL statements or components. Some examples of setting up tests for the above use cases include to use complex queries and/or huge data volumes to have a longer runtime. In this example, controlling the runtime of such statements is difficult, for example, when a query produces an intermediate table of 500\hat{ }4=62,500,000,000 rows.

Further, performance improvements in the optimizer/system may make such tests fail as side effects, but such a test failure hardly indicates that the improvements are faulty (instead, the test case design is problematic to begin with). Still further, some query statements (e.g., CREATE SCHEMA) don't lend themselves for any kind of control. In some examples, tests use some sleep( ) functionality (e.g., a query statement of SELECT . . . , sleep(30) FROM . . . ). However, this comes with the usual problem of time-based synchronization: that is for robust tests, longer sleep times are used but prolong the test execution time, Also alternatively, shorter sleeps lead to brittle and flaky tests.

In some examples, the database system employs some user-defined functions (UDFs) as a hook that's invoked during query execution. This hook can be used to wait for conditions (e.g., rows inserted/modified in some other table or events stored in the file system). However, in this example, other relational tables of the database system cannot be used if the database system employs snapshot isolation because concurrent changes will not become visible. The UDF could establish a new SQL connection to circumvent this issue, but this requires handling of credentials. Further, using the file system for the synchronization is problematic in distributed database systems because a shared file system is needed if it cannot be controlled what is executing on which node. Furthermore, having node-specific control may be problematic (e.g., for testing cancellation behavior in different parts of the system). Still further, if a shared file system is used, paths have to be handled, increasing overhead. Even further, management of the file system state is required (including collision avoidance).

In an example of implementation of improving testing on database systems via external control for SQL statement execution, the database system performs one or more of the following steps.
(1) create a new database object. For example: CREATE LATCH <name> <parameters>.
(2) in an SQL session (S1) where SQL statement execution shall be synchronized, subscribe to the LATCH object: SUSPEND AT LATCH <name>.
(3) in S1, start the SQL statement execution, which runs until the conditions defined in <parameters> are met. At this point, the SQL statement execution is halted (e.g., suspended) in the database engine.
(4) in another SQL session (S2), monitor the LATCH object (e.g., utilizing a vtable) to determine whether the SQL statement execution in S1 has reached the desired conditions.
(5) in S2, instruct the LATCH object to resume any suspended SQL statement execution when the desired conditions are found.
(6) in S1, the resumed statement execution runs until encountering the next condition in LATCH.

Some examples of an SQL expression for use in testing database systems include:

CREATE LATCH <name> <parameters>
ALTER LATCH <name> <new-parameters>
DROP LATCH <name>
SUSPEND AT LATCH <name>
RESUME LATCH <name> [ <specific-condition> ]

The parameters for the SQL LATCH expressions can include a <name> parameter. This is a unique name identifying the database object to be used for synchronization of SQL statement execution across SQL sessions. The parameters for the SQL LATCH expressions can further include a <parameters> parameter and a <new-parameters> parameter. These parameters can include conditions such as custom definitions of locations in the source code, identifying where SQL statement execution shall be suspended. In an example, these parameters may specify one or more source code locations. In an example, the parameters are logical names (e.g. “optimization complete”). In another example, the parameters include more specific function names. Note that the source code is specifically instrumented at those locations.

In an example, SQL statement execution will be suspended at the first source code location identified by a condition that is encountered. Upon resuming the execution, the SQL statement execution continues until it reaches the next source code location or the statement execution finishes.

The parameters for the SQL LATCH expressions can further include a <specific-condition> parameter. This specific condition specifics a source code location at which a waiting queries will resume processing. In some examples, SQL expressions for the monitoring of the testing of the database systems include CREATE EXEC_SYNC and SUSPEND AT EXEC_SYNC, and then kicks of the execution of the SQL statement. After kicking of statement execution, the test driver may need to know that statement execution has indeed reached the synchronization point (defined in <conditions>). Thus, some monitoring infrastructure needs to be included in the test in order to ensure the synchronization point was reached.

In some examples, the database system uses system tables (e.g., a vtable) to externalize state information. In an example, the vtable is the infrastructure also utilized for externalizing which SQL statement execution is currently suspended at which source code location. An example of an SQL query expression for monitoring includes:

SELECT *
FROM sys.statement_execution_suspension_status
WHERE exec_name = <name>

In this example, the implementation of the monitoring is done with substantially no additional overhead (e.g., <5%, <0.1%, etc.). This is because the source code is already being instrumented for suspending execution. Thus, once a suspension request has been detected, monitoring information can be externalized.

For example, suspending SQL statement execution after statement optimization could be implemented by the following expressions:

```
TKTOptimizer::optimize(...) {
  preOptimize( );
  optimize( );
  postOptimize( );
  if (shallSuspendAfterOptimization( )) {
    populateMonitoringDataForSuspension( );
    waitForResume( );
  }
}
```

Note that without a suspension request, the additional check (e.g., in shallSuspendAfterOptimization( )) is the only added overhead. And this can be minimized because <parameters> are known during CREATE LATCH, and this can be populated into the connection-specific configuration setting during the execution of SUSPEND AT LATCH. Thus, the condition check can be the lookup of a simple Boolean value. In an example, this Boolean value does not require atomic memory access. For example, the Boolean value toggles between true for a suspension of execution of a query and false for resuming the query after being suspended.

In examples using a distributed and highly parallel database system, an important aspect is to synchronize this Boolean value across clusters and nodes. For example, operator instances may be requested to suspend during their end-of-file (EOF) processing. When many (e.g., tens, hundreds, etc.) operator instances are active across different processes and on different machines, the Boolean value needs to be available to the clusters and the nodes running the processes. Fortunately, there is no complex synchronization needed as only the initial state has to be transmitted. In an example, the initial state is transmitted when the query execution is kicked off. Then, the transition from true to false will be transmitted when the execution of the query is suspended. Note: the communication protocol between the nodes must not be suspended so that this transition can reach all rolehostd processes on all nodes.

In some examples, the database system ensures not to suspend regular intra-cluster communication (e.g., raft protocols) during testing, at least not for a duration that may exceed configured timeouts.

In some examples, the database system enables the functionality in specific build types only (e.g., “test_release”), which can be compiled-out in production deployments. In some examples, the implementation of waitForResume( ) can be based on existing low-level mechanisms that include one or more of latches, mutexes, and monitors. A regular check for a “resume request” is done (e.g., via polling or sleeping and waiting for a notification). In some examples, a Boolean flag is sufficient to communicate the “resume request”—either for the complete LATCH object or possibly more fine-granular on the level of individual source code locations.

In an example, the waitForResume( ) does not only check for “resume requests” but also for statement cancellations, loss of connection from the client, and/or system errors, which helps the testing to not get stuck in problematic situations.

In some examples, a publish or subscribe model can be adopted for the LATCH objects. Multiple subscribers, i.e., multiple SQL sessions, can subscribe themselves to the same object using SUSPEND AT LATCH <name>. This allows all SQL statements to wait together. When RESUME LATCH is run, all statements will stop waiting and resume execution together. This allows putting targeted stress on individual components in the database kernel.

In some examples, state changes are communicated/externalized via monitoring information. For example, states include “reached suspension point X” and “finished execution”. In an alternative example, the database system counts at each suspension point how many SQL statements have reached it and are suspended and for which latch. In this example, if <parameters> is defined like “suspend execution until “n” queries have reached this point”, an automatic RESUME could be triggered (e.g., based on an atomic counter (note that the atomic counter would have to be synchronized across all nodes in the cluster)). This example provides the benefit that no active polling of monitoring information will be required.

In another example, the externalizing SQL statement execution includes utilizing a syntax that combines WAIT FOR LATCH and the actual SQL statement (e.g., a query or an INSERT statement). As an example, SUSPEND AT LATCH <SQL-statement>. This provides the benefit that it is inherently clear that the wait-for-latch functionality is applicable. Thus, information that the execution of this SQL statement has reached a suspension point can be communicated back to the client application using the communication channel of the SQL session.

In an example of operation of FIG. 32A, the database system creates a synchronization database object (SDO) 4020. As a specific example the synchronization data object 4202 is created by the SQL expression CREATE LATCH <name> <parameters>. The SDO 4020 includes conditions 4030 for suspending execution of queries 3522-3522.n. In an example, the conditions 4030 are defined by the <parameters> in the SQL expression above. The conditions include one or more of a row inserting into a table, a row of a table being modified, a source code location of source code, a logical name associated with a query expression and/or phase (e.g., “optimization complete”), and a name of a function associated with execution of a query expression.

The operation continues with establishing a first session 4000. The first session 4000 is configured to apply the synchronization data object 4020 to suspend execution of the at least one executing query expression when a condition of the set of conditions for suspension of execution is detected. The first session then subscribes to the synchronization data object 4020. In an example, the first session subscribes to the synchronization data object by using an SQL expression SUSPEND AT LATCH <name>.

The first session 4000 initiates execution of one or more queries 3522-3522.n via a plurality of parallelized nodes of the database system based on processing an execute query command to execute the queries issued via the first session. In some examples, one or more queries are also executed on a different session (e.g., a third session, a fourth session, etc.).

The first session 4000 executes the queries until it detects a condition 4030 of the set of conditions being met during the execution of the queries. When the condition is detected, the first session 4000 suspends execution of the queries and updates at least one relational database 4040 with monitoring data indicating suspension of the queries. The operation continues with populating a relational database table with monitoring data regarding the execution and/or suspension of the queries.

The operation continues with establishing a second session 4002. Note the second session 4002 may be established prior to, concurrent with, or after the first session. The second session 4002 accesses the monitoring data 4042 in the at least one relational database table 4040 to verify that suspension of the queries 3522 are in accordance with at least one condition 4030.

For example, the second session determines whether an SQL statement execution of a query executing in the first session has reached the desired code location as defined by the conditions 4030 in the synchronization data object 4020.

When the second session 4002 determines that the SQL statement execution was suspended in accordance with the at least one condition 4030 of the synchronization data object 4020, the second session instructs the synchronization data object 4020 to resume any suspended queries. In the first session 4000, the resumed queries then execute (e.g., run) until the resumed queries encounter the next condition 4030 of the synchronization data object 4020. For example, the resumed queries execute until they reach a second code location in the source code.

As used herein, an “AND operator” can correspond to any operator implementing logical conjunction. As used herein, an “OR operator” can correspond to any operator implementing logical disjunction.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such an advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<−5, and the comparison to determine if signal A matches signal B can likewise be performed by determining −A matches −B or not(A) matches not(B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e. machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A database system comprises:
a plurality of computing device clusters, wherein a computing device cluster includes a plurality of computing devices, wherein a computing device of the pluralities of computing devices includes a plurality of computing nodes, wherein a computing node of the pluralities of computing nodes includes a plurality of processing core resources;
wherein a set of processing core resources of the pluralities of processing core resources is operably coupled to:
obtain the query statement regarding a set of data values of a dataset, wherein the query statement includes a set of query operations, wherein the dataset includes pluralities of data cells for storing pluralities of data values, wherein the pluralities of data cells are organized in rows and columns, wherein a first row of the rows includes a first plurality of data cells of the pluralities of data cells, and wherein the set of data values is stored in a set of data cells of a particular column of the columns of the dataset;
obtain source data type information regarding source data type of the set of data values and target data type information regarding target data type regarding resulting data of the query statement;
when the source data type does not match the target data type:
access a data type conversion path list to identify a set of entries, wherein each entry of the set of entries includes a target data type of the target data type information for target data;
determine, for the set of entries, whether an entry of the set of entries includes a source data type that corresponds to the source data type information; and
when the entry includes the source data type, output a representation of data conversion path information of the entry, wherein the data conversion path information includes a list of data format conversion from the source data type to the target data type, a path length regarding a number of the data format conversions, and a conversion type for each conversion between the source data type and the target data type.

2. The database system of claim 1 further comprises:
the set of processing core resources is further operable to:
receive a response to the representation;
when the response is unfavorable, determine whether another entry of the set of entries includes a source data type of the source data type information; and
when the other entry includes the source data type, provide a second representation of data conversion path information of the other entry;
each processing core resource of the set of resources is further operable to:
when the response is favorable, implement the set of query operations of the query statement in accordance with the data conversion path information to produce an implemented query statement.

3. The database system of 2, wherein a first processing core resource of the set of processing core resources is further operable to:
execute the implemented query statement upon a first sub-set of data values of the set of data values to produce a first resulting data having the target data type.

4. The database system of claim 1, wherein the query statement comprises:
a query process to implement a set of input/output (IO) pipelines by the set of processing core resources, wherein a first processing core resource of the set of resources implements a first IO pipeline of the set of IO pipelines, wherein the first IO pipeline is used to:
retrieve a first sub-set of data values of the set of data values from memory of the first processing core resource, and process the first sub-set of data values to a first resulting data values having the target data type.

5. The database system of claim 1, wherein the set of processing core resource is further operable to:
when multiple entries include the source data type, provide multiple representations of data conversion path information of the multiple entries;
receive a response to the multiple representations;
when the response includes a selection of one of the multiple representations, each processing core resource of the set of resources is further operable to:
implement the set of query operations of the query statement in accordance with the selected data conversion path information to produce an implemented query statement.

6. The database system of claim 1, wherein the set of processing core resources is further operable to:
when the set of entries does not include an entry where the source data type corresponds to the source data type information, generate an initial data conversion path that includes the source data type at a beginning of the initial data conversion path and the target data type at the end;
access a list of query operations that include a data format conversion function;
based on the set of query operations of the query statement and on the list of query operations, add a set of intermediate data format conversions between the beginning and the end of the initial data conversion path, wherein the set of intermediate data format conversions includes one or more intermediate data format conversions;
determine a set of data format conversion information for the set of intermediate data format conversions, wherein first data format conversion information is regarding a first intermediate data format conversion of the set of intermediate data format conversions;
add the set of data format conversion information to the initial data conversion path to produce constructed data conversion path information; and
output a representation of the constructed data conversion path information.

7. The database system of claim 6, wherein the list of query operations comprises:
a field for operation name;
a field for return type;
a field for a first argument type; and
a filed for second argument type.

8. The database system of claim 6, wherein the set of processing core resources is further operable to add the set of intermediate data format conversions the initial data conversion path by:
identifying a first set of intermediate data format conversions;
identifying a second set of intermediate data format conversions; and
selecting the first or second set of intermediate data format conversions as the set of intermediate data format conversions based on desired length of the set of intermediate data format conversions.

9. The database system of claim 1 further comprises:
the source data type and the target data type are a data type from of a list of data types that includes: a long data type, a character data type, a byte data type, a raw data type, a long-term storage data type, a compressed data type, an eraser encoded data type, and a data ingest data type.

10. The database system of claim 1 further comprises one or more of:
obtain the query statement includes one of: receive the query statement, generate the query statement, and retrieve the query statement;
obtain the source data type information and the target data type information includes one of: receive the source data type information and the target data type information with the query statement, receive the source data type information and the target data type information separately from the query statement, generate the source data type information and the target data type information, and retrieve the source data type information and the target data type information; and
the representation of data conversion path information is a graphical representation for display via a graphical user interface.

11. A computer readable memory device comprises:
one or more memories that store operational instructions that, when executed by a set of processing core resources of the pluralities of processing core resources of a database system, causes the set of processing core resources to:
obtain the query statement regarding a set of data values of a dataset, wherein the query statement includes a set of query operations, wherein the dataset includes pluralities of data cells for storing pluralities of data values, wherein the pluralities of data cells are organized in rows and columns, wherein a first row of the rows includes a first plurality of data cells of the pluralities of data cells, and wherein the set of data values is stored in a set of data cells of a particular column of the columns of the dataset;
obtain source data type information regarding source data type of the set of data values and target data type information regarding target data type regarding resulting data of the query statement;
when the source data type does not match the target data type:
access a data type conversion path list to identify a set of entries, wherein each entry of the set of entries includes a target data type of the target data type information for target data;
determine, for the set of entries, whether an entry of the set of entries includes a source data type that corresponds to the source data type information; and
when the entry includes the source data type, output a representation of data conversion path information of the entry, wherein the data conversion path information includes a list of data format conversion from the source data type to the target data type, a path length regarding a number of the data format conversions, and a conversion type for each conversion between the source data type and the target data type, wherein
the database system includes a plurality of computing device clusters, wherein a computing device cluster includes a plurality of computing devices, wherein a computing device of the pluralities of computing devices includes a plurality of computing nodes, and wherein a computing node of the pluralities of computing nodes includes a plurality of processing core resources.

12. The computer readable memory of claim 11 further comprises:
the one or more memories further store operational instructions that, when executed by the set of processing core resources, causes the set of processing core resources to:
receive a response to the representation;
when the response is unfavorable, determine whether another entry of the set of entries includes a source data type of the source data type information; and
when the other entry includes the source data type, provide a second representation of data conversion path information of the other entry;
the one or more memories further store operational instructions that, when executed by each processing core resource of the set of processing core resources, causes each processing core resource to:
when the response is favorable, implement the set of query operations of the query statement in accordance with the data conversion path information to produce an implemented query statement.

13. The computer readable memory of claim 12, wherein the one or more memories further store operational instructions that, when executed by a first processing core resource of the set of processing core resources, causes the first processing core resource to:
execute the implemented query statement upon a first sub-set of data values of the set of data values to produce a first resulting data having the target data type.

14. The computer readable memory of claim 11, wherein the query statement comprises:
a query process to implement a set of input/output (IO) pipelines by the set of processing core resources, wherein a first processing core resource of the set of resources implements a first IO pipeline of the set of IO pipelines, wherein the first IO pipeline is used to:
retrieve a first sub-set of data values of the set of data values from memory of the first processing core resource, and process the first sub-set of data values to a first resulting data values having the target data type.

15. The computer readable memory of claim 11 further comprises:
the one or more memories further store operational instructions that, when executed by the set of processing core resources, causes the set of processing core resources to:
when multiple entries include the source data type, provide multiple representations of data conversion path information of the multiple entries;
receive a response to the multiple representations;
the one or more memories further store operational instructions that, when executed by each processing core response of the set of processing core resources, causes each processing core resource to:
when the response includes a selection of one of the multiple representations, implement the set of query operations of the query statement in accordance with the selected data conversion path information to produce an implemented query statement.

16. The computer readable memory of claim 11, wherein the one or more memories further store operational instructions that, when executed by the set of processing core resources, causes the set of processing core resources to:
when the set of entries does not include an entry where the source data type corresponds to the source data type information, generate an initial data conversion path that includes the source data type at a beginning of the initial data conversion path and the target data type at the end;
access a list of query operations that include a data format conversion function;
based on the set of query operations of the query statement and on the list of query operations, add a set of intermediate data format conversions between the beginning and the end of the initial data conversion path, wherein the set of intermediate data format conversions includes one or more intermediate data format conversions;
determine a set of data format conversion information for the set of intermediate data format conversions, wherein first data format conversion information is regarding a first intermediate data format conversion of the set of intermediate data format conversions;
add the set of data format conversion information to the initial data conversion path to produce constructed data conversion path information; and
output a representation of the constructed data conversion path information.

17. The computer readable memory of claim 16, wherein the list of query operations comprises:
a field for operation name;
a field for return type;
a field for a first argument type; and
a filed for second argument type.

18. The computer readable memory of claim 16, wherein the one or more memories further store operational instructions that, when executed by the set of processing core resources, causes the set of processing core resources to add the set of intermediate data format conversions the initial data conversion path by:
identifying a first set of intermediate data format conversions;
identifying a second set of intermediate data format conversions; and
selecting the first or second set of intermediate data format conversions as the set of intermediate data format conversions based on desired length of the set of intermediate data format conversions.

19. The computer readable memory of claim 11 further comprises:
the source data type and the target data type are a data type from of a list of data types that includes: a long data type, a character data type, a byte data type, a raw data type, a long-term storage data type, a compressed data type, an eraser encoded data type, and a data ingest data type.

20. The computer readable memory of claim 16 further comprises:
the one or more memories further store operational instructions that, when executed by the set of processing core resources, causes the set of processing core resources to:
obtain the query statement includes one of: receive the query statement, generate the query statement, and retrieve the query statement;
the one or more memories further store operational instructions that, when executed by the set of processing core resources, causes the set of processing core resources to:
obtain the source data type information and the target data type information includes one of: receive the source data type information and the target data type information with the query statement, receive the source data type information and the target data type information separately from the query statement, generate the source data type information and the target data type information, and retrieve the source data type information and the target data type information; and
the representation of data conversion path information is a graphical representation for display via a graphical user interface.
